(19) United States
(12) Patent Application Publication
(10) Pub. No.: US 2011/0093457 A1
(43) Pub. Date: Apr. 21, 2011

(54) METHOD FOR CALCULATING RESOURCE POINTS OF RESOURCE INFORMATION AND DISTRIBUTING POINTS

(75) Inventor: Arei Kobayashi, Saitama (JP)

(73) Assignee: KDDI CORPORATION, Tokyo (JP)

(21) Appl. No.: 12/997,745

(22) PCT Filed: Jun. 15, 2009
(86) PCT No.: PCT/JP2009/060839

§ 371 Date: Dec. 13, 2010

(30) Foreign Application Priority Data
Jun. 13, 2008 (JP) 2008-155841

(51) Int. Cl. G06F 17/30

(52) U.S. Cl. 707/723; 707/E17.044

(57) ABSTRACT

An object of the present invention is to provide a system and method that provides an objective value evaluation with respect to various resources to be posted to a community by users over a network and accumulated in a database; and which allows this value to be distributed within the community. The system generates an association (link) with respect to the various resources to be accumulated in the database according to a content of an automatically retrieved tag as well as user behavior over the resource. Using these resources and their associations, the system automatically provides an objective valuation with respect to the entire community by a predetermined valuation method and further associates the points based on this valuation with the resource thereby to present the user a relative value within the community, wherein further based on the points, given points will be taken as a reward dividend to be allotted and distributed to the user who has posted the resource, thus allowing the points to be distributed in the community.

### TECHNICAL FIELD

The present invention relates to a system that is operable to provide a valuation in accordance with a predetermined method and automatically grant given points with respect to a plurality of resources that are to be posted by client terminals over a network so as to allow the points to be distributed in the community having a plurality of resource groups on the network.

### BACKGROUND ART

Media for allowing contents to be generated by users themselves who directly post information to be placed thereon by means of the Internet may include, for example, Q&A sites, auction sites, Social Networking Services (SNSs), blogs, and so on. These are referred to as CGM (Customer Generated Media), by way of which the users can disclose information on the Internet in real time and in a convenient way, and other Internet users can also make a decision freely on whether to accept or reject interesting and valuable information in the accumulation of the information. Thus, the CGM is used by a number of Internet users in various forms as social databases directing the users into various communities on the Internet.

However, it has been noticed often that the pieces of information accumulated in these social databases also lack credibility due to the unrestrained manner of accumulation thereof; and even if those pieces of information are of real value, valuations on them are no more than subjective ones that depend on the respective users' personal determinations.

As such, in the Q&A sites, for example, with regard to questions, answers to the questions, and ratings on the answers, when persons who have prepared the questions are to evaluate the level of value of answers that have been posted on behalf of the questions as well as the ratings on the answers, typically may make determinations manually, based on their personal perspectives, for example, in such a manner that the specific levels of value represented in the form of points are granted to the respective users who have made those postings (Patent Literature 1). Also, in the auction sites, since prices can be settled in the auction style between buyers and sellers, the prices here again can be determined based merely on personal perspectives. More specifically, there has been no common concept of valuation among those pieces of information accumulated in the social databases, but predominantly they have little societal asset value.

In one form, media on the Internet that provide objective valuations on the contents may include search sites, such as Page Rank used in Google (http://www.google.com), for example (Patent Literature 2). This, based on a concept that “any sites that are hyperlinked from any significant sites also could be considered as significant sites,” can make determinations of value equivalently with respect to the contents on the Internet. In this form, the contents intimately associated with key word(s) used in the searches may be objectively given high ratings, based on which, the contents can be presented to the users as search results. However, the valuation in such a search site is based on a premise such that explicit link information by way of the hyperlink should be given, wherein after calculating the level of significance of contents using said explicit link information, a group of contents (a search result) associated with the key word(s) may be retrieved from the social database, in which the valuation can be simply directed to the relative order in the indication. In fact, this form is not the one that can provide the value evaluation commonly applicable to all the contents accumulated in the social database throughout the entire social database.

In another form, media on the Internet of high societal asset value may include encyclopedia sites, such as the Wikipedia (http://ja.wikipedia.org/wiki/), on which anyone can make additions and modifications to the contents freely. This can be considered as an exemplary form in which the operator of the site has presented his/her own distinctive concept of valuation, so that the social databases of high societal asset value have been successfully constructed. However, with regard to such media there has arisen a situation of increased burden to the operator in that the operator has to keep an eye on the contents of the postings all the time. In addition, although it should be natural to come up with an idea that some kind of reward may be kicked back to the posting made by the person making the posting who did add value to the site in spite of a high barrier against the posting activities as in such circumstances that a ratio of the number of persons who make postings to a total number of users who utilize the social database is very small, this idea concerning the kick back of reward has not yet been realized, due to such thought lying behind the fact that the person to post the information should do it on a voluntary basis.

### CITATION LIST

### Patent Literature

PTL 1: Japanese Patent Application Public-disclosure No. 2002-329112 official gazette
PTL 2: U.S. Pat. No. 6,285,999

### SUMMARY OF INVENTION

### Technical Problem

The present invention has been proposed to solve the problems that reside in the prior arts as noted above, and an object thereof is to provide a system, which with respect to a variety of resources that are to be posted to the community over a network including the Internet and accumulated in a database, can generate an association (linking) according to a content of an automatically retrieved tag and/or behavior of a user over the resource, while automatically providing an objective valuation with respect to such a resource relative to the entire community using a predetermined valuation method and further associate points with the resource based on this valuation, so as to present the user a relative value for the resource within the community and further based on the points, allot and distribute the given points as a rewarded dividend to the user who has posted the resource, thus allowing the points to be automatically distributed in the community.

### Solution to Problem

In order to accomplish the object as stated above, an invention according to claim 1 relates to (i) a system operable, with respect to a resource to be input by a user via an interface (21), to calculate and output resource point for said resource, which comprises: a first storage means (42) operable to store said resource, a resource ID for identifying said resource and a first resource median value associated with said resource ID; (ii) a second storage means (45, FIG. 9B) operable to store one or more piece(s) of resource-tag association information including one of said resource IDs and a tag ID associated with said one of the resource IDs, said tag ID for identifying a tag to be retrieved from said resource identified by said resource ID; (iii) a first generation means (FIG. 9A, FIG. 17 and S1608) operable to generate a resource list corresponding to a value of the hop number with respect to one resource ID based on said one or more piece(s) of resource-tag association information stored in said second storage means repeatedly by sequentially incrementing the value of said hop number from 1, wherein each one of said resource lists to be generated contains one or more said resource ID(s) and based on said resource ID contained in said resource-tag association information, which further associates therewith each said tag ID associated with each said resource ID contained in a last generated said resource list; (iv) a first calculation means (S3401) operable to calculate the first resource median value for said one resource ID based on the value of said hop number and the values of said first resource median values, each respectively associated by said first storage means with each of said resource IDs contained in said resource list corresponding to the value of said hop number; (v) a second calculation means (S3404) operable to calculate further said point for said resource identified by said one resource ID based on said first resource median value calculated by said first calculation means; and (vi) a presentation means (D143) operable to present said point calculated by said second calculation means on said interface.

An invention according to claim 2 relates to a system in accordance with claim 1, wherein (i) said resource list having the value of said hop number of 1 to be generated in said first generation means is generated by subtracting said one resource ID from a sum set of said resource IDs contained in said resource-tag association information, which further associates therewith each said tag ID associated by said second storage means (45) with said one resource ID (S1603); and (ii) each of said resource lists having 2 or greater value taken as the value of said hop number to be generated in said first generation means is generated by retrieving a new said resource ID, which is not contained in any already generated said resource lists corresponding to any of the values of said hop number from a sum set of said resource IDs contained in said resource-tag association information, which further associates therewith each of said tag IDs associated respectively with said resource IDs contained in said last generated resource list (S1608).

An invention according to claim 3 relates to a system in accordance with claim 2, wherein further, said first generation means is operable to generate said resource list repeatedly until there are no more said new resource IDs to be retrieved or the value of said hop number has reached a given value as a result of the increment (S1607 and S1608).

An invention according to claim 4 relates to a system in accordance with any one of claims 1 to 3, wherein further, said first storage means is capable of storing a second resource median value associated with said resource ID, said system comprising: (i) a third storage means (44) operable to store one or more piece(s) of user behavior correspondence information including one of said resource IDs and a user ID associated with said one of the resource IDs, said user ID for identifying said user, and a behavioral classification for identifying a relation between said one of the resource IDs and said user ID; (ii) a third calculation means (S1803, S3503, and S1806) operable to calculate a user valuation value with respect to each one of said user IDs associated with said one resource ID based on said one or more piece(s) of user behavior correspondence information stored in said third storage means, wherein with respect to each one of said user IDs, said third calculation means calculates said user valuation value for said user ID based on: the value of said second resource median value that is further associated by said first storage means (42) with said resource ID in said user behavior correspondence information that associates therewith said user ID; the value indicative of said behavioral classification for identifying a relation between said resource ID in said user behavior correspondence information that associates with said user ID and said user ID; and the value indicative of said behavioral classification for identifying a relation between said one resource ID and said user ID in said third storage means; and (iii) a fourth calculation means (S1815) operable to calculate said second resource median value for said one resource ID based on said user valuation value for each one of said user IDs calculated in said third calculation means.

An invention according to claim 5 relates to a system in accordance with claim 4, further comprising: (i) a fourth storage means (41) operable to store said user ID and a user median value associated with said user ID; (ii) a fifth storage means (311) for storing one or more piece(s) of user association information including one of said user IDs, other said user IDs associated with said one of the user IDs and a user association type for identifying a relation between said one of the user IDs and said other user IDs; and (iii) a fifth calculation means (S3306) operable to calculate the value of said user median value to be stored in said fourth storage means (41) with respect to one user ID, wherein the value of said user median value to be stored is calculated based on the value of each said user median value that is further associated by said fourth storage means with each one of said other user IDs associated with said one user ID stored in said fifth storage means and based on each said user association type for identifying a relation between said one user ID of 1 and each of said other user IDs, wherein (iv) said second resource median value of said one resource to be calculated by said fourth calculation means is calculated further based on the value of each of said user median values that is further associated by said fourth storage means (41) with each of said user IDs in said user behavior correspondence information associated with said one resource ID stored in said third storage means (44).

An invention according to claim 6 relates to a system in accordance with claim 4, wherein said behavioral classification includes questioning, answering, negative rating, positive rating and/or viewing and the value indicative of said behavioral classification is set as weighted corresponding to each said behavioral classification.

An invention according to claim 7 relates to a system in accordance with claim 5, wherein said user association type includes favored user registration and/or denied user registration.

An invention according to claim 8 relates to a system in accordance with any one of claims 4 to 7, wherein further, said first storage means is capable of storing a resource demand-supply value associated with said resource ID, and said system comprises a sixth calculation means operable to calculate the value of said resource demand-supply value associated with said one resource ID to be stored in said first storage means (42), based on said first resource median value that has been calculated by said first calculation means and said second resource median value that has been calculated by said fourth calculation means, both with respect to said one resource ID.

An invention according to claim 9 relates to a system in accordance with claim 8, wherein the value of said resource demand-supply value to be calculated and stored by said sixth calculation means is based on a value from division between said second median value and said first median value.

An invention according to claim 10 relates to a system in accordance with claim 9, wherein said point for said resource identified by said one resource ID to be calculated by said second calculation means is calculated in accordance with normalization of the value of said resource demand-supply value associated with said one resource ID in said first storage means within a given range in relation to the values of all said resource demand-supply values associated with all said resource IDs stored in said first storage means.

An invention according to claim 11 relates to a system in accordance with any one of claims 1 to 10, comprising (i) a sixth storage means (not shown) operable to store said points for said resource identified by said resource ID and the time and date when calculation of said points for said resource has been made by said second calculation means, wherein said time and date when the calculation of said points has been made is such a time and date, including the time and date when said resource has been input as well as a timing by a fixed interval set, a fixed time and/or any timing as set, said system characterized in that (ii) said presentation means is further operable to create and present on said interface (21) a resource point transition graph (D142) with respect to said resource identified by said one resource ID, which is based on said time and date and said points associated with said one resource ID stored in said sixth storage means.

An invention according to claim 12 relates to a method to be carried out on a server (13), said server (13) comprising a database (152) within a storage unit, said database (152) containing: (i) a resource table (42) for storing two or more pieces of resource information including a resource, a resource ID for uniquely identifying said resource and resource point; (ii) a tag table (43) for storing two or more pieces of tag information including a tag and a tag ID for uniquely identifying said tag; and (iii) a resource-tag association table (45) for storing one or more piece(s) of resource-tag correspondence information including one of said resource IDs possessed by said resource information and one or more tag ID(s) associated with said resource ID, wherein (iv) said method is carried out by a processing unit (14) further provided on said server (13) equipped with a temporary memory (153) to calculate and store a value of resource point in one piece of said resource information based on values of said resource points in other pieces of said resource information so as to increase or decrease account point, said method comprising: (v) a selection step (S1601) of selecting a value of said resource ID in one piece of said resource information stored in said resource table (42); (vi) a first resource list generation and storage step (S1603) including: retrieving (S1601) the value of said tag ID in said resource-tag correspondence information having the value of said selected resource ID as the value of said resource ID in said resource-tag correspondence information; further retrieving the resource ID in said resource-tag correspondence information having the value of said retrieved tag ID as the value of said tag ID in said resource-tag correspondence information; generating a list composed of the values of said resource IDs, which are determined by deleting the value of said selected resource ID from a sum set of the values of said retrieved resource IDs, as a resource list corresponding to the hop number of 1 taken as said hop number with respect to said selected resource ID; and storing the thus generated list into said temporary memory (153); (vii) a second resource list generation and storage step (S1608) of generating said hop number correspondent resource list with the value of said hop number, which is an integer of 2 or a greater number, repeatedly, by incrementing (S1606) the value of said hop number from 2 until a given condition (S1607) is satisfied and storing the thus generated list into said temporary memory (153), said second resource list generation and storage step (S1608) including: retrieving the value of said tag ID in said resource-tag correspondence information having the value of said resource ID possessed by the last generated said hop number correspondent resource list as the value of said resource ID in said resource-tag correspondence information; further retrieving the value of said resource ID in said resource-tag correspondence information having the value of said retrieved tag ID as the value of said tag ID in said resource-tag correspondence information; and generating a list composed of the values of said resource IDs, which are determined by deleting the value of said resource IDs possessed respectively by all first resource lists stored in said temporary memory from a sum set of the values of said retrieved resource IDs, as said hop number correspondent resource list, which list will be repeatedly generated; (viii) a first calculation step (S1604, S1605, and S1609) of calculating a first resource median value with respect to said one piece of resource information based on the value of said hop number as well as the value of said resource point in said resource information having the value of each said resource ID possessed by each said hop number correspondent resource list corresponding to the value of said hop number as the value of said resource ID in said resource information stored in said resource table (42); and (ix) a second calculation step (S1503) of calculating first point with respect to said one piece of resource information based on said calculated first resource median value and storing said first point as the value of said resource point in said one piece of resource information into said resource table, wherein said method is executed by said processing unit at a first timing.

An invention according to claim 13 relates to a method in accordance with claim 12 executed by said processing unit (14), characterized in that: said resource information to be stored in said resource table (42) includes initial resource point associated with said resource ID, said method further comprising: (i) resource storage steps (S1202, S1204, and S2501) of newly storing one or more piece(s) of a first text newly input via an interface (21), each as a new resource in said resource information, along with the value of said resource ID in said new resource information and the value of said initial resource point, into said resource table (42); (ii) a tag retrieval and storage step (S2004) for newly storing a new second text that is to be retrieved respectively from said one or more piece(s) of said first text, which has been newly stored by said resource storage steps (S1202, S1204, and S2501) and that has not yet been stored as the tag in said tag information stored in said tag table (43), as the tag in new said tag information, along with the value of said tag ID in said new tag information, into said tab table (43); and (iii) a step of storing new said resource-tag correspondence information including the value of said resource ID in said new resource information that has been stored by said resource storage step and the value of said tag ID in said new tag information that has been stored by said tag retrieval and storage step into said resource-tag association table, wherein the value of said initial resource point for said new resource information that has been stored by said resource storage step is calculated, at the time of an input via said interface taken as said first timing, (iv) by selecting (S1601) the value of said resource ID in said new resource information in said selection step followed by a series of said first resource list generation and storage step (S1603), (v) said second resource list generation and storage step (S1608), (vi) said first calculation steps (S1604, S1605, and S1609) and (vii) said second calculation step (S1503).

An invention according to claim 14 relates to a method in accordance with claim 13, characterized in that said second text to be retrieved from said first text by said tag retrieval and storage step retrieved by: (i) retrieving a group of first keywords including one or more first keyword(s) from said first text (S2002); (ii) using each first keyword in said retrieved group of first keywords to make a search over a text set comprising a plurality of pairs of words and their description to be stored in a second database (19), which is to be stored in a storage unit of a second server configured on the network in coordination with said database (152) of said server (13) with the aid of an application interface, for said word corresponding to each said first keyword so as to obtain said description for said word matched with said first keyword (S2002 and S2101); (iii) further retrieving a group of second keyword including one or more second keyword(s) from the thus obtained said description (S2002 and S2102); and (iv) using each said second keyword included in the group of said retrieved second keywords to make a search over said resources in said resource information in said resource table (42) and deleting those said second keywords that have been stored in excess of a given number from the group of said second keywords so as to retrieve said second text (S2003 and S2104-S2107).

An invention according to claim 15 relates to a method in accordance with claim 13 or 14, wherein further, (i) said database (152) contains a user history table (44) for storing two or more pieces of user behavior correspondence information including one of said resource IDs possessed by said resource information in said resource table (42) and one or more user ID(s) and a corresponding behavioral classification associated with said one of said resource IDs, said method comprising: (ii) a behavioral classification retrieval step (S1801) of retrieving the value of said one or more user ID(s) in said user behavior correspondence information having the value of said resource ID in said one piece of resource information selected by said selection step (S1601) as the value of said resource ID in said user behavior correspondence information stored in said user history table (44) and the value of its first said corresponding behavioral classification and storing the thus retrieved values into a temporary memory (153); (iii) a third calculation step (S1803-S1806) of calculating a valuation value for said one user ID repeatedly for every one of the values of said retrieved one or more user ID(s) and storing the thus calculated valuation value into said temporary memory (153), said third calculation step including a series of step (S1803) comprising: retrieving the value of one or more resource ID(s) and the value of its second said corresponding behavioral classification possessed by said user behavior correspondence information having the value of said one user ID as the value of said user ID in said user behavior correspondence information stored in said user history table (44); generating a list, which is created by deleting the value of said selected resource ID from a sum set of the values of said retrieved one or more resource ID(s), as a second resource list with respect to said selected resource ID; and storing the thus generated second resource list into said temporary memory (153), and (iv) a series of step (S1805) comprising: calculating the valuation value for said one user ID based on: the value of said first behavioral classification retrieved at said behavioral classification retrieval step (S1801); the value of said resource point in said resource information having the value of each said resource ID possessed by said generated second resource list as the value of said resource ID in said resource information stored in said resource table (42); and the value of said retrieved second behavioral classification with respect to the value of said resource ID in said resource information; and storing the thus calculated valuation value into said temporary memory (153); (v) a step of calculating a second resource median value with respect to said one piece of resource information based on each said valuation value for said retrieved one or more user ID(s) (S1512, S1808, and S1815); and (vi) a step of further calculating second point with respect to said one piece of resource information based on said calculated first resource median value and said calculated second resource median value, both with respect to said one piece of resource information and storing in said resource table (42) (S1503) the thus calculated second point as the value of said resource point for said one piece of resource information, wherein said method is executed by said processing unit (14) at said first timing.

An invention according to claim 16 relates to a method in accordance with claim 15, further comprising third point storage step (S1503), said step including: (i) with respect to each of the values of said resource IDs in all pieces of said resource information stored in said resource table (42), making a selection for retrieval as said resource ID in said one piece of resource information at said selection step (S1601); (ii) subsequently calculating the values of said first resource median values for said all pieces of resource information and the values of said second resource median values for said all pieces of resource information, respectively, through the series of steps including said first resource list generation and storage step (S1603), said second resource list generation and storage step (S1608), said first calculation steps (S1604, S1605, and S1609) and said second calculation step (S1503); (iii) based on a ratio of the sum of calculated said first resource median values to the sum of calculated said second resource median values, calculating third points for said all pieces of resource information, respectively, and storing the thus calculated said third points into said temporary memory (153), (iv) wherein the thus respectively calculated third points are stored respectively as the values of said resource points in said all pieces of resource information in said resource table (42), wherein said method is executed by said processing unit (14) at said first timing.

An invention according to claim 17 relates to a method in accordance with claim 16, further comprising (i) a user table (41) for storing two or more pieces of user account information including said user ID for uniquely identifying a user and account point associated with said user ID, wherein (ii) said two or more pieces of resource information to be stored in said resource table (42) further contain, respectively, one posting user ID associated with said resource ID in said resource information, the value of said posting user ID representing the value of said user ID of said user who has posted said first text; and (iii) said behavioral classification in said two or more pieces of user behavior correspondence information stored in said user history table (44) includes those representing questioning, answering, negative rating, positive rating, and viewing, whose corresponding values are taken as the value of said behavioral classification, said method comprising: (iv) said resource storage steps (S1202, S1204, and S2501), which work to store the value of said user ID of the user who has input said first text via said interface (21) as the value of said posting user ID in said new resource information, while concurrently storing said user behavior correspondence information including the value of said resource ID in said new resource information, the value of said posting user ID in said new resource information and the value of any one of said behavioral classifications other than the viewing that corresponds to the one that has been selected by said user, in said user history table (44); and (v) a step occurring at the time when any one of the values of said resource IDs of said resources possessed by said all pieces of resource information stored in said resource table (42) is specified by any said user via said interface (21) so as to store said user behavior correspondence information including the value of said specified resource ID, the value of said user ID identifying said user who has invoked said specification and the value corresponding to said classification representing the viewing into said user history table (44), wherein said method is executed by said processing unit (14).

An invention according to claim 18 relates to a method in accordance with claim 17, further comprising: (i) a point investment step characterized by subtracting the initial resource point in said new resource information stored in said resource table (42) from the value of said account point in said user account information that has the value of said posting user ID in said new resource information as the value of said user ID in said user account information stored in said user table (41) and then further storing a result from said subtraction as the value of said account point in said user account information in said user table (41) so as to increase or decrease the value of said account point, (ii) wherein every piece of tag information stored in said tag table (43) further comprises tag point, wherein the tag point in one piece of said tag information can take for storage a value from a summation of the resource point in said resource information that further has as the value of said resource ID in said resource information stored in said resource table (42), the value of one or more resource ID(s) in said resource-tag correspondence information having the value of said tag ID in one piece of said tag information as the value of said tag ID in said resource-tag correspondence information stored in said resource-tag association table (45), said method further comprising: (iii) a fourth points calculation and storage step occurring at said first timing to calculate the fourth points for all pieces of said tag information and store each of the values of said fourth points as the value of said tag points in said tag information in said tag table; (iv) a reward distribution step including: at the second timing as specified when said first text of said resource in said new resource information has been input via said interface (21), (a) selecting the value of said resource ID in said new resource information by said selection step; (b) generating said hop number correspondent resource list having said hop number of 1 with respect to said resource ID in said new resource information by said first resource list generation and storage step (1603); (c) summing up the values of said tag points in pieces of said tag information, each of which further has, as the value of said tag ID in said tag information stored in said tag table (43), the value of said one or more tag ID(s) in said resource-tag correspondence information, each having the value of each resource ID possessed by said hop number correspondent resource list as the value of said resource ID in said resource-tag correspondence information stored in said resource-tag association table (45) to calculate thereby each total value of said tag points with respect to each resource ID possessed by said hop number correspondent resource list having said hop number of 1 and storing the thus calculated value into said temporary memory (153); (d) calculating each value of the point to be allotted with respect to each said resource ID possessed by said hop number correspondent resource list from the value of said initial resource point in said new resource information stored in said resource table (42) based on the ratio of the sum of the values of said stored tag points and storing the thus calculated each value of said point in the temporary memory (153); and (e) adding each value of said stored point to be allotted to each value of the account point in said user account information that further has, as the value of said user ID in said user account information in said user table (41), the value of said posting user ID in said resource information that has the value of each said resource ID possessed by said hop number correspondent resource list as the value of said resource ID in said resource information stored in said resource table (42), and storing each result from the addition taken as the value of said account point in said user account information into said user table (41), wherein said method is executed by said processing unit (14).

An invention according to claim 19 relates to a method in accordance with claim 18, wherein (i) said database (152) further comprises an operation management table (48) for storing two or more pieces of management information, each of which includes point to be paid, point to be collected, and a time of point movement in the reward distribution, said method further comprising: (ii) a first management information storage step of storing in said operation management table said management information including the value of said initial resource point in said new resource information stored in said resource table taken as the value of said point to be paid, a difference between the value of said resource point in said new resource information and the total value of allotted points stored in said temporary memory taken as the value of said point to be collected and the time of said second timing taken as the value of said time of point movement, wherein said method is executed by said processing unit (14).

An invention according to claim 20 relates to a method in accordance with claim 19, characterized in further comprising a process occurring at a third timing and including: (i) a step of multiplying each value of said account point possessed by every piece of said account information stored in said user table (41) by a given rate; truncating values at decimal places from the result from said multiplication to yield an integer; subtracting the thus yielded integer from each value of said account point; and storing the result from said subtraction taken as the value of said account point in said user account information into said user table (41); and (ii) a second management information storage step of storing in said operation management table (48), said management information including said integer value taken as the value of said point to be paid as well as the value of said point to be collected in said management information to be stored in said operation management table (48) and the time of said third timing taken as the value of said time of point movement, wherein said method is executed by said processing unit (14).

An invention according to claim 21 relates to a method in accordance with claim 20, wherein (i) said database (152) further comprises a points distribution management table (49) for storing two or more pieces of points distribution information including total distribution point, said method comprising a process occurring at said first timing and including: (ii) a step (S301) of calculating a total sum of the values of said points to be paid possessed by said management information with the value of said time of points movement falling within a given range among those pieces of said management information stored in said operation management table (48) by said first management information storage step and/or said second management information storage step and storing the thus calculated value of said total sum taken as the value of said total distribution point into said points distribution management table (49); (iii) a step (S302) of calculating a total distribution point increase rate by taking a ratio of the value of said total distribution point that has been thus stored to the total distribution point in the last stored said points distribution information among those pieces of points distribution information that have been already stored and storing thus calculated total distribution point increase rate in said temporary memory (153); and (iv) a step (S292) of calculating and storing fifth point with respect to said new resource information, said step including: calculating the fifth point based on the fourth point that have been calculated with respect to said new resource information by said fourth points calculation and storage step and the total distribution point increase rate that has been stored in said temporary memory (153) and storing the thus calculated point taken as the value of resource point in said newly input one piece of resource information into said resource table (42), wherein said method is executed by said processing unit (14).

### BRIEF DESCRIPTION OF DRAWINGS

FIG. 1 shows a general overview of a configuration for a point(s) valuation and allotment system according to the present invention;

FIG. 2 shows a preferred overall flow between a client terminal 12 and a point(s) valuation and allotment server in Example 1 of a point(s) valuation and allotment system according to the present invention;

FIG. 3 shows a list of preferred functions in Example 1 of a point(s) valuation and allotment system according to the present invention;

FIG. 4 shows a list of preferred tables and their associations in Example 1 of a point(s) valuation and allotment system according to the present invention;

FIG. 5 shows a preferred questioning resource registration flow in Example 1 of a point(s) valuation and allotment system according to the present invention;

FIG. 6 shows a preferred answering resource registration flow in Example 1 of a point(s) valuation and allotment system according to the present invention;

FIG. 7 shows a preferred rating resource registration flow in Example 1 of a point(s) valuation and allotment system according to the present invention;

FIG. 8A shows an exemplary resource classification link in Example 1 of a point(s) valuation and allotment system according to the present invention;

FIG. 8B shows a specific table storage condition with respect to the exemplary resource classification link in Example 1 of a point(s) valuation and allotment system according to the present invention;

FIG. 9A shows an exemplary tag link in Example 1 of a point(s) valuation and allotment system according to the present invention;

FIG. 9B shows a specific table storage condition with respect to the exemplary tag link in Example 1 of a point(s) valuation and allotment system according to the present invention;

FIG. 10A shows an exemplary behavior link in Example 1 of a point(s) valuation and allotment system according to the present invention;

FIG. 10B shows a specific table storage condition with respect to the exemplary behavior link in Example 1 of a point(s) valuation and allotment system according to the present invention;

FIG. 11 shows a list of preferred functions in Example 2 of a point(s) valuation and allotment system according to the present invention;

FIG. 12 shows a preferred questioning resource registration flow in Example 2 of a point(s) valuation and allotment system according to the present invention;

FIG. 13 illustrates, in the form of flow chart, a preferred pricing process timing in Example 2 of a point(s) valuation and allotment system according to the present invention;

FIG. 14 shows a preferred user screen image in Example 2 of a point(s) valuation and allotment system according to the present invention;

FIG. 15 shows a preferred pricing process flow in Example 2 of a point(s) valuation and allotment system according to the present invention;

FIG. 16 shows a process flow of a preferred resource median value calculation in accordance with a tag(s) in Example 2 of a point(s) valuation and allotment system according to the present invention;

FIG. 17 shows conceptually an exemplary preferred transition of a tag link in Example 2 of a point(s) valuation and allotment system according to the present invention;

FIG. 18A shows a process flow of a preferred resource median value calculation in accordance with user behavior(s) in Example 2 of a point(s) valuation and allotment system according to the present invention;

FIG. 18B represents an exemplary preferred behavior link in Example 2 of a point(s) valuation and allotment system according to the present invention;

FIG. 19 shows a list of preferred functions in Example 3 of a point(s) valuation and allotment system according to the present invention;

FIG. 20 shows a preferred general overview of Example 3 of a point(s) valuation and allotment system according to the present invention;

FIG. 21 shows a preferred feature vector retrieval process flow in Example 3 of a point(s) valuation and allotment system according to the present invention;

FIG. 22 shows a process flow of a preferred tag retrieval in accordance with a genetic algorithm in Example 3 of a point(s) valuation and allotment system according to the present invention;

FIG. 23 shows a schematic diagram of a preferred reward distribution in Example 4 of a point(s) valuation and allotment system according to the present invention;

FIG. 24 shows a list of preferred functions in Example 4 of a point(s) valuation and allotment system according to the present invention;

FIG. 25 shows a preferred questioning resource registration flow in Example 4 of a point(s) valuation and allotment system according to the present invention;

FIG. 26 shows a flow of a preferred direct allotment process in Example 4 of a point(s) valuation and allotment system according to the present invention;

FIG. 27 shows a flow of a preferred indirect allotment process in Example 4 of a point(s) valuation and allotment system according to the present invention;

FIG. 28 shows an exemplary preferred management table in Example 5 of a point(s) valuation and allotment system according to the present invention;

FIG. 29 shows a preferred pricing process flow in Example 5 of a point(s) valuation and allotment system according to the present invention;

FIG. 30 shows an exemplary preferred intra-community points current ratio (increase rate) calculation process flow in Example 5 of a point(s) valuation and allotment system according to the present invention;

FIG. 31 shows a list of improved tables and their associations in Example 6 of a point(s) valuation and allotment system according to the present invention;

FIG. 32A shows an exemplary user link in Example 6 of a point(s) valuation and allotment system according to the present invention;

FIG. 32B shows a specific table storage condition with respect to the exemplary user link in Example 6 of a point(s) valuation and allotment system according to the present invention;

FIG. 33 shows a flow of a user median value calculation in accordance with a link(s) between users in Example 6 of a point(s) valuation and allotment system according to the present invention;

FIG. 34 shows an improved pricing process flow in Example 6 on a point(s) valuation and allotment system according to the present invention;

FIG. 35 shows a process flow of an improved resource centricity calculation in accordance with user behavior(s) in Example 6 of a point(s) valuation and allotment system according to the present invention;

FIG. 36 shows an exemplary improved behavior link with a user link taken into account in Example 6 of a point(s) valuation and allotment system according to the present invention; and

FIG. 37 shows a process flow of an improved resource centricity calculation in accordance with a tag(s) in Example 6 according to the present invention.

### DESCRIPTION OF EMBODIMENTS

A point(s) valuation and allotment system with respect to resources according to the present invention will be described below in accordance with some modes of embodiment with reference to the drawings.

### Example 1

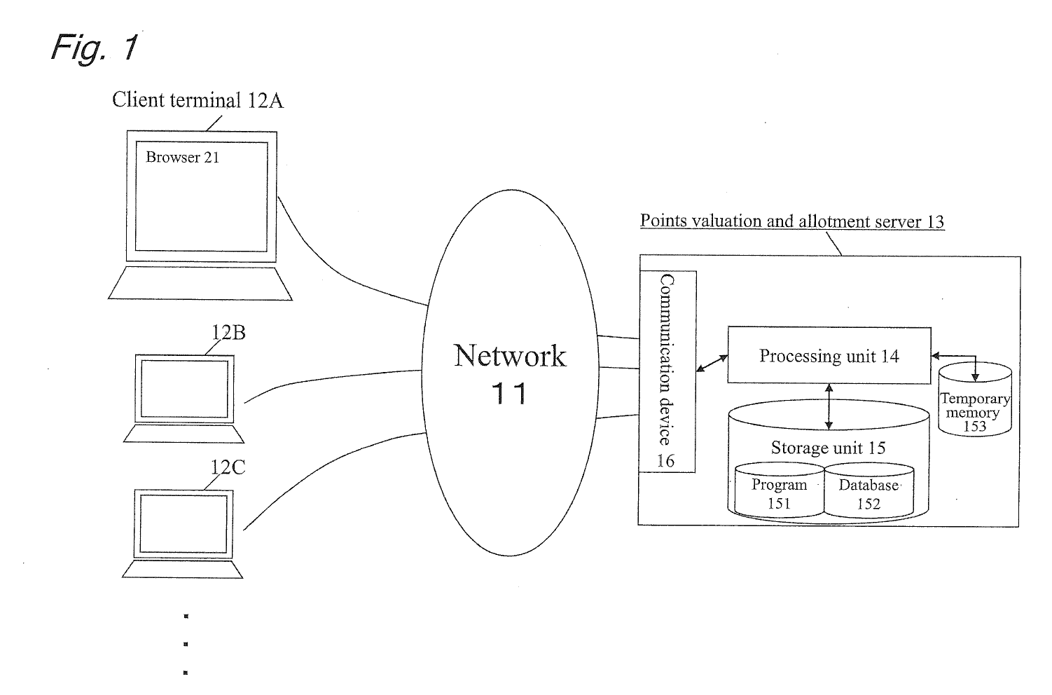

FIG. 1 illustrates schematically a construction of a first mode of embodiment of a point(s) valuation and allotment system according to the present invention. Referring to FIG. 1, the point(s) valuation and allotment system is constructed by interconnecting a plurality of client terminals 12A, 12b, 12C . . . with a point(s) valuation and allotment server 13 via a communication network 11. Such a system allows a user to have an access to the point(s) valuation and allotment server 13 over the network 11 by means of the client terminal.

In this regard, the point(s) valuation and allotment server 13 comprises a processing unit 14, a storage unit 15, and a communication device 16. The storage unit 15 can be constructed with a medium, including a hard disc and a random access memory (RAM). Further, the communication network 11 may be any network including the interne network. The client terminals 12A to 12N may be a commonly used computer system, i.e., a desktop or laptop personal computer, or even a portable terminal, such as a cellular phone and a PDA, which is connectable to said network 11. In addition, each one of the client terminals 12A to 12N comprises a browser 21 for interaction with the point(s) valuation and allotment server 13 in addition to a communication device (not shown) for connecting with the processing unit 14 and/or the network 11. The point(s) valuation and allotment system can be a network system of a known client-server type.

In this regard, said storage unit 15 provided on the point(s) valuation and allotment server 13 can store a program 151 for activating said server 13, a database 152, which is a collection of pieces of information such as values and others and can be searched by using said server 13, and a temporary memory 153 for storing the information temporarily. The point(s) valuation and allotment server 13 is configured such that the processing unit 14 may activate the program 151 stored in the storage unit 15, so that the data contained in the database 152 thereby can be registered, searched, updated, deleted or otherwise processed to achieve a desired processing. In this regard, the database 152 can be a known relational type database.

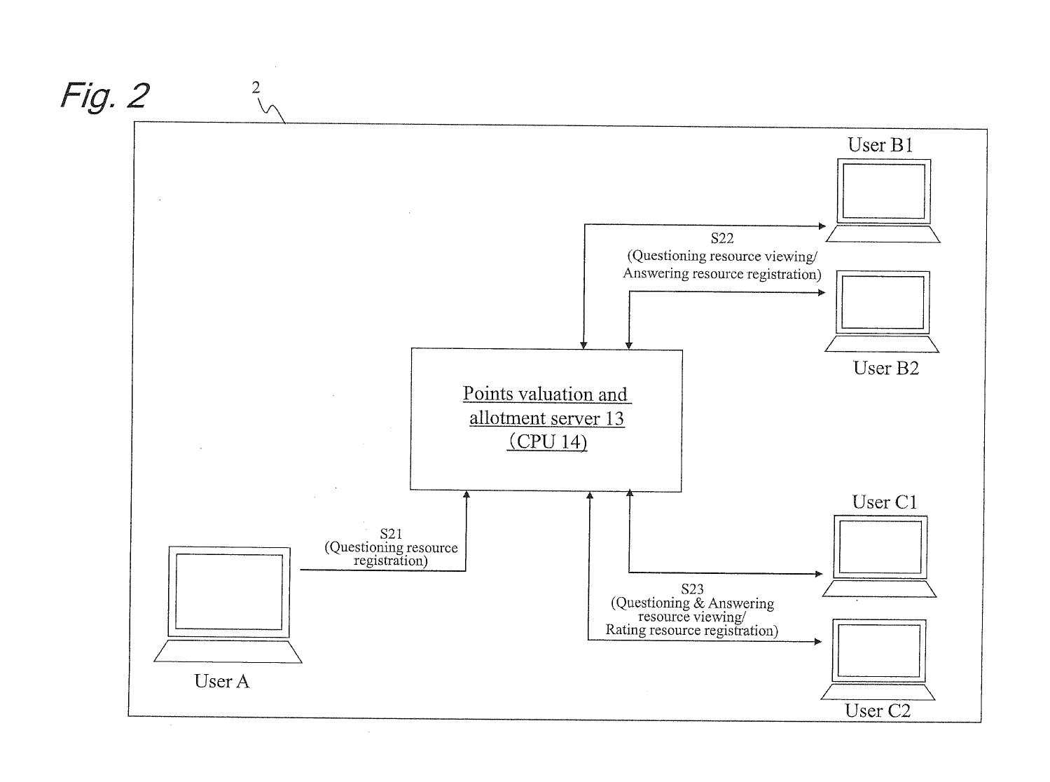

Turning now to FIG. 2, description will be given to a preferred overall flow (2) between the client terminal 12 and the point(s) valuation and allotment server 13 in a first embodiment of a point(s) valuation and allotment system according to the present invention as implemented in such a configuration. Referring to FIG. 2, there are users A, B1, B2, C1, and C2, each as a user accessing the point(s) valuation and allotment server 13 and each capable of interacting with the point(s) valuation and allotment server via the browser 21 provided on the user's own client terminal and the network 11. Further, these users, as in a service realized by the system, can belong to a field (hereinafter referred to as a “community”), which is realized virtually and provided to the users by the point(s) valuation and allotment server and can upload resources freely within this community. As used herein, the resource refers to a content to be posted by a user and the contents, as input in a plurality of fields, such as a title, text, and the likes, should be coupled together to be treated as a single resource on the point(s) valuation and allotment server. In addition, the resource may include not only text data but also format data such as an image and others.

Initially, the user A can post a question having, for example, such a context as “Teach me how to install MS Office 2007” to the community as a questioning resource along with an answer reception deadline (S21). This questioning resource is disclosed to another user after its registration having been completed. The users B1 and B2, upon viewing the questioning resource, can post answers with respect to the question, respectively, for example, such as “It can be installed as in the current environment,” which may be considered appropriate as answering resources (S22). Further, the users C1 and C2, upon viewing the questioning resource and/or the answering resource can post a rating, for example, “This can be of good help” as rating resources with respect to the questioning resource and/or answering resource (S23). In this way, the resources, specifically those including the questioning resources, the answering resources and the rating resources, will be sequentially accumulated in the database 152 of the point(s) valuation and allotment server.

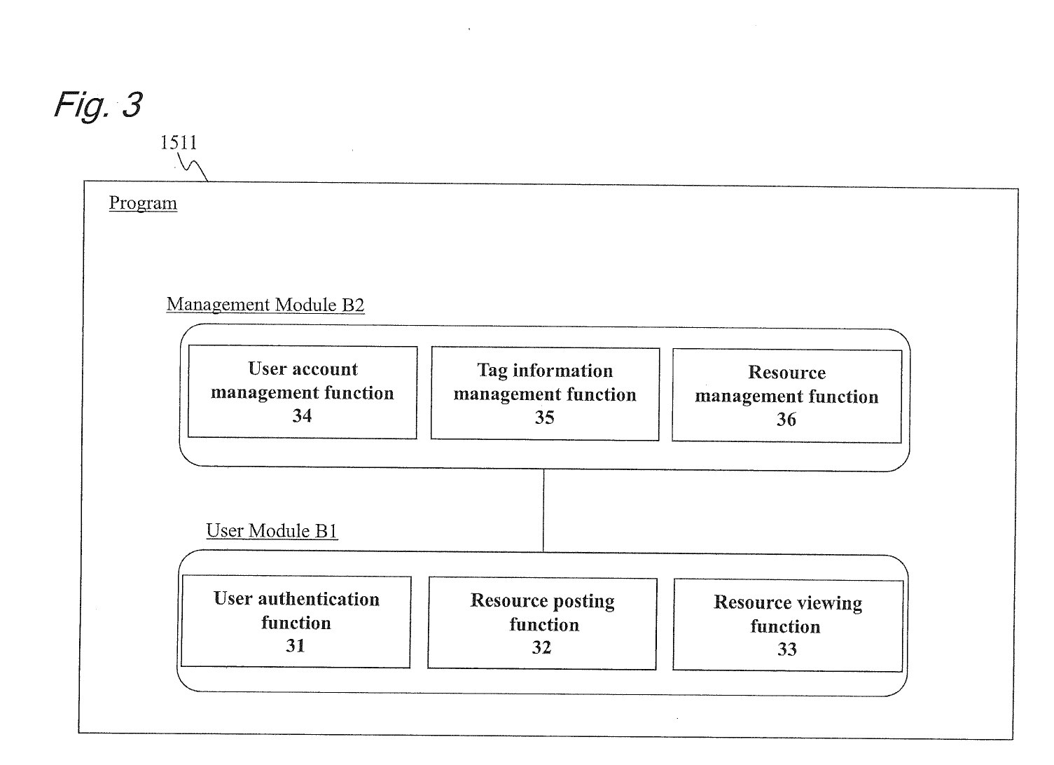

FIG. 3 shows a list of preferred functions and their associations in the first embodiment of a point(s) valuation and allotment system according to the present invention. The program 1511 to be stored in the storage unit 15 provided on the point(s) valuation and allotment server 13 may comprise a user module B1 for realizing functions 31 to 33 and a management module B2 for realizing functions 34 to 36.

A user authentication function 31 can authorize an access to the server and use of various functions by a user through a request for an authentication process from a client terminal. A resource posting function 32 can authorize a request for posting a resource from a client terminal and accept posting of a resource by a user. A resource viewing function 33 can authorize a request for viewing resources from a client terminal and perform searching over a variety of resources stored in the database 152 and presentation of resource contents.

A user account management function 34 can carry out management of authentication information for execution of the user authentication function and the management of a user profile as well as the management of an account in connection with a user account. A tag information management function 35 can carry out automatic retrieval of a tag at any given time from a group of resources posted by users and management of a variety of tag information, including registration, updating, or deletion of the retrieved tag information to/from the database 152. A resource management function 36 can carry out management of a variety of resource information, including registration of a resource posted by a user, association between resources, association between a tag and a resource, and association between a user and a resource.

Further, the program 1511 may include, in addition to the modules for realizing the functions 31 to 36 as described above, a generic communication program that enables a computer to communicate by using a protocol, for example, the TCP/IP and the like and any known program in a typical database management system.

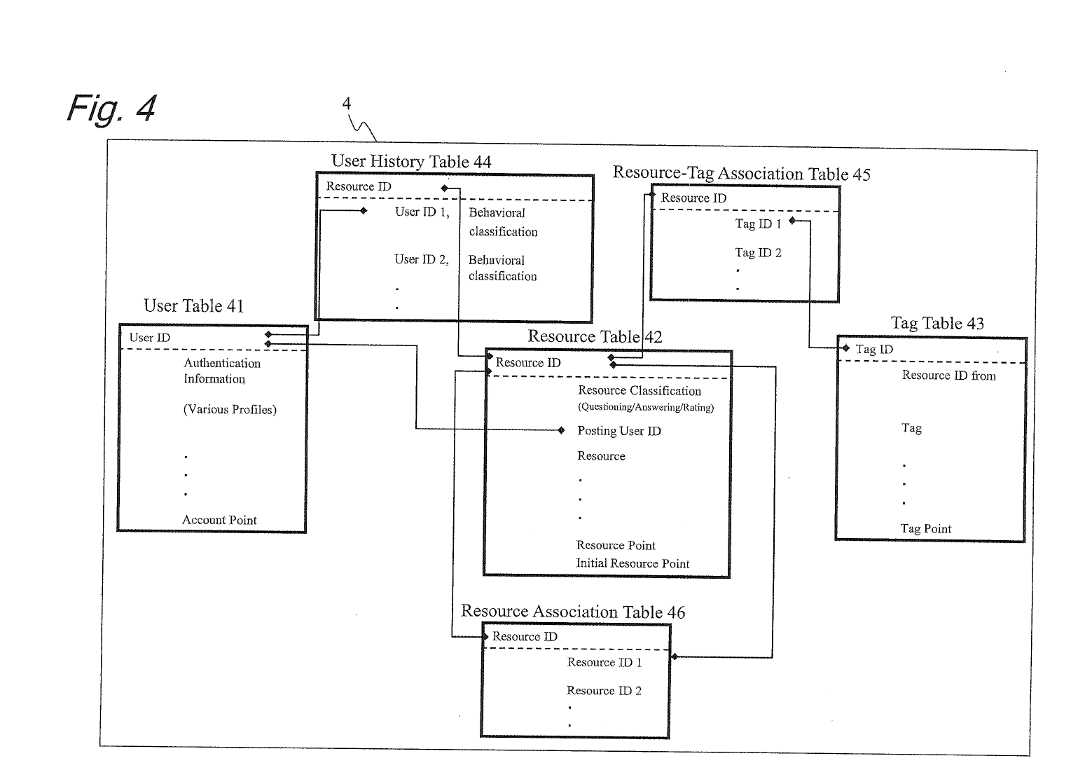

As shown in FIG. 4 presenting a list of preferred tables and relations therebetween (4), the database 152 may contain a user table 41, a resource table 42, a tag table 43, a user history table 44, a resource-tag association table 45, and a resource association table 46.

Specifically, the user table 41 may contain a user ID for uniquely identifying a user, authentication information, a variety of profile information of the user and information of account point possessed by a user account associated with said user ID, as user account information. The resource table 42 in which resource information to be posted by a user is stored, may contain a resource, a resource ID for uniquely identifying the resource, resource attribute information including a resource classification and a posting user ID and resource point information including resource point possessed by the resource as well as initial resource point, all of which is contained as the resource information. As used herein, the resource classification refers to the classifications including “questioning,” “answering,” and “rating” in the present embodiment. The tag table 43, in which tag information to be retrieved from a group of resources is stored, may contain a tag, a tag ID for uniquely identifying said tag, tag attribute information, a content of the tag and tag point possessed by the tag, all of which is contained as the tag information. The user history table 44, in which history information of a user with respect to a resource is stored, may contain a resource ID, a user ID and a behavioral classification, all of which are contained as user behavior correspondence information. As used herein, the behavioral classification refers to the classifications including “questioning,” “answering,” “rating,” and “viewing” in the present embodiment. In addition to those stated above, the classifications such as “buying,” “registration on bookmark,” and “requesting for resource deletion” may be included. In addition, the behavioral classification “rating” may be further subdivided into a plurality of classifications, such as “positive rating” and “negative rating.” The resource-tag association table 45 in which association information between a resource and a tag is stored, may contain one of the resource IDs possessed by the resource information and one or more tag ID(s) associated with that resource ID, all of which is contained as the resource-tag correspondence information. The resource association table 46 in which a parent-child information between two resources is stored, may contain a resource ID and its child resource ID. As used herein, the parent-child information indicates, with respect to which one resource the other resource has been registered, for example, the answering resource registered with respect to the questioning resource, the rating resource registered with respect to the answering resource and so on.

It is to be noted that the user table 41 will be associated with the user behavior correspondence information in accordance with the user ID identifying the user. Further, in the resource table 42, the resource information will be associated in accordance with the resource ID identifying the resource. In addition, in the tag table 43, the tag information will be associated in accordance with the tag ID identifying the tag; in the user history table 44, the user history information is associated in accordance with the resource ID; in the resource-tag association table 45, the tag information will be associated in accordance with the resource ID; and in the resource association table 46, the child resource ID will be associated in accordance with the resource ID.

Further, the user table 41 and the resource table 42 can be linked by using the user ID as a key, the tag table 43 and the resource table 42 can be linked by using the resource ID as a key, and in a similar manner, the resource table 42 and the user history table 44, the resource-tag association table 45 and the resource association table 46 can be linked respectively by using the resource ID as a key.

It is to be noted that the descriptions related to the program and the database as set forth above, specifically, the descriptions related to any particular modular configuration, functional configuration, table configuration and the items in the table as well as the key items and the likes therein are intended to be only illustrative but not limiting to them.

An overview of the point(s) valuation and allotment system in the present embodiment will be described below.

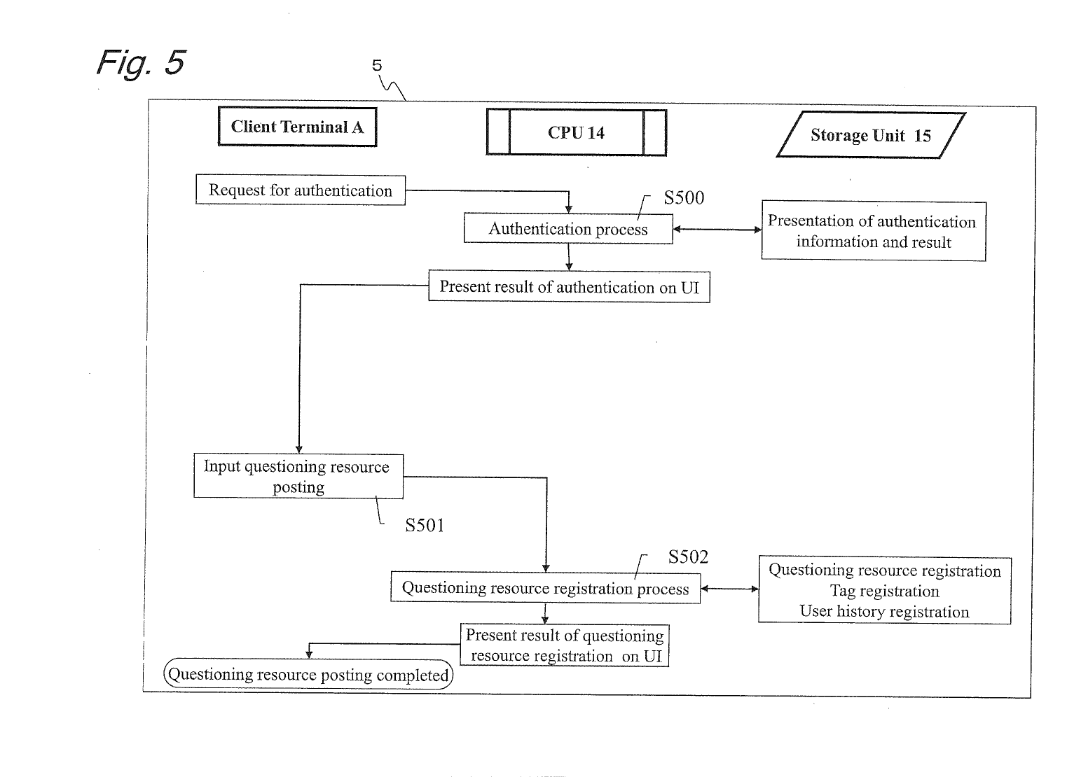

Turning now to FIGS. 5, 6, and 7, description will be given to a flow between a client terminal, a program on the server and a database during the registration of a questioning resource, an answering resource, and a rating resource in a point(s) valuation and allotment system according to the present invention. It is to be noted that the processing unit 14 and the storage unit 15, as illustrated, are to be provided on the point(s) valuation and allotment server 13.

FIG. 5 shows a questioning resource registration flow (5) by a client terminal A onto the point(s) valuation and allotment server. Initially, at S500, the processing unit 14, in response to a request for authentication from the client terminal A, performs an authentication process by using the user authentication function 31, the user account management function 34, and the information stored in the user table 41. This authentication process may be of, by way of example but not limited to, a commonly used ID/password method. Once the authentication process has been normally completed, the point(s) valuation and allotment server is able to accept a request for posting a questioning resource from the client terminal A. At S502, the processing unit 14 stores the resource along with the resource information with “classification=questioning” in the resource table 42 through the resource posting function 36. In this step, the management may be provided by using a status, such as “temporary registration” or “authorized registration” for the registration information of the questioning resource. Concurrently at S501, in addition to the resource information, the client terminal A can specify the tag information related to that resource for posting and further the history of “questioning” is stored in the user history table 44. Thus, the registration of the questioning resource will be completed.

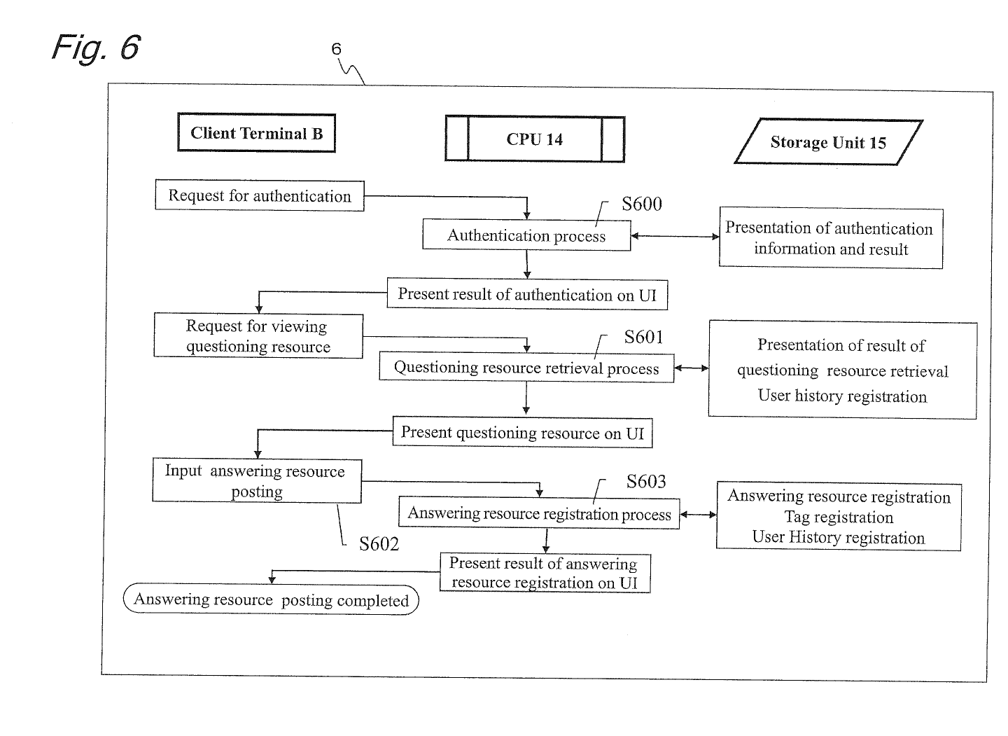

FIG. 6 shows an answering resource registration flow (6) by a client terminal B onto the point(s) valuation and allotment server. An authentication process at S600 is carried out similarly as described above with reference to FIG. 5. The point(s) valuation and allotment server, in receipt of a request for viewing the questioning resource by the client terminal B, make a search over the resource table 42 by using a given condition for search with the aid of the resource viewing function 33 at S601 and then presents a search result on the client terminal B. In this regard, the condition for search may be but is not limited to a case in which the search should be made in accordance with the time and date when the questioning resource has been registered, or to a keyword. With respect to this searched questioning resource, an answering resource could be posted from the client terminal B (S602). At S602, in addition to the resource information, the client terminal B can specify the tag information related to that resource for posting. At S603, the server, in receipt of a request for the registration of the answering resource with respect to a certain questioning resource by the resource posting function 32, stores the resource along with the posted resource information with “classification=answering” as determined by the resource management function 36, into the resource table 42. In this step, the management can be also made by using a status, such as “temporary registration” or “authorized registration” for the registration information of the answering resource. Concurrently, the posted tag information is stored in the tag management table 43, and the history of “answering” is stored in the user history table 44. Thus, the registration of the answering resource is completed.

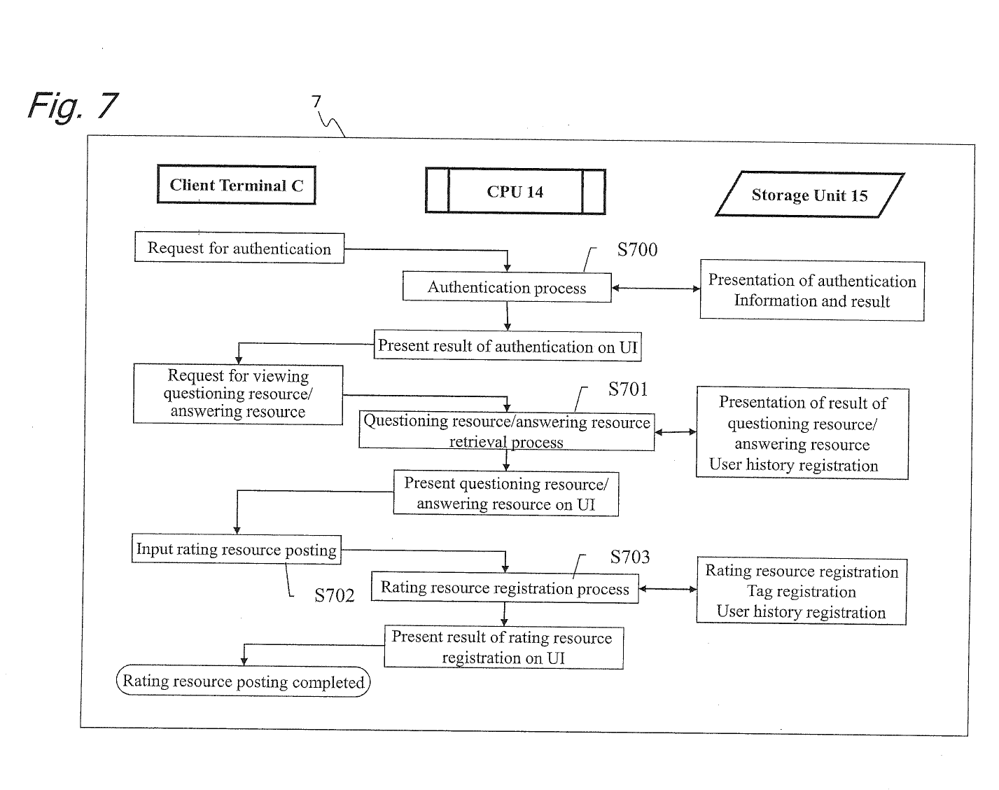

FIG. 7 shows a rating resource registration flow (7) by a client terminal C onto the point(s) valuation and allotment server. An authentication process at S700 is carried out similarly as described above with reference to FIG. 5. The point(s) valuation and allotment server, in receipt of a request for viewing the questioning resource and/or the answering resource by the client terminal C, makes a search over the resource table 42 by using a given condition for search with the aid of the resource viewing function 33 at S701 and then presents a search result on the client terminal C. In this regard, the condition for search may be, but is not limited to a case in which the search should be made in accordance with the time and date when the questioning resource has been registered, or a keyword. With respect to this searched questioning resource and/or answering resource, a rating resource could be posted by the client terminal C (S702). At S702, in addition to the resource information, the client terminal C can specify the tag information related to that resource for posting. At S703, the server, in receipt of a request for the registration of the rating resource with respect to a certain questioning resource or answering resource by the resource posting function 32, stores the rating resource along with the posted resource information with “classification=rating” as determined by the resource management function 36, in the resource table 42. In this step, the management can be also made by using a status, such as “temporary registration” or “authorized registration” for the registration information of the rating resource. Concurrently, the posted tag information is stored in the tag management table 43, and the history of “rating” is stored in the user history table 44. Thus, the registration of the rating resource will be completed. The term “community,” as used in the point(s) valuation and allotment system of the present embodiment, is to be defined as a whole world composed of a set of resources accumulated in the resource table 42 as well as a set of users and a set of tags, which are accumulated in a group of tables including the user table 41 and the tag table 43 to be linked with the resource table 42. The community can be also defined as a set of a plurality of communities with IDs that can identify respective communities. In this community, a relation between two or more resources can be defined by three types of links as described below. Those are, specifically, “a link in accordance with a resource classification” that will be realized by the resource association table 46, “a tag link possessed by a resource” that will be realized by the resource-tag association table 43 and “a link by user behavior (history)” that will be realized by the user history table 44.

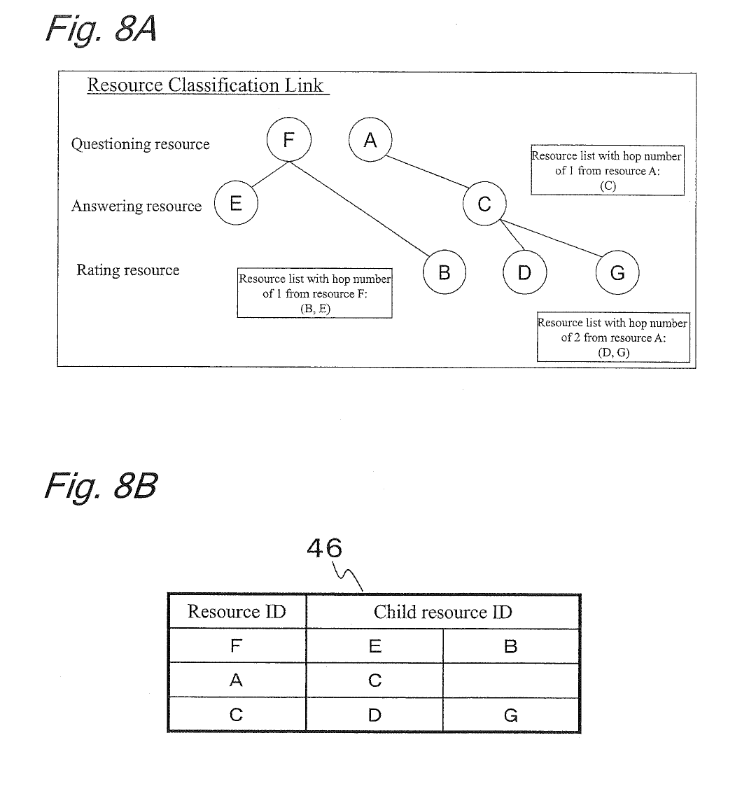

These three types of links will be described below with reference to FIG. 8A to FIG. 10B.

FIGS. 8A and 8B illustrate a concept of “a link in accordance with a resource classification(s)” (hereinafter referred to as “a resource classification link”) and a specific condition of storage into the resource association table (46). In FIG. 8A, there are a number of resources; resource (ID) A to resource (ID) G, present in the community, and each of the resources is registered on the resource table 42 as one of “a questioning resource,” “an answering resource,” or “a rating resource” in accordance with its resource classification. In this example, the resources A and F are “the questioning resources,” the resources C and E are “the answering resources,” and the resources B, D, and G are “the rating resources.” Further, the resource F is linked with the resources E and B. In addition, the resource A is linked with the resource C, which is also linked with the resources D and G. In this way, in the community, an answering resource or a rating resource with respect to a questioning resource are linked directly or indirectly from the questioning resource and this link relation is to be defined as “a resource classification link.” In the example of FIG. 8A, there are two resource classification links existing in the relations among resources A to G: one resource classification link that is directly linked from the resource F and another resource classification link that is directly or indirectly linked from the resource A. Then, a resource list corresponding to this can be defined in accordance with a resource taken as a reference and a hop number indicative of a distance from the reference resource, such that the resource list with the hop number of 1 for the resource F is defined by (B, E), the resource list with the hop number of 1 for the resource A is defined by (C) and the resource list with the hop number of 2 for the resource A is defined by (D, G). It is to be noted that the resource list is intended to refer to a list composed of one or more resource ID(s) and these resource lists are separately stored and kept in said temporary memory. Further, the term “linked” means that one ID is associated with other ID(s) in accordance with a table (such as the resource association table) that designates the association. This resource classification link can define two resources in accordance with the correspondence between the resource ID of a resource and the resource ID of its child resource in the resource association table 46. It is also possible to systematize a group of resources contained in a single such resource classification link as “a resource group.”

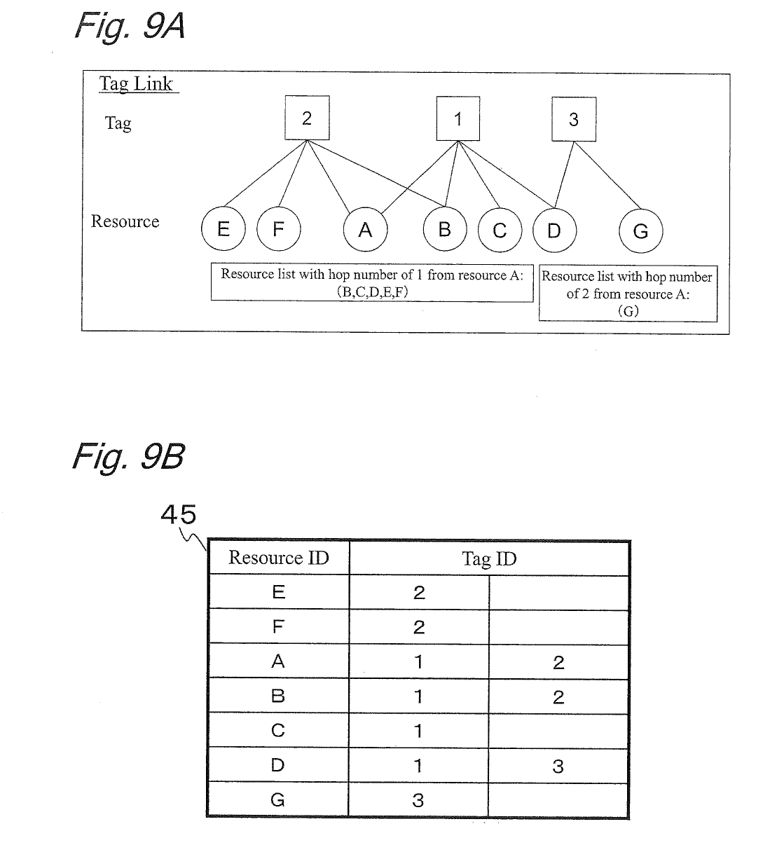

FIGS. 9A and 9B illustrate a concept of “a link in accordance with a tag(s) possessed by a resource” (hereinafter referred to as “a tag link”) and a specific condition of storage in the resource-tag association table (45). In FIG. 9A, there are resources A to G and also tags 1 to 3 present in the community. The tags 1 to 3 are stored in the tag table 43 and in the present embodiment they have been posted manually by the users during the registration of resources in connection with FIGS. 5 to 7 as described above. As such, the resources A, B, C, and D are linked with one another via a tag 1, the resources E, F, A, and B are linked with one another via a tag 2, and the resources D and G are linked with each other via a tag 3. As such, the resources E and G are linked via the tags 2, 1, and 3 with three hops as “the resources E [symbol] B [symbol] D [symbol] E.” In this way, in the community, a direct and/or an indirect relation between a plurality of resources via a tag is to be defined as “a tag link.” In addition, a resource list corresponding to this can be defined in accordance with a resource taken as a reference and a hop number indicative of the number of intervening tags, such that, for example, the resource list with the hop number of 1 for the resource A is defined by (B, C, D, E, F) and the resource list with the hop number of 2 for the resource A is defined by (G). If there is a plurality of possible tag links from one of the resources to the other of the resources, then the link with the smallest hop number can be taken as the tag link for them. This tag link can define the link between two resources in accordance with the correspondence between the resource ID and the tag ID by using the resource-tag association table 45. It is to be noted that although the tag link is defined for the relation between the tag and the resource, in another embodiment, such tag link can be also defined in the relation between the tag and the resource group.

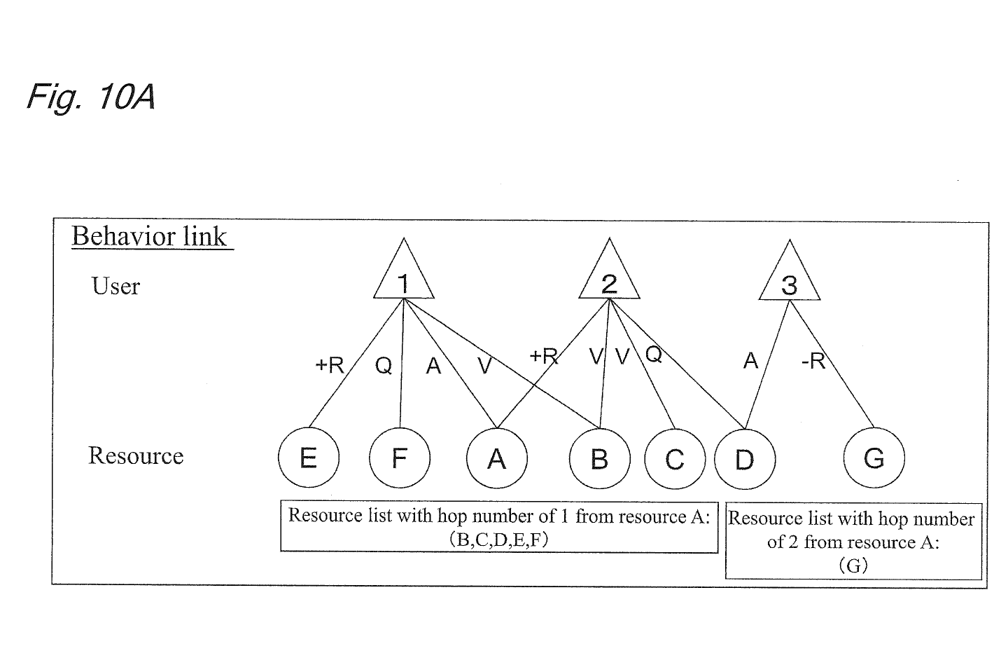

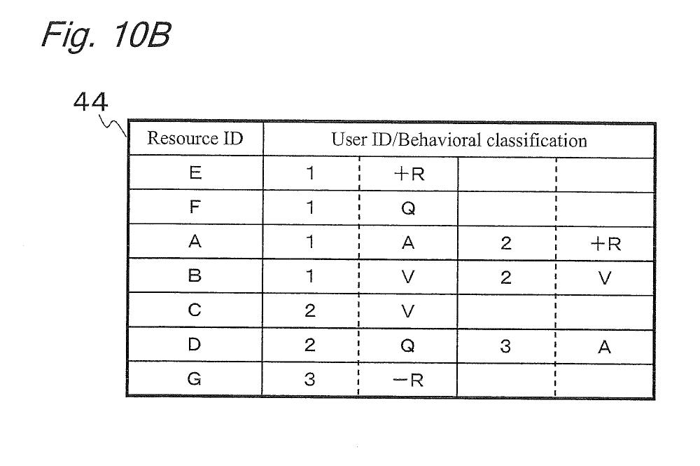

FIGS. 10A and 10B illustrate a concept of “a link in accordance with user behavior(s) (history)” (hereinafter referred to as “a behavior link”) and a specific condition of storage in the user history table (44). In FIG. 10A, there are resources A to G and also users 1 to 3 present in the community. The information of the users 1 to 3 are stored in the user table 41 and each of them can “post” a questioning resource, an answering resource, and a rating resource and also “view” the resource information already stored in the resource table. In addition, when the user posts the rating resource, he or she can post it in conjunction with two or more rating classifications, such as “a positive rating” and “a negative rating.” In FIG. 10B, as used for the classification representing the behavior of the user, a symbol “Q” denotes “posting of a questioning resource” and similarly a symbol “A” denotes “posting of an answering resource, a symbol “+R” denotes “posting of a positive rating” and a symbol “−R” denotes “posting of a negative rating.” As such, the resources E, F, A, and B in conjunction with their respective behavioral classifications are linked with one another via the user 1, and similarly the resources A, B, C, and D and the resources D and G, all in conjunction with their respective behavioral classifications, are linked with one another via the user 2 and the user 3, respectively. In this way, in the community, a direct and/or indirect relation between any two resources is to be defined as “a behavior link” by using a user and a behavioral classification therewith. In addition, a resource list corresponding to this can be defined in accordance with a resource taken as a reference and a hop number indicative of the number of intervening users, such that, for example, the resource list with the hop number of 1 for the resource A is defined by (B, C, D, E, F) and the resource list with the hop number of 2 for the resource A is defined by (G). If there is a plurality of possible tag links from one of the resources to the other of the resources, then the link with the smallest hop number can be the tag link for them. This behavior link can define the link between two resources in accordance with the correspondence between the resource ID and the user ID by using the user history table 44. It is to be noted that the behavioral classifications for the user in FIGS. 10A and 10B have been presented by way of example only, and that the behavior link can be defined to include behavioral classifications other than the above, such as “buying,” “registration on bookmark,” and “requesting for resource deletion,” which could be defined freely.

As described above, in the point(s) valuation and allotment system of the present embodiment, the relation between a plurality of resources to be posted by one or more users can be defined by using the three types of links: the resource classification link, the tag link, and the behavior link. This enables, with respect to the resources present in the community, specifically with respect to each discrete resource accumulated in the database 152 of the point(s) valuation and allotment server, an objective valuation on the resource in question to be made relative to the community from multiple viewpoints, and combining such valuations could make it possible to provide a distinctive mechanism of resource point calculation.

### Example 2

In a second mode of embodiment of a point(s) valuation and allotment system of the present invention, a pricing process can occur at any time with respect to one or more resource(s) present in the community as described above in the first mode of embodiment, specifically each discrete resource accumulated in the database 152 of the point(s) valuation and allotment server, in which the process determines an objective median value relative to the entire community and calculates it as resource points. This makes it possible to provide not such a manually performed valuation on the resources as provided conventionally based on the users' own perspectives but an objective valuation relative to the entire community and thus a value evaluation common in those pieces of information to be accumulated in the social database.

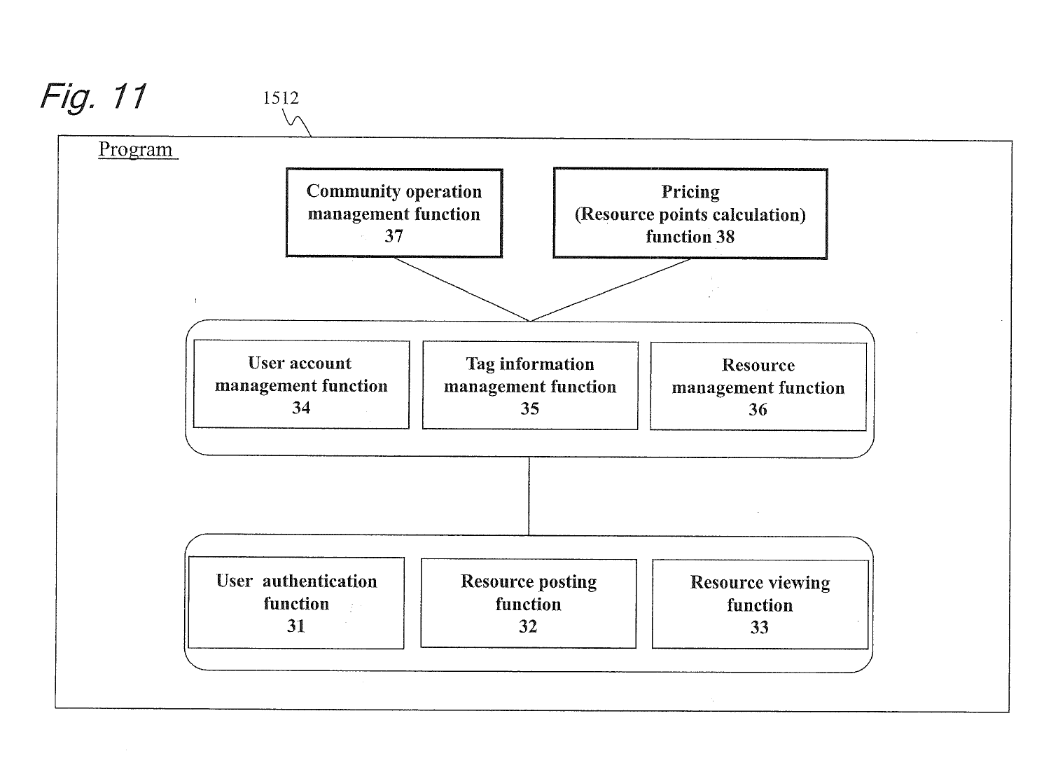

As seen in a list of preferred functions (1512) in the present embodiment shown in FIG. 11, modules for realizing a community operation management function 37 and a resource point(s) calculation function 38 are further provided in addition to the functions 31 to 36 as comprised in the program 1511 of the point(s) valuation and allotment system of FIG. 3 in the first mode of embodiment as described above. The community operation management function 37 can provide a function to enable an operation manager of the community to make a variety of settings required for executing the pricing process, including a setting of a pricing process timing and a setting of an intra-community interest rate. The resource point(s) calculation function 38 performs pricing operation on respective resources stored in the resource table 42 at any time, such as, for example, at a fixed interval/time or otherwise at a predetermined time or at each time when a particular event occurs, and outputs a result from that as resource points, which will be stored in the resource points of the resource table 42. It is to be noted that the above descriptions related to the program are intended to be only illustrative but not limiting to them.

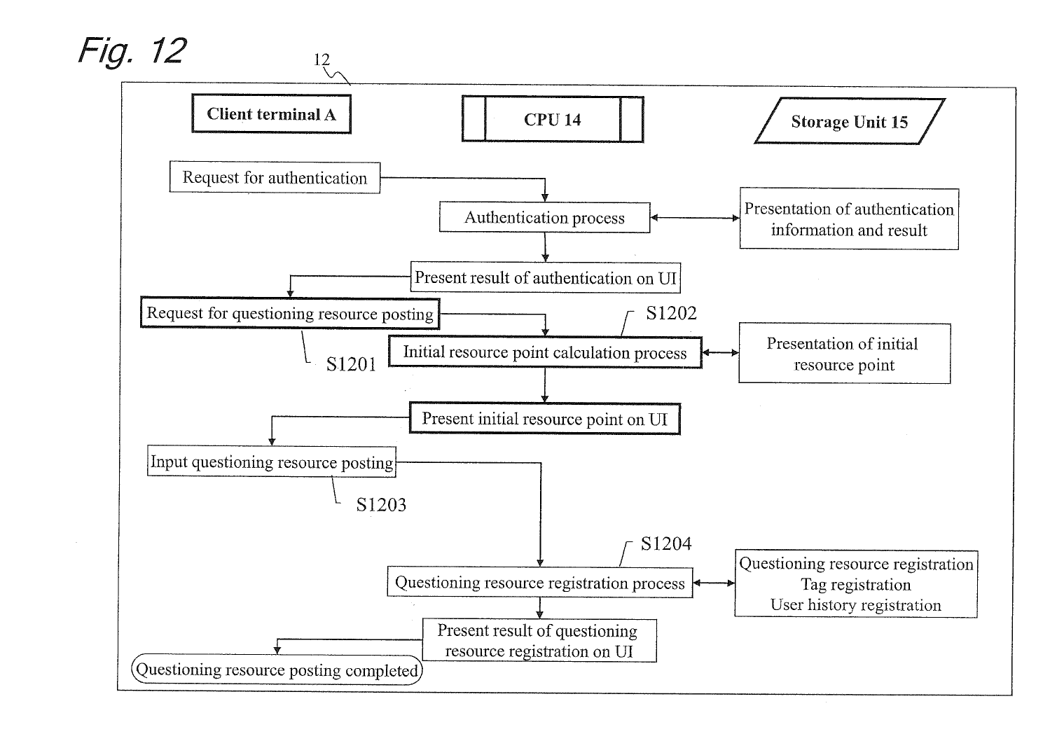

FIG. 12 shows an exemplary flow (12) involving a questioning resource registration by a client terminal A onto the point(s) valuation and allotment server 13, which incorporates therein an execution of said pricing process. This flow is different from the questioning resource registration flow of FIG. 5 in the first embodiment as described above in that before the input of a questioning resource posting (S1203) by the client terminal A, at S1202, the point(s) valuation and allotment server 13 performs an initial resource point calculation process simultaneously upon receipt of the request for the input of the questioning resource posting (S1201) by the client terminal A. Specifically, in response to the questioning resource posting request (S1201), the processing unit 14, at S1202, stores it in the resource table 42 as with, for example, “status=temporary registration” and “classification=questioning” with the aid of the resource management function 36, while performing the pricing of respective resources including the questioning resource with the aid of the resource point(s) calculation function 38 so as to present the result from the pricing with respect to the questioning resource from among those resources as the initial resource point to the client terminal.

Thus, the present embodiment is characterized in that it can provide such a mode of storing a resource in which each of one or more piece(s) of text or resource(s) that have been newly input via the interface (21) is to be taken, respectively, as the resource for the new resource information and newly stored along with the value of the resource ID and the value of its initial resource point in the new resource information into the resource table (42) (S1202, S1204). It is to be noted that such initial resource point is to be calculated and stored through a process in the resource point(s) calculation function 38, as will be described later.

Although the pricing process of the questioning resource occurs, in this example, at the time of registration of said questioning resource, the embodiment is not limited to this timing but any timing, specifically, such as once a day, daily at twelve midnight or otherwise at the end of an answer reception period with respect to the questioning resource or upon detection of an event, the processing unit 14 can activate the program in the resource point(s) calculation function 38 so as to carry out the pricing process. Further, the resource subject to the pricing process is not limited exclusively to a specific resource but may be all resources, and it may include any resource to be stored in the resource table 42.

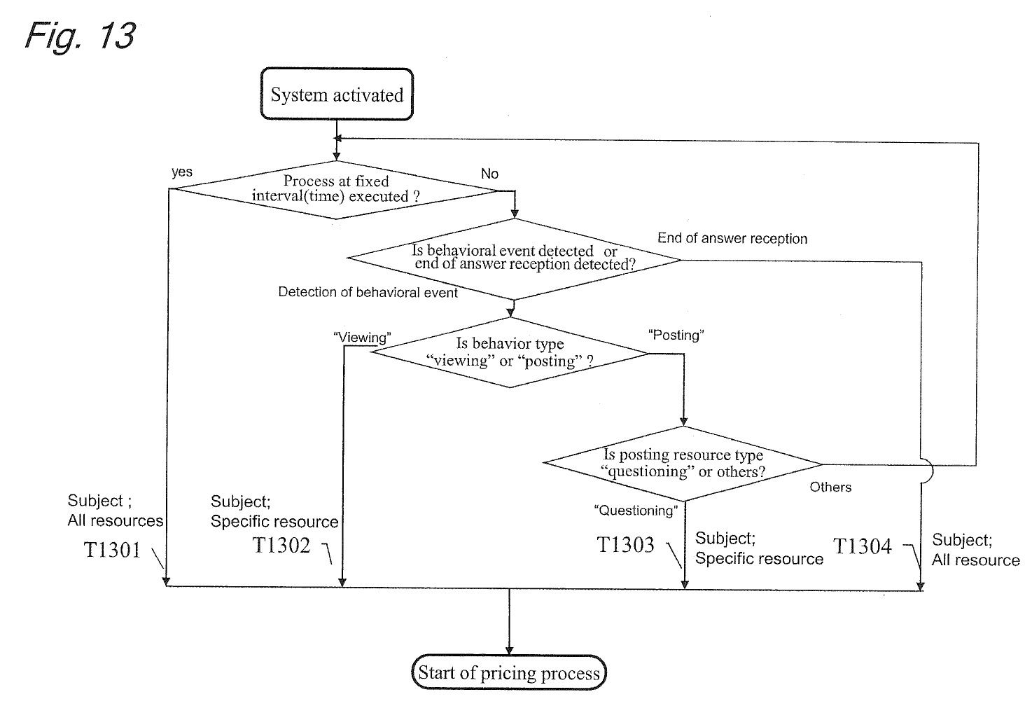

FIG. 13 shows an exemplary flow chart illustrating a timing at which the pricing process is executed in the point(s) valuation and allotment system of the present embodiment. With a timing T1301, the pricing process can be executed with a fixed interval/time, such as once a day or daily at twelve midnight and the pricing process is applied to all resources. With a timing T1302, the pricing process can be executed at a timing when such an event occurs that the system detects a behavioral event by a user, specifically a history is stored in the user history table 44, and further the behavior thereof is “viewing” of a certain resource, and the pricing process is applied to that resource in question. A timing T1303 is the case with the initial resource point calculation in FIG. 12 as described above, and the pricing process can be executed at a time when such an event occurs that the system detects behavior by a user, specifically a history is stored in the user history table 44, and the behavior thereof is “a posting” plus the posted resource is “a questioning resource,” and the pricing process is applied to the resource in question. It is to be noted that in this case, if the event is such that the resource is other than the questioning resource, specifically the resource is either “an answering resource,” or “a rating resource,” then the pricing process would not be carried out. With a timing T1304, the pricing process can be executed with respect to all resources at the end of the answer reception period as set at the time of registration of the questioning resource.

It is to be noted that in order to enable the pricing process to be executed at any desired timing as above, preferably a job scheduler capable of detecting any desired event and activating a specific program 1512 should be implemented with the program 151, or a middleware capable of executing such job scheduling should be operated in coordination with the present system.

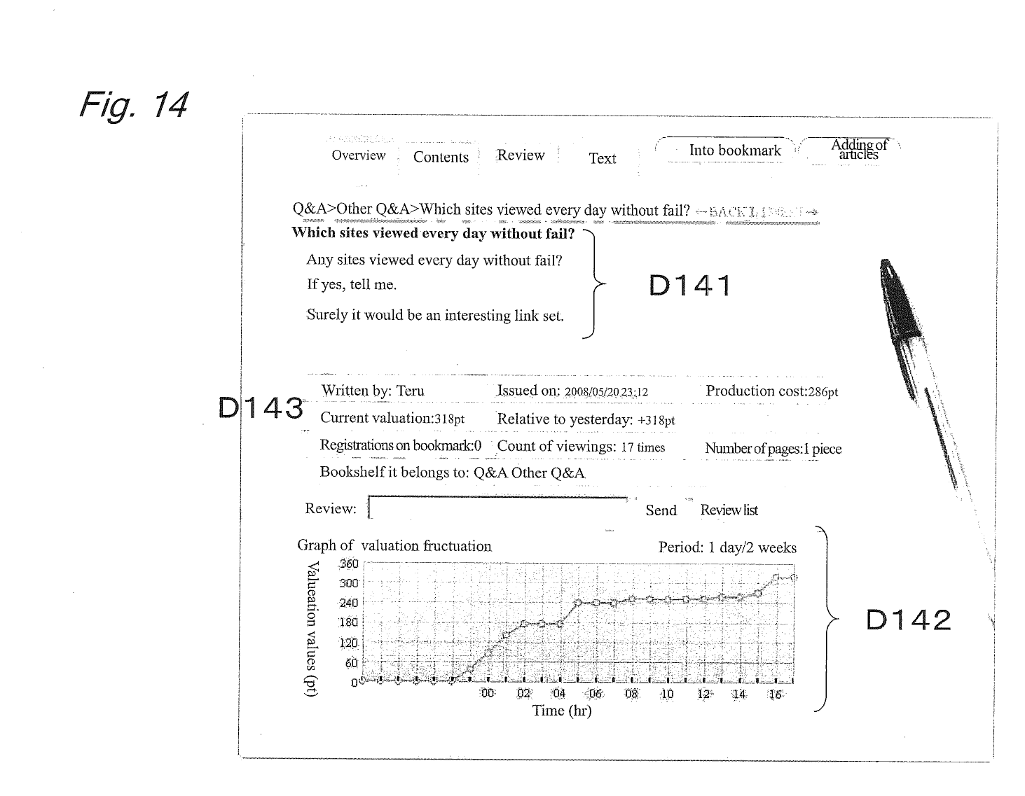

Performing the pricing process at any desired time to calculate the resource points of every resource within the community allows each value of the resource points to be modified dynamically at each execution of the pricing process. As these values of the resource points are saved in the storage unit after every execution, the server can generate a graph indicative of a temporal transition of said resource points. Then such a graph can be presented to the user having the resource. Specifically, the user can always check the transition of the resource points from the initial resource point for the resource posted by that user through the indication presented on the browser screen of the user. This makes it possible for the user to check “how valuable information the resource posted by him or her was” at every posting. Also, such resource points can be considered as a reliable value throughout the community as it represents a relative and objective valuation with respect to the entire community. A screen image to be presented on the browser of the user is shown in FIG. 14. D141 illustrates the questioning resource as registered by the user, whose resource points' daily transition is plotted in D142. In addition, D143 shows the value of the current resource point. Preferably, the graph should be generated with the horizontal axis indicating the time and the vertical axis indicating the resource point, as seen in D142. In the present system, the point(s) valuation and allotment server 13 comprises a means for presenting the information, such as D141-D143, on the browser of the user.

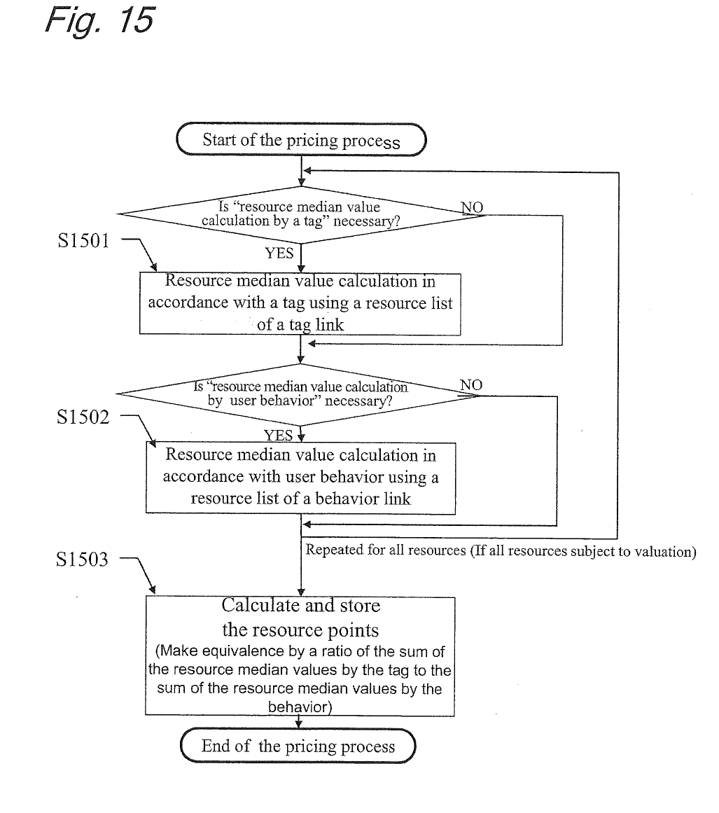

Regarding the pricing of the resource in the present embodiment, the concept thereof will be described below in detail with reference to FIG. 15. Each of a plurality of resources stored in the resource table 42 has a resource ID for identifying the resource and resource point associated with said resource ID, and the present system calculates such resource points with respect to all resources within the community by the pricing process so as to update the items within the resource table 42. Further, one or more piece(s) of resource-tag association information is stored in the resource-tag association table (45) and the resource-tag association information includes one of the resource IDs and a tag ID associated with said one of the resource IDs, the tag ID for identifying a tag retrieved from the resource identified by said resource ID. In the pricing process in the present embodiment, the processing unit 14 of the point(s) valuation and allotment server 13, initially with the aid of the resource point(s) calculation function, can calculate, with respect to each resource, a median value relative to all resources within the community by using the resource classification link, the tag link, and the behavior link as described above. In this regard, to calculate such a median value, “a resource median value calculation in accordance with a tag(s) using a resource list(s) of a tag link(s)” (S1501) and/or “a resource median value calculation in accordance with user behavior(s) using a resource list(s) of a behavior link(s)” (S1502) are applied. Then, by using the above median value and a current ratio, which will be described later, the resource point for each resource can be determined (S1503). As used herein, the term “median value” refers a value representing objective centricity of a certain resource relatively as viewed in relation to an entire group of resources having one or more resource(s), and the median value can be calculated by using the above-described tag link and/or the behavior link plus their respective resource lists. Specifically, the median value will be greater, as said certain resource and many of other resources are directly/indirectly linked with each other and have more relations therebetween, whereas said median value will be smaller as they have lesser direct/indirect relations.

It is to be noted, in connection with “a resource median value calculation in accordance with a tag(s) using a tag link” (S1501) and “a resource median value calculation in accordance with user behavior(s) using a behavior link(s)” (S1502), that the process execution timing for these processes can be employed as desired according to the timings T1301 to T1304 as described above, and for example, in such a case where the value of the resource point is presented to the user in real time in response to the behavioral event from the user as with the timing T1302 and T1303, the operation may be set so that only the process of S1502 is to be executed so as to mitigate the pricing processing. These can be set by the operation manager with the aid of the community operation management function 37.

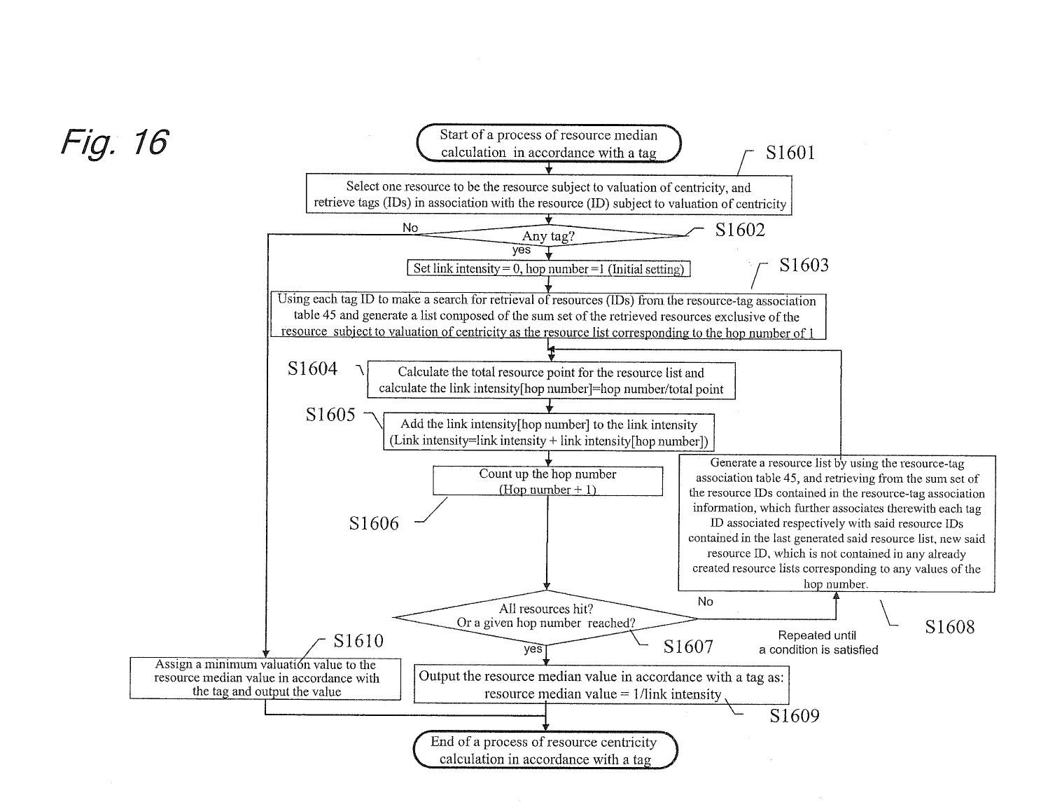

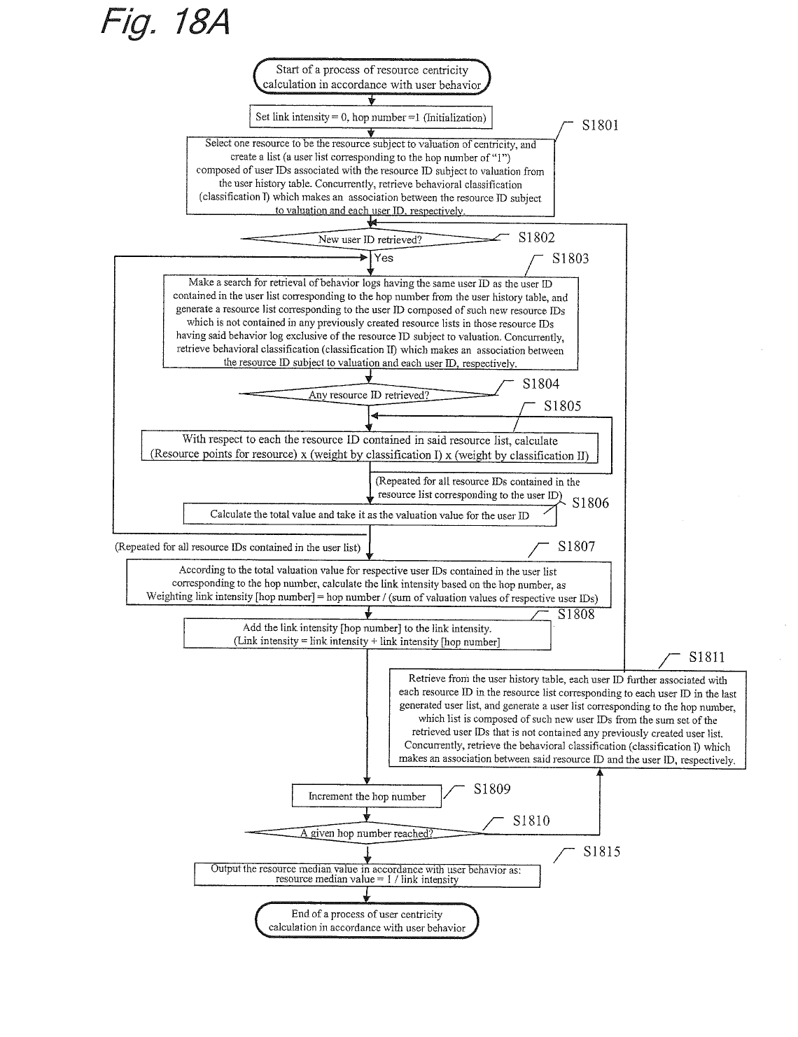

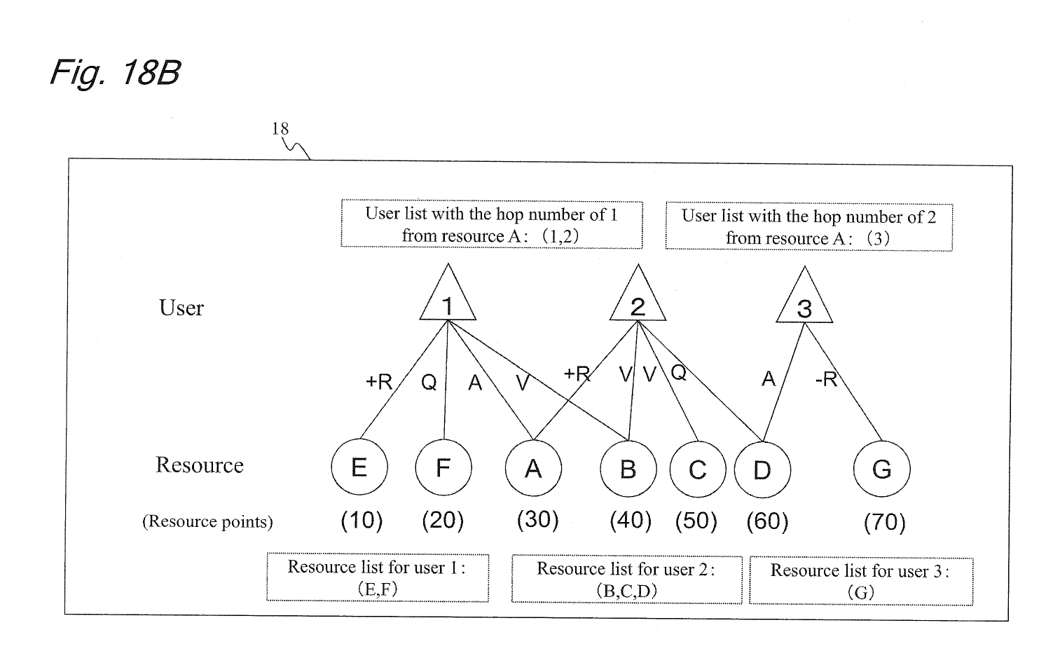

Now, exemplary detailed process flows of S1501 and S1502 are described specifically with reference to FIG. 16 and FIGS. 18A and 18B, respectively.

FIG. 16 represents an exemplary process flow involving “a resource median value calculation in accordance with a tag(s) using a tag link” (S1501) of FIG. 15.

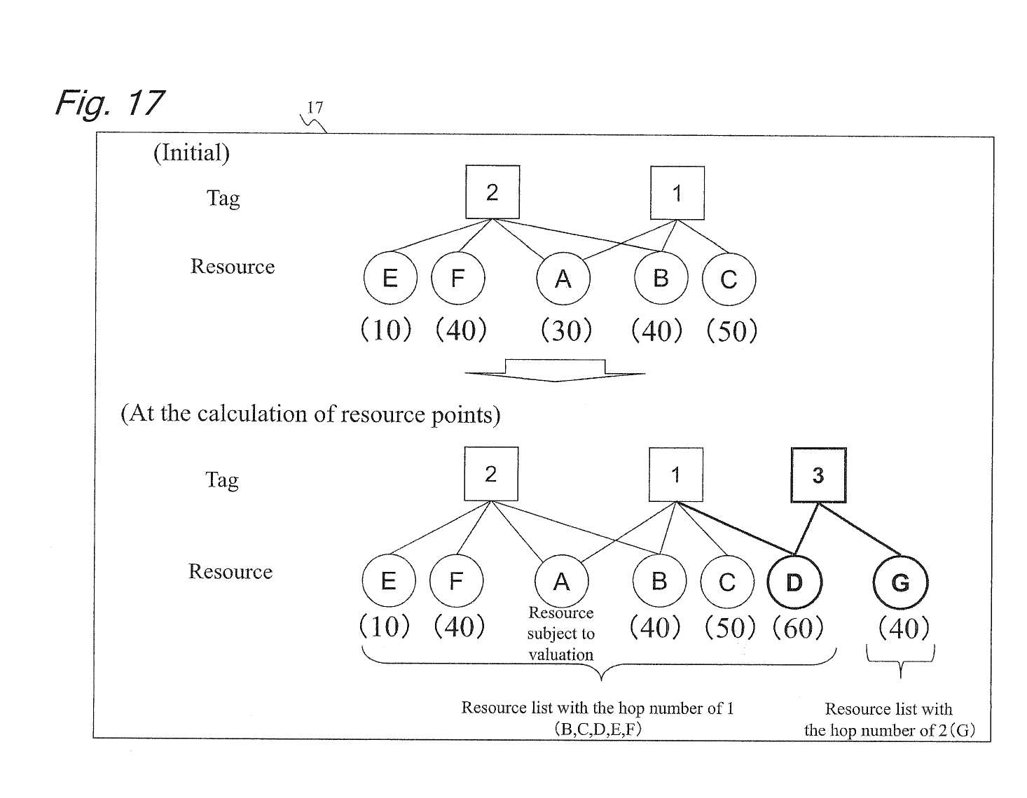

An overview thereof is as follows. Specifically, the process flow is characterized in that the resource point(s) calculation function 38 comprises a module operable to generate a resource list corresponding to the value of the hop number with respect to one resource ID based on one or more piece(s) of resource-tag association information stored in the resource-tag association table (45) repeatedly by sequentially incrementing the value of said hop number from 1 (FIG. 17, S1608), wherein each one of the resource lists to be generated contains one or more said resource ID(s) and based on said resource ID contained in said resource-tag association information, which further associates therewith each said tag ID associated with each said resource ID contained in the last generated resource list. It is to be noted that the term “last” as used above implies a most recently generated resource list in one or more resource list(s), which will be generated in accordance with the number of times of repetition in the repetitive processing, as will be described later. In addition, the resource point(s) calculation function 38 comprises a module operable to calculate a first resource median value for the one resource ID based on the value of said hop number and the values of resource points, each associated by the resource table 42 with each of the resource IDs contained in the resource list corresponding to the value of said hop number (S3401). In addition, the resource point(s) calculation function 38 comprises a module operable to further calculate the resource point for the resource identified by said one resource ID based on the first resource median value (S3404), and the present system is characterized in that with the aid of a means for presenting the calculated point on said interface (D143), the system can present the user said points.

The process will be described below in detail. Initially, by selecting a value of a resource ID in one piece of resource information stored in the resource table (42), a resource subject to a resource median value valuation (hereinafter referred to as a resource subject to valuation) is selected and then a tag(s) possessed by that resource subject to valuation is retrieved along the tag link (S1601). Specifically, the tag ID(s) associated with the resource ID is retrieved by retrieving, from the resource-tag association table 45, the value of the tag ID in the resource-tag correspondence information having the value of said selected resource ID as the resource ID in the resource-tag correspondence information.

If no tag is retrieved (S1602), a given minimum value will be set for the resource median value in accordance with the tag (S1610), and then the resource median value calculation process will be completed. If a tag(s) is retrieved, a search is made along the tag link over the resources associated with this tag, and a sum set of the resources exclusive of the resource subject to valuation is generated as a resource list for the hop number of “1” (S1603). This is realized by the steps of further retrieving the resource ID in the resource-tag correspondence information having the value of the retrieved tag ID as the value of the tag ID in said resource-tag correspondence information; generating a list composed of the values of said resource IDs, which are determined by deleting the value of the selected resource ID from the sum sets of the values of the retrieved resource IDs, as the resource list having the value of the hop number of 1 for the selected resource ID; and storing in said temporary memory (153) the thus generated list. Specifically, the generated resource list having the value of the hop number of 1 can be generated with the aid of the module that is included in the resource point(s) calculation function and operable to generate the resource list, by using each tag ID retrieved from the resource-tag association table (45) to further search over the resource-tag association table 45 and retrieve the resource ID contained in the resource-tag association information that further associates therewith each tag ID associated with the ID of the resource subject to valuation, wherein the list is generated as the one composed of the set of the retrieved resource IDs exclusive of the ID of the resource subject to valuation.

Then, a total resource points for those hit resources are calculated, and link intensity [hop number] corresponding to the hop number can be calculated as “link intensity [hop number]=hop number/total point” (S1604). Then, it is added to the existing link intensity, specifically “link intensity+link intensity [hop number]” is set as a new “link intensity” (S1605). Subsequently, the hop number is incremented (S1606), while using each one of the tags retrieved along the tag link with respect to each resource possessed by the resource list so as to search a resource associated with that tag, and hit resources are retrieved to make a sum set, from which already hit resources are deleted thus to obtain such a resource list that exclusively contains newly hit resources as the resource list corresponding to the hop number of “n (n is any natural number, initial value is 1)” (S1608). It means that this step provides a step of generating the resource list with the value of the hop number, which is an integer of 2 or greater, repeatedly by incrementing the value of the hop number from 2 (S1606) until a given condition (S1607) is satisfied and storing thus generated list in the temporary memory (153) (S1608), which step including: retrieving the value of the tag ID in the resource-tag correspondence information having the value of the resource ID possessed by the last generated resource list as the value of the resource ID in said resource-tag correspondence information; further retrieving the value of the resource ID in the resource-tag correspondence information having the value of said retrieved tag ID as the value of the tag ID in said resource-tag correspondence information; and generating a list composed of the values of said resource IDs that are determined by deleting the value of said resource IDs possessed respectively by all first resource lists stored in said temporary memory from a sum set of the values of said retrieved resource IDs, as said hop number correspondent resource list, which list will be repeatedly generated (S1608). Specifically, the step, using the resource-tag association table 45, retrieves the resource ID contained in the resource-tag association information that further associates therewith each tag ID individually associated with each resource ID contained in the last generated resource list, and retrieves from the set of thus retrieved resource IDs, the newly retrieved resource ID, which is not contained in any already created resource lists corresponding to any values of the hop number, so that a set of thus retrieved resource IDs is generated as a new resource list corresponding to the hop number of “n”.

It is to be noted that the resource lists corresponding to these hop numbers “n (n is any natural number, initial value is 1)” are each separately saved in the temporary memory 153 so that they are made available during such “a resource median value calculation in accordance with a tag(s) using a tag link” being carried out. In addition, the processes S1609 and S1604 to S1607 are repeated using this resource list, until a given condition is satisfied. The given condition as used herein can be such as, “Until all resources within the community stored in the resource table 42 have been hit upon searching and there is no more new resource IDs to be retrieved” or “Has a given value been reached as a result of the increment in the value of the hop number n?” (e.g., “Has n reached 10?”). If such a given condition has been satisfied, the flow exits such repetitive processing, and eventually a resource median value in accordance with a tag(s) is calculated as “resource median value in accordance with tag=1/link intensity”, and then the resource median value calculation process in accordance with said tag will be completed (S1609). It is to be noted that the resource list and link intensity generated in this process can be temporarily stored in the temporary memory provided on said server.

Now, the process of “a resource median value calculation in accordance with a tag(s) using a tag link” as stated above will be described based on an exemplary tag link as shown in FIGS. 9A and 9B. Assuming that the resource points for resources A to G at the time of the processing are as follows, respectively: resource Points for (A)=30, (B)=40, (C)=50, (D)=60, (E)=10, (F)=40 and (G)=70, over which the resource median value calculation process is applied so as to yield “a resource median value in accordance with a tag(s).” It is assumed herein that the resource subject to valuation is “the resource (ID) A.”

(S1601) A tag corresponding to the resource A, “tags 1 and 2,” are retrieved.

(S1603) Using “the tags 1 and 2,” a search is made over the resources so as to generate a resource list for the hop number of 1 or “the resources (B, C, D, E, F).”

(S1604) A calculation is made to determine the link intensity, as link intensity [1]=1/(40+50+60+10+40), or 1/200.

(S1605) Therefore, the link intensity= 1/200 is yielded.

(S1606) The hop number is incremented to 2.

(S1607) The resource G has not yet been hit, then the process continues to S1609.

(S1609) As the tags related to the resource list for the hop number of 1 or “the tags 1, 2, and 3” are retrieved, a resource search is made, and then with respect to a newly retrieved resource G, a resource list having the hop number of 2 or “a resource list (G)” is retrieved.

(S1604)′ A calculation is made so as to determine the link intensity as link intensity [2]= 2/70.

(S1605)′ An intensity= 1/200+ 2/70 is given.

(S1606) The hop number is incremented to 3.

(S1607)′ All the resources have been hit, and then the process continues to S1608.

(S1608)′ A resource median value in accordance with a tag(s)=1/( 1/200+ 2/70)(≈52) is output, and then the process will be completed.

In this way, is it possible to calculate a first resource median value with respect to one piece of resource information based on the hop number as well as the value of the resource point for the resource information having the value of each resource ID possessed by respective resource lists corresponding to the values of said hop number as the value of the resource ID in resource information stored in the resource table (42). Then, based on the thus calculated first resource median value, the first point with respect to the one piece of resource information can be calculated and stored as the value of the resource point in that one piece of resource information into said resource table (S1503).

It is to be noted that the value of the initial resource point for new resource information as described above can be also calculated by selecting the value of the resource ID in said new resource information in the step of selecting a resource ID at the time of the input via the interface taken as said first timing (S1601) and then executing the step of generating and storing the resource lists (S1603 and S1608) and the calculation steps (S1604, S1605, S1609, and S1503).

It is herein assumed, as shown in FIG. 17, that the resources that had been originally stored were the resource A, B, C, E, and F, wherein the resource D (60 Points) and the resource G (40 Points) have been posted by the time of the present resource points calculation and as a result of this, the tag 3 has been newly stored and the resource D and the tags 1 and 3 have been linked and further the resource G and the tag 3 have been linked (17). In such a situation, assuming that the thus calculated resource median value is directly applied to the resource point with respect to the above resource A, then the outcome would be such that the resource A has gained the effect from resources B to G in the present resource points calculation and has its resource points modified to 52 Points, whereas it had originally 30 Points. This means that the resource point for each resource can continue to be modified dynamically according to the condition of the link at the time of the resource points calculation.

FIG. 18A represents an exemplary process flow involving “a resource median value calculation in accordance with user behavior(s) using a behavior link” (S1502) of FIG. 15. The user history table 44, which is primarily used in the present process, stores one or more piece(s) of user behavior correspondence information including one of the resource IDs, a user ID associated with said one of the resource IDs, which identifies a user of 1 and a behavioral classification for identifying a relation between said one of the resource IDs and the user ID. As such, the process flow is characterized in that the resource point(s) calculation function 38 comprises a module operable to calculate a user valuation value with respect to each one of the user IDs associated with the one resource ID, based on one or more piece(s) of user behavior correspondence information stored in the user history table 44 (S1803, S3503, S1806), wherein in said module, with respect to each one of said user IDs, the user valuation value for said user ID is calculated based on: the value of the resource point that is further associated by the resource table 42 with the resource ID in the user behavior correspondence information that associates therewith the user ID; the value indicative of the behavioral classification for identifying a relation between the resource ID in the user behavior correspondence information, which associates therewith said user ID and said user ID; and the value indicative of a behavioral classification for identifying a relation between said one resource ID and said user ID in the user history table (44), and further characterized in that with the aid of the module provided in the resource point(s) calculation function 38, a second resource median value for one resource ID can be calculated based on the user valuation value for each one of said user IDs. Further, detailed description will be given below with reference to FIG. 18A.

Initially, a resource subject to the valuation by a resource median value (hereinafter referred to as a resource subject to valuation) is selected, and a user ID(s) possessed by said resource subject to valuation and a behavior log for said user are retrieved along a behavior link(s). By way of such a behavioral classification retrieval step (S1801), value(s) of one or more user ID(s) in the user behavior(s) correspondence information having the value of the resource ID in one piece of resource information selected as the resource subject to valuation as the resource ID in said user behavior correspondence information stored in the user history table (44), and the value of a (first) behavioral classification corresponding to said user ID is stored in the temporary memory (153). Specifically, a list (user list) composed of the user ID(s) associated by the user history table 44 with the ID of the resource subject to valuation is generated and then each behavioral classification making an association therebetween (hereinafter referred to as “a classification I”) is individually retrieved from the user history table 44 (S1801). The “user list” herein corresponds to a hop number “n (n is any natural number, initial value is 1)” (herein, n=1). If there is no user ID existing (S1802), a minimum value is set as a resource median value in accordance with user behavior(s), and then the resource median value calculation process will be completed (not shown). If the user ID(s) is retrieved, a search is made along the behavior link(s) over the resources associated with this user ID(s), and a sum set of the resources exclusive of the resource subject to valuation is generated as a resource list corresponding to the user ID(s). This step is realized by retrieving a value(s) of one or more resource ID(s) and its corresponding value of a (second) behavioral classification possessed by the user behavior(s) correspondence information having the value of the one user ID as the value of the user ID in said user behavior correspondence information stored in the user history table (44); generating a list, which is created by deleting the value of said selected ID from a sum set of said retrieved one or more resource ID(s), as a (second) resource list with respect to the selected resource ID; and storing the thus generated list in said temporary memory (153) (S1803). Specifically, with respect to one retrieved user ID, the user history information is searched from the user history table 44, and the resource ID included in that history information is retrieved. Then, a set of newly retrieved resource ID(s), which is determined by excluding the resource ID subject to valuation and the resource ID(s) contained in the already created resource list from the retrieved resource ID(s), as the resource list corresponding to said one user ID (S1803). Concurrently, the behavioral classification, which makes an association between said one user ID and each resource ID in the resource list (hereinafter referred to as “a classification II”), is also retrieved (S1803).

If the hop number is 1 and no resource ID is retrieved (S1804), a given minimum value is set for the resource median value in accordance with the user behavior(s) (not shown), and then the resource median value calculation process will be completed. If the hop number is 2 or greater and no resource ID is retrieved (S1804), then here again, a calculation of a resource median value, which will be described later, is made (S1815), and then again the resource median value calculation process will be completed.

Subsequently, with respect to all the resources in the resource list corresponding to said user ID, a calculation is made as “resource point for a resource×a weight by the classification II×a weight by the classification I” (S1805), and the sum of the values for said all resources is determined as a valuation value for said user ID (S1806). Specifically, the valuation value for the one user ID can be calculated based on: the value of the (first) behavioral classification retrieved at the step of retrieving a behavioral classification (S1801) as described above; the value of the resource point in said resource information having the value of each resource ID possessed by said generated (second) resource list as the value of the resource ID in the resource information stored in the resource table (42); and the value of the (second) behavioral classification retrieved with respect to the value of the resource ID in said resource information, and the thus calculated valuation value is stored in the temporary memory (153) (S1805). It is to be noted that “the weight by a classification I (II)” is a value that can be set freely by the operator with respect to the behavioral classification as described above, and may be set such as, for example, “viewing=1, answering=3, questioning=4, positive rating=2, and negative rating=0.5” and the likes. The steps S1803 to S1806 are executed on the user ID basis repeatedly with respect to all of the user IDs in the user list corresponding to the hop number, retrieved and created in S1801 or S1811, which will be described later, so that respective valuation values with respect to all of these user IDs can be calculated and stored in the temporary memory (153) (S1806). Then, from the sum of the valuation values with respect to respective user IDs calculated through said repetitive processing, a weighting link intensity[hop number] corresponding to the hop number (hereinafter referred to as link intensity[hop number]) can be calculated as “weighting link intensity[hop number]=hop number/total valuation value” (S1807). Then, it is added to the already calculated link intensity. Specifically, the “link intensity+link intensity[hop number]” will be set as a new “link intensity” (S1808).

Subsequently, the hop number is incremented (S1809), and then the user ID and its behavior log retrieved along the behavior link with respect to the resources possessed by the resource list are retrieved. Specifically, retrieved from the user history table 44 is a user ID(s) that is further associated with each resource ID contained in each resource list corresponding to each user ID contained in the last generated user list. Then such a set of newly retrieved user IDs determined by excluding the resource IDs contained in any already generated user lists from the retrieved user IDs can be obtained as a new user list corresponding to the hop number “n (n is any natural number, initial value is 1)” (S1811). Concurrently, the behavioral classification (“the classification I”), which associates said each user ID with each resource ID in the resource list, is also retrieved (S1811). In addition, this user list is used and the processes S1811 and S1802 to S1810 are repeated, until a given condition (S1810) is satisfied. The given requirement as used herein can be such as, “Has n met a given hop number?” and in some cases, said given hop number may be set as the hop number=1, so that the repetitive processing can be eliminated.

In the present embodiment, based on each valuation value for one or more user ID(s), which have been retrieved, a second resource median value with respect to said one piece of resource information is calculated (S1512, S1808, and S1815). Specifically, once such a given condition has been satisfied and then flow has exited such repetitive processing, finally the resource median value in accordance with the user behavior(s) can be calculated as “resource median value in accordance with user behavior(s)=1/link intensity,” thereby completing the resource median value calculation process in accordance with user behavior(s) (S1815). It is to be noted that the generated user list and link intensity as well as the retrieved behavior log in this process can be temporarily stored in the temporary memory provided on said server.

Now, the process of “a resource median value calculation in accordance with user behavior(s) using a behavior link” as stated above will be described based on an exemplary behavior link (18) as shown in FIG. 18B. Assuming that the resource points for resources A to G upon processing are as follows, respectively: resource pints for (A)=30, (B)=40, (C)=50, (D)=60, (E)=10, (F)=20 and (G)=70, and also that the weight in accordance with the behavioral classification is as follows: viewing (V)=1, answering (A)=3, questioning (Q)=4, positive rating (+R)=2, and negative rating (−R)=0.5. It is further assumed that “a predetermined hop number=2.” Under these assumed conditions, “a resource median value in accordance with user behavior(s)” is to be calculated by a resource median value calculation process. Herein, the resource subject to valuation is assumed to be “the resource (ID) A.” As can be seen, the user list having the hop number of 1 from the resource A is denoted as “the users (1, 2),” the user list having the hop number of 2 is denoted as “the user (3).” Further, the resource list corresponding to “the user 1” is denoted as “the resources (E, F),” the resource list corresponding to “the user 2” is denoted as “the resources (B, C, D) and the resource list corresponding to “the user 3” is denoted as “the resource (G).”

(S1801) The user list having the hop number of 1, “the users (1, 2),” and the classification I (A, +R) are retrieved.

(S1803) Using the user list having the hop number of 1, “the users (1, 2),” a search is made over the resources so as to generate the resource list corresponding to “the user 1,” “the resources (E, F),” and the resource list corresponding to “the user 2,” and “the resources (B, C, D).” Further, retrievals for the classification II (+R, Q, V, V, Q) are made, respectively.

(S1805 and S1806) A calculation is made to determine the valuation value, as follows:

Valuation value for the user 1=(valuation value for E+valuation value for F)={(10*(+2)*3)+(20*4*3)}=300, and
Valuation value for the user 2=(valuation value for B+valuation value for C+valuation value for D)={(40*1*(+2))+(50*1*(+2))+(60*4*(+2))}=660.

(S1807) The link intensity [1]=1/(300+660) is calculated.

(S1808) Therefore, the link intensity= 1/960 results.

(S1809) The hop number is incremented to 2.

(S1811) Using the user list having the hop number of 1, “the users (1, 2),” a search is made over the resources so as to generate the user list, “the user 3” having the hop number of 2 and the classification I(A).

(S1803)′ Using the user list having the hop number of 2, “the users (3),” a search is made over the resources so as to generate the resource list corresponding to “the user 3,” and “the resource (G).” Further, the classification II (−R) is retrieved.

(S1805 and 1806)′ A calculation is made to determine the valuation value, as follows:

Valuation value for the user 3=(valuation value for G)=(70*0.5*3)=105.

(S1807)′ The link intensity [2]= 2/105 is calculated.

(S1808)′ Therefore, the link intensity= 1/960+ 2/105 is given.

(S1815) A resource median value in accordance with user behavior(s)=1/( 1/960+ 2/105) (approximately =50) results and is output, thus completing the process.

In such a case, assuming that the thus calculated resource median value is directly applied to the resource point with respect to the above resource A, then the outcome would be such that the resource A has gained the effect from the behavior link generation by the present resource point calculation, and has its resource point modified to 50 Points, whereas it had originally 30 Points. Specifically, the resource point for each resource can continue to be modified dynamically according to the condition of the link at the time of the resource point(s) calculation. It is to be noted in such a process of “a resource median value calculation in accordance with user behavior(s) using a behavior link(s)” that in order to mitigate the processing by the server 13, the subject whose resource centricity is to be calculated may be exclusively such a behavior link that has been newly generated during the period between the last calculation and the current calculation, or exclusively a differential behavior link. In this case, the link intensity calculation is made with respect to said differential behavior link for respective resources, and thus the calculated link intensity is added to the last calculated link intensity so as to determine the link intensity for each resource.

The description is now directed to a process of S1503 in FIG. 15 involving a calculation and updating of the resource point(s) by means of “a resource median value calculation in accordance with a tag(s) using a tag link(s)” and/or “a resource median value calculation in accordance with user behavior(s) using a behavior link(s)” as described above.

The present embodiment comprises a step (S1503), in which, at the above-described first timing and based on the calculated first resource median value and/or the calculated second resource median value with respect to the one piece of resource information, point for the one piece of information can be calculated and stored as the value of the resource point in said one piece of resource information in the resource table (42).

If the input is either one of “a resource median value calculation in accordance with a tag(s) using a tag link(s)” or “a resource median value calculation in accordance with user behavior(s) using a behavior link(s),” then said process can be such that the processing unit 14 of the point(s) valuation and allotment server 13, with the aid of the resource point(s) calculation function, can take the calculated resource median value directly as the resource point for the resource and it can update the value of the resource point in the resource table 42 with respect to each one of all the resources. If the input includes both “a resource median value calculation in accordance with a tag(s) using a tag link(s)” and “a resource median value calculation in accordance with user behavior(s) using a behavior link(s),” then these two resource median values are equilibrated by applying a ratio (current ratio) so that a total value by “a resource median value calculation in accordance with a tag(s) using a tag link(s)” will be equal to a total value by “a resource median value calculation in accordance with user behavior(s) using a behavior link(s)” for all the resources, and then an average over the resource median values after the equilibration can be taken as the resource point for the resource. Then, the value of the resource point in the resource table 42 can be updated with respect to each one of all the resources.

Specifically, the process is carried out at the first timing as described above by: with respect to each one of the values of the resource IDs in all pieces of resource information stored in the resource table (42), making a selection for retrieval as the resource ID in one piece of information at the step of selecting a resource ID (S1601); subsequently, calculating the values of the first resource median values for all the pieces of resource information and the values of second resource median values for all the pieces of resource information, respectively, through the series of steps including the resource list generation and storage steps (S1603 and S1608) and the calculation steps (S1604, S1605, S1609, and S1503) as described above; based on the ratio of the sum of the first resource median values to the sum of the second resource median values, calculating third points for all said pieces of information, respectively, and storing the thus calculated third points into the temporary memory (153), wherein the thus respectively calculated third points can be stored, respectively, as the values of the resource points in all the pieces of resource information in the resource table (42) (S1503).

In the foregoing description, an exemplary specific process involving the pricing of the resource has been explained. It is to be noted that in the present embodiment, the two methods: “a resource median value calculation in accordance with a tag(s) using a tag link(s)” and “a resource median value calculation in accordance with user behavior(s) using a behavior link(s)” are contemplated as the resource median value indicative of the centricity of the resource, but the point(s) valuation and allotment system of the present invention is not limited to them.

### Example 3

In a third mode of embodiment in a point(s) valuation and allotment system of the present invention, a pricing process in the second mode of embodiment as described above and a process of automatically retrieving a tag from a group of resources stored in the resource table 42 can be combined. More specifically, by using one or more keywords retrieved from the group of resources stored in the resource table and through the cooperation with a dictionary system (database) 19, the system can automatically retrieve the tag corresponding to the resource at any desired timing and can update the tag table 43 and the resource-tag association table 45. This automatic tag retrieval allows dynamic updating of said tag link in light of automatic accumulation in said tag table 43 as well as automatic updating of the resource point for the resource, thereby making the resource point for each resource within a community a much more objective one.

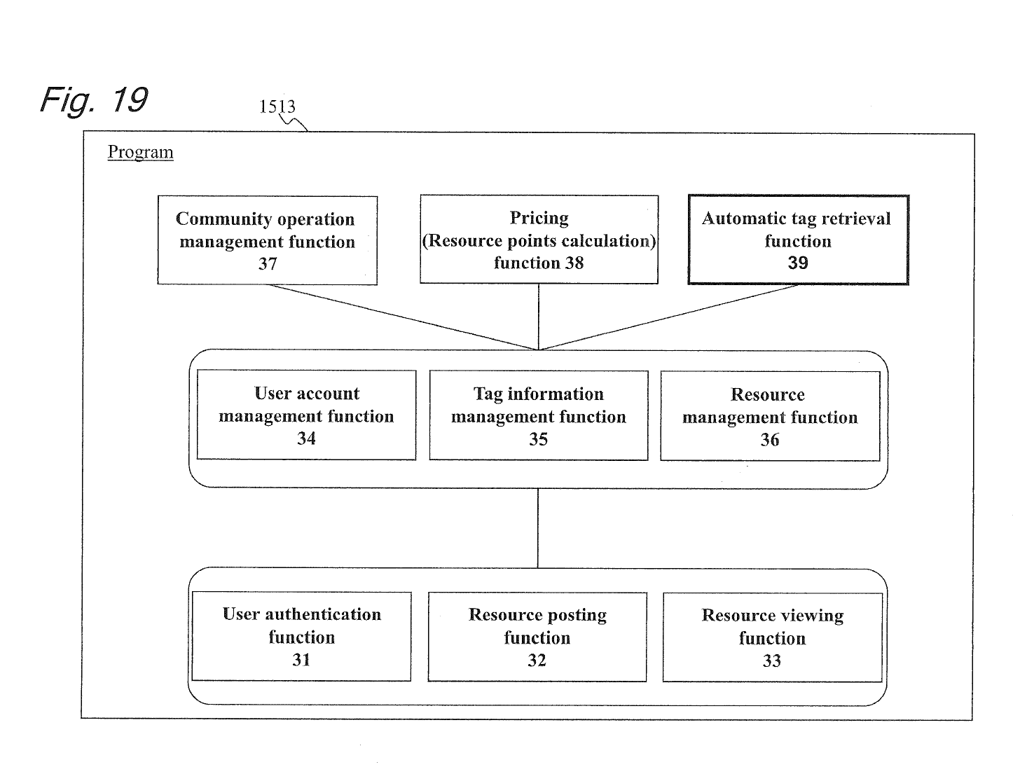

As seen in a list of preferred functions (1513) in the present embodiment shown in FIG. 19, a module for realizing an automatic tag retrieval function 39 is further provided in addition to the functions 31 to 36 as provided in the program 1512 of the point(s) valuation and allotment system of FIG. 11 in the second mode of embodiment as described above. As described above, the automatic tag retrieval function 39 provides a function for retrieving a tag from a resource subject to retrieval and further making a correspondence between the resource and the tag. It is to be noted that the above descriptions related to the program are intended to be merely illustrative but not limiting to them.

In the present embodiment, the system further comprises: a step involving a tag retrieval and storage (S2004), in which such a new second text that is to be retrieved respectively from one or more piece(s) of the first text or resource(s) that have been newly stored by the step of storing a resource (S1204) as described above and that has not yet been stored as the tag in the tag information stored in the tag table (43) is to be newly stored as the tag in the new tag information along with the value of the tag ID in the new tag information in the tag table (43); and a step of storing new resource-tag correspondence information including the value of the resource ID in the newly stored resource information and the value of the tag ID in said new tag information into the resource-tag association table (45).

Such second text to be retrieved from said first text in the present embodiment is characterized in that it is retrieved through the steps of: retrieving a group of first keywords including one or more first keyword(s) from said first text (S2002 and S2101); using each first keyword in the group of first keywords to make a search over a text set comprising a plurality of pairs of words and the description to be stored in a second database (19), which is to be stored in a storage unit of a second server configured on the network in coordination with the database (152) of the server (13) with the aid of an application interface, for said word corresponding to each first keyword so as to obtain the description for the word matched with said first keyword (S2002, S2102); further retrieving a group of second keywords including one or more second keyword(s) from the thus obtained description (S2002, S2103); using each second keyword included in said group of second keywords to make a search over the resources in the resource information in the resource table (42) and deleting those second keywords that have been stored in excess of a given number as the resources from said group of second keywords so as to retrieve said second text (S2003, S2104-S2107).

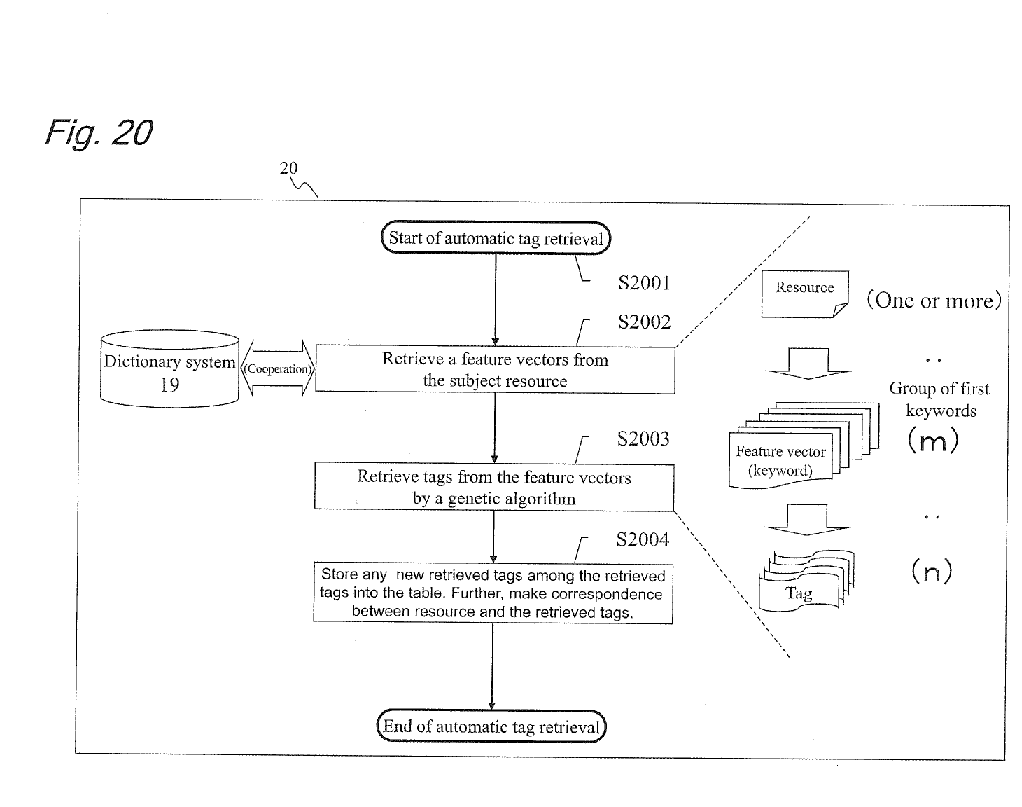

An overview (20) of a process involving an automatic tag retrieval of a point(s) valuation and allotment system in the present embodiment will be described below with reference to FIG. 20.

The processing unit 14 of the point(s) valuation and allotment server 13 can activate the program in the automatic tag retrieval function 39 to start an automatic tag retrieval process (S2001), at any desired time such as, at the time of the registration of a resource, once a day, daily at twelve midnight, or otherwise at the end of an answer reception period with respect to a questioning resource or upon detection of an event. Then, at S2002, the processing unit 14 retrieves the keyword from one or more resource(s) subject to the tag retrieval, and through cooperation with the dictionary system 19, it generates feature vectors having, as their elements, m keywords from said keywords that can satisfy a given requirement and TF/IDF values. Then, at S2003, n tags are retrieved from said m feature vectors by using a genetic algorithm Finally, at S2004, exclusively new tags are stored in the tag table 43 (tags that have been already registered are not to be stored), and correspondence can be made between the resource subject to retrieval and all of the thus retrieved tags for storage in the resource tag table 45. It is to be noted that the dictionary system 19 employed herein refers to a system that comprises keywords and their descriptions in the content and has such an input/output interface function that in response to an input of a keyword, outputs a description for said keyword, and in a point(s) valuation and allotment system in the present invention, it may be provided inside the system or the system can be configured to interact with publicly known dictionary sites on the network by means of an API. It is also appreciated that any publicly known valuation method and algorithm may be applied for the above TF/IDF value and genetic algorithm.

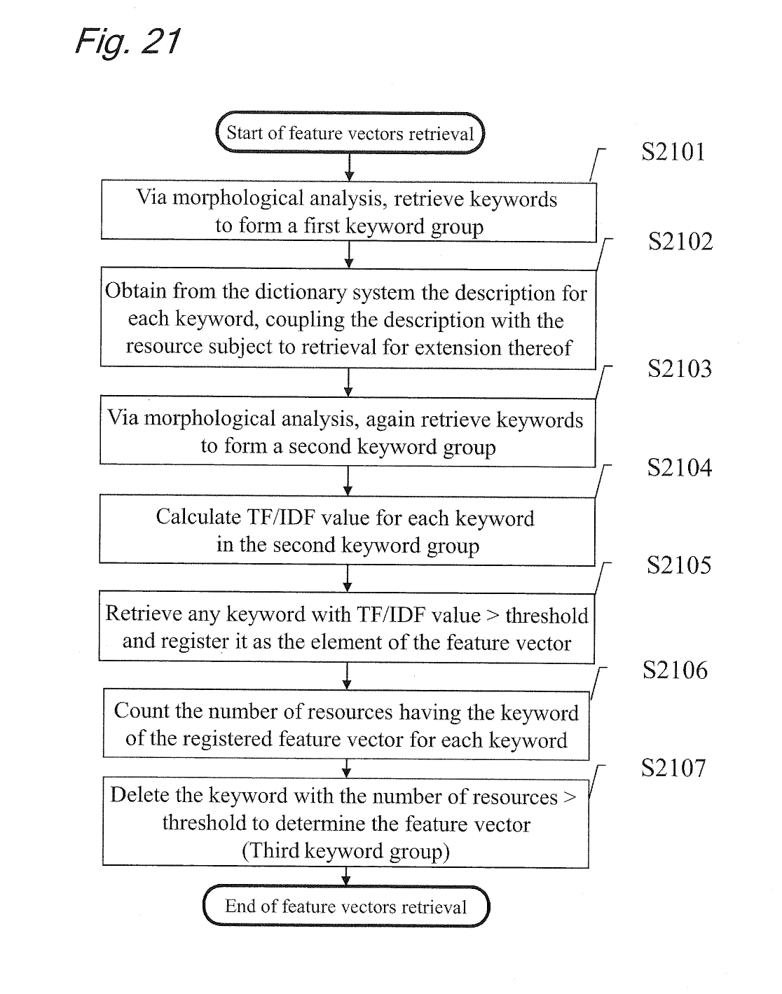

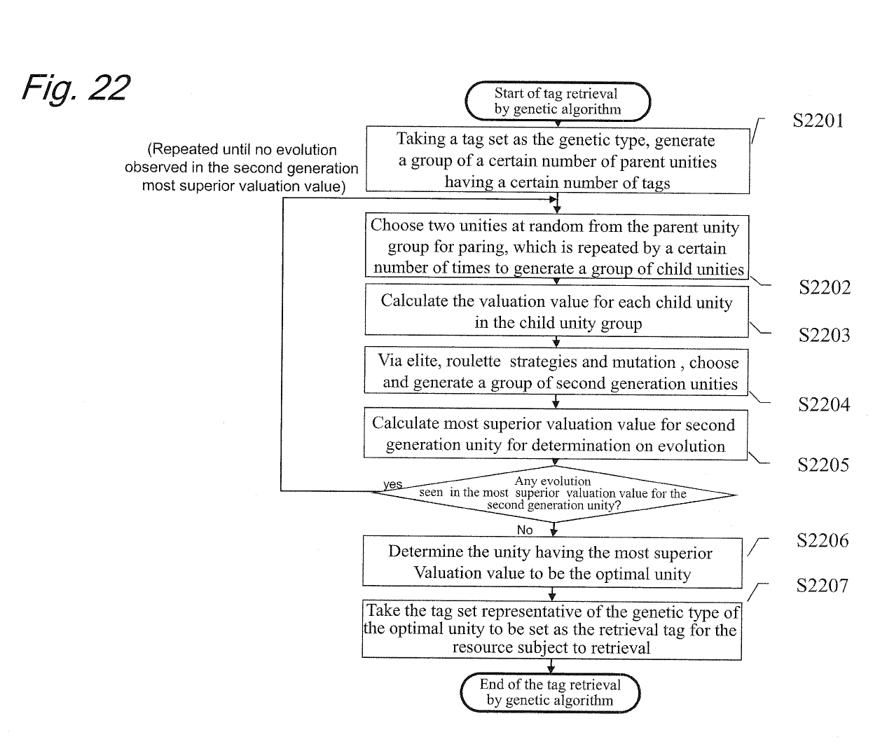

Specific configurations for the S2002 and S2003 as described above will be described with reference to FIGS. 21 and 22, respectively.

FIG. 21 represents an exemplary process flow involving the above-mentioned feature vectors retrieval (S2002 of FIG. 20) in the present embodiment. Upon receipt of an instruction to start the feature vectors retrieval, the processing unit 14 of the point(s) valuation and allotment server 13 initially retrieves keywords according to a publicly known technique of morphological analysis, which retrieved keywords establish a group of first keywords (S2101). Subsequently, through the cooperation with the dictionary system 19 as described above, the description with respect to said keyword is obtained, and the resource subject to retrieval is coupled with the thus obtained description so as to extend the resource subject to retrieval (S2102). Then, using again the technique of morphological analysis, the processing unit 14 again retrieves keywords, which establish a group of second keywords (S2103), while calculating the TF/IDF value for each keyword in said group of second keywords (S2104). The TF/IDF value can be herein calculated in accordance with a publicly known formula:

$${w}_{i , j} = {tf}_{i , j} \times log ( \frac{N}{{df}_{i}} ) \qquad [ Formula 1 ]$$

Where, in the present embodiment, the tf_{i,j} denotes the frequency of appearance of the keyword, i, in the resource, j; the dfᵢ denotes the number of resources subject to retrieval, which contains the i; and the N denotes the total number of resources subject to retrieval.

Subsequently, the keyword having the TF/IDF value for each keyword that is greater than a given threshold value is retrieved and then the thus retrieved keyword together with its frequency of appearance is registered as the element of the feature vector (S2105). Then, the number of resources having respective keywords in the registered feature vectors is counted (S2106), and keywords having the value of said number of resources greater than a given value are deleted from said feature vectors so as to determine the feature vectors (S2107). Thus, the feature vector retrieval process can be completed.

It is to be noted in connection with the process of deleting certain keywords from the feature vectors, which is carried out in S2107, that those keywords to be deleted in this process are at risk of making the above-described tag link complicated and may potentially bring adverse effects to the calculation of a resource median value in accordance with a tag(s) and thus the resource point calculation based on the resource median value calculation, as they are comprised commonly in many resources. Accordingly, those keywords should be deleted through said processing. On the other hand, employing those keywords may allow for an explicit automatic grouping of the resources present within the community. Specifically, this may provide another effect of enabling the automatic grouping of the resources, given that in addition to respective tables as described in connection with the first mode of embodiment of FIG. 4, the database 152 newly comprises a table that includes in its items, for example, an ID for uniquely identifying a group, a keyword, and a resource ID having a keyword and can define the correspondence between said retrieved keyword and the resource having the keyword, wherein those keywords in question may be stored in such a table at the time of their deletion from the feature vectors and may be made correspondent with the resources, thereby to provide the automatic grouping of the resource.

FIG. 22 represents an exemplary process flow involving the above-mentioned tag retrieval by means of the genetic algorithm (S2003 of FIG. 20) in the present embodiment. Once the feature vector retrieval has been completed, the processing unit 14 of the point(s) valuation and allotment server 13 can subsequently use the genetic algorithm to carry out a process of determining a group of tags to be retrieved from a group of tag candidates subject to the resource retrieval, which group of tag candidates is composed of a group of the keywords registered on the feature vectors.

Initially, a given times of random generation of a unity having a given number of tag candidates can produce a group of parent unities (a group of first generation unities) with a tag set as the genetic type (S2201). Subsequently, any two unities can be chosen from the group of parent unities to make a pair, which pairing will be repeated by a given number of times so as to generate a group of child unities (S2202). Once the group of child unities has been generated, a unity valuation value for each unity is calculated (S2203). In this connection, the number of resources that include one or more tag candidate(s) in the given number of tag candidates possessed by the unity can be taken for the valuation of the unity. Subsequently, by means of publicly known elite, roulette and mutation strategies in the genetic algorithm, those unities suitable for a next generation are selected so as to generate a group of next generation unities (S2204). A unity valuation value for each next generation unity is calculated and a most superior valuation value in the group of next generation unities is retrieved (S2206). If this most superior valuation value is greater than that in the former generation, or in other words, if evolution can be noticed, then the process goes back to S2202 to perform the paring process again. If this most superior valuation value is not greater than that in the former generation, meaning that the evolution has been terminated, a unity having the most superior valuation value can be considered an optimal unity (S2206), and the tag candidate with the genetic type of the optimal unity can be determined to be set as the tag for the resource subject to retrieval (S2207).

In the foregoing description, the automatic tag retrieval from the resource subject to retrieval has been explained.

### Example 4

In a fourth mode of embodiment of a point(s) valuation and allotment system of the present invention, it is possible to distribute points to be allotted (hereinafter referred to as “reward distribution”), which may be calculated by a given method to an account of a user having, with respect to one questioning resource, one or more other resource(s) contained in the resource classification link or the tag link as described above.

The present embodiment is characterized in that the processing unit (14) further provided on the server (13), which comprises the temporary memory (153), can calculate and store a value of resource point in one piece of resource information based on values of the resource points in other pieces of resource information so as to increase or decrease the account points.

As described also in the first mode of embodiment, the user table (41) stores two or more pieces of user account information including a user ID for uniquely identifying a user and account point associated with said user ID, while the resource table (42), upon storing two or more pieces of resource information, may further contain one posting user ID, respectively, which is associated with the resource ID in the resource information and the value of which represents the value of the user ID of the user who has input the text as the resource in the resource information. Further, the behavioral classification in two or more pieces of user behavior correspondence information stored in the user history table (44) includes those representing questioning, answering, negative rating, positive rating, and viewing, whose corresponding values are taken as the values of behavioral classifications. As such, when storing said resource (in S1201, S1204, S2501), the processing unit additionally stores the value of the user ID for the user who has input the (first) text via the interface (21) as the value of the posting user ID in the new resource information, while concurrently storing the user behavior correspondence information including the value of the resource ID for the new resource, the value of the posting user ID in the new resource information and the value corresponding to either one of the classifications other than the viewing, which has been selected by said user, in the user table (44). The process is further configured to occur at the time when any of the values of the resource ID of the resources possessed by all pieces of resource information stored in the resource table (42) is specified by any user via the interface (21) so as to store the user behavior correspondence information including the value of the specified resource ID, the value of the user ID identifying the user who has invoked the specification and a value corresponding to the classification representing the viewing in the user history table (44). Based on the information in each table, which will be stored as described above, the reward distribution by means of a point(s) valuation and allotment system according to the present invention can be carried out.

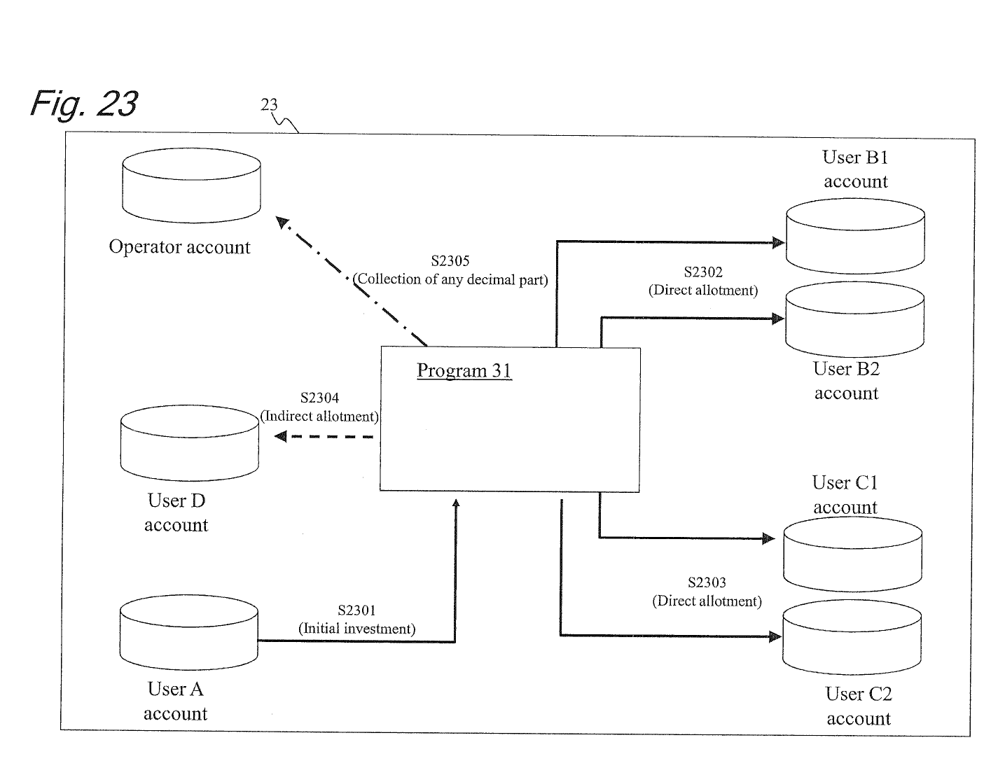

A general overview of reward allotment (23) by means of a point(s) valuation and allotment system in the fourth embodiment according to the present invention will be described with reference to FIG. 23. It is to be noted that in the present embodiment, although the points in the present system as described above, specifically, the account points, the resource points and the tag points, respectively, as described above could potentially take numerical values including values at decimal places as a consequence from the calculations; these values in the present invention, are supposed to have been rounded up to integer values by truncating any of the values at decimal places and then stored in the above-described respective tables.

The user A, upon registration of a questioning resource, can make an initial investment with respect to the posting of the questioning resource using the above-described initial resource point calculated in the second mode of embodiment as the investment resource points (S2301). At the end of the answer reception period after answering resources having been posted by users B1 and B2 and also rating resources having been posted by the users C1 and C2, the pricing (not shown) is applied with respect to all the resources within the community including the posted answering and rating resources. Then, in dependence on the values of these resource points, a given part of the investment resource points is allotted as direct allotment points (direct allotment) and distributed to the accounts of the users B1, B2, C1, and C2 (S2302 and S2303). In addition, if the user D who has not posted answering resource or rating resource directly with respect to the questioning resource but did have posted by another chance such a resource that happens to have a relation to these resources, then the resource that has been posted by the user D can be subject to allotment of the investment resource points (indirect allotment), and the account of the user D can be also allotted with a given part of the investment resource points as indirect allotted points (S2304). In addition, any fractional parts of the resource points, which have been generated through the calculation of these direct and indirect allotments, can be collected and added to an operator account (S2305).

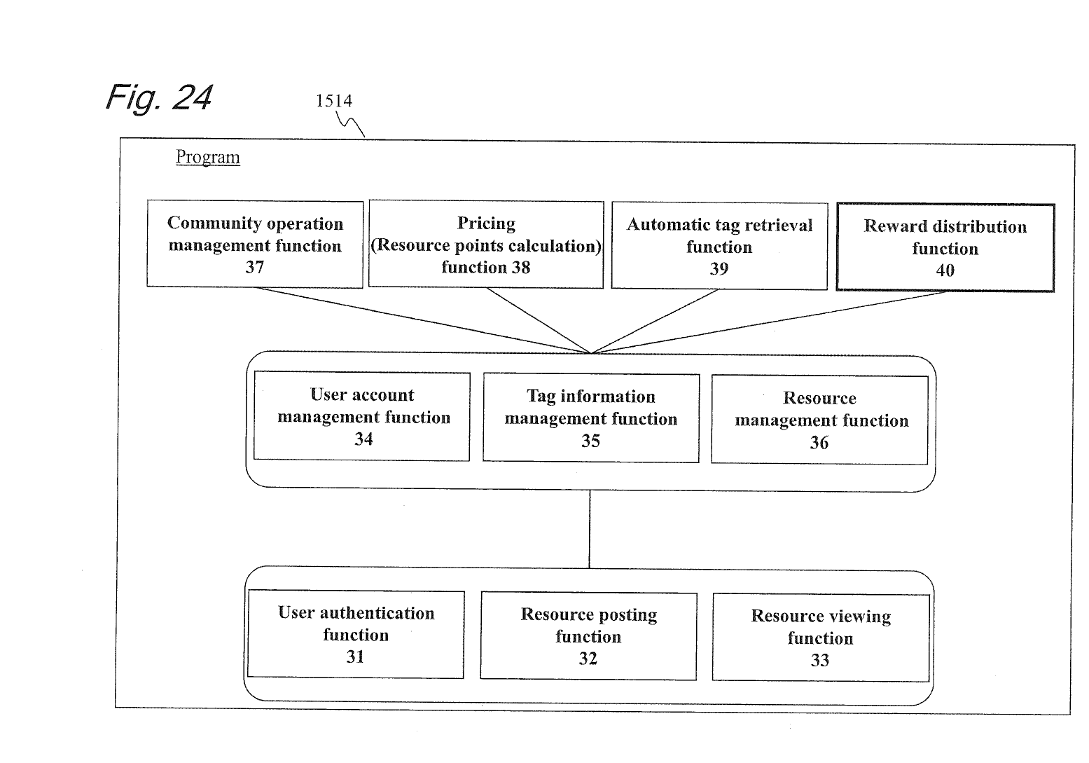

As seen in a list of preferred functions (1514) in the present embodiment shown in FIG. 24, a reward distribution function 40 is further provided in addition to the functions 31 to 39 provided in the program 1513 of the point(s) valuation and allotment system of FIG. 19 in the third mode of embodiment as described above. The reward distribution function 40 accepts an investment of resource point by a user at the time of the questioning resource registration and determines as to where the resource point are distributed and calculates the point to be allocated to the thus determined users at the end of the answer reception so as to increase or decrease the account point of each user concerned. The account point, as used herein, refers to the point possessed by an account of a user stored in the user table 41, which can be increased or decreased by the investment, at the time of the posting of a questioning resource by a user as well as during the reward distribution for the direct and indirect allotments. Further, the given part used in the direct allotment points and/or indirect allotment point(s) calculation can be set beforehand by the community operator with the aid of the community operation management function 37 as mentioned above.

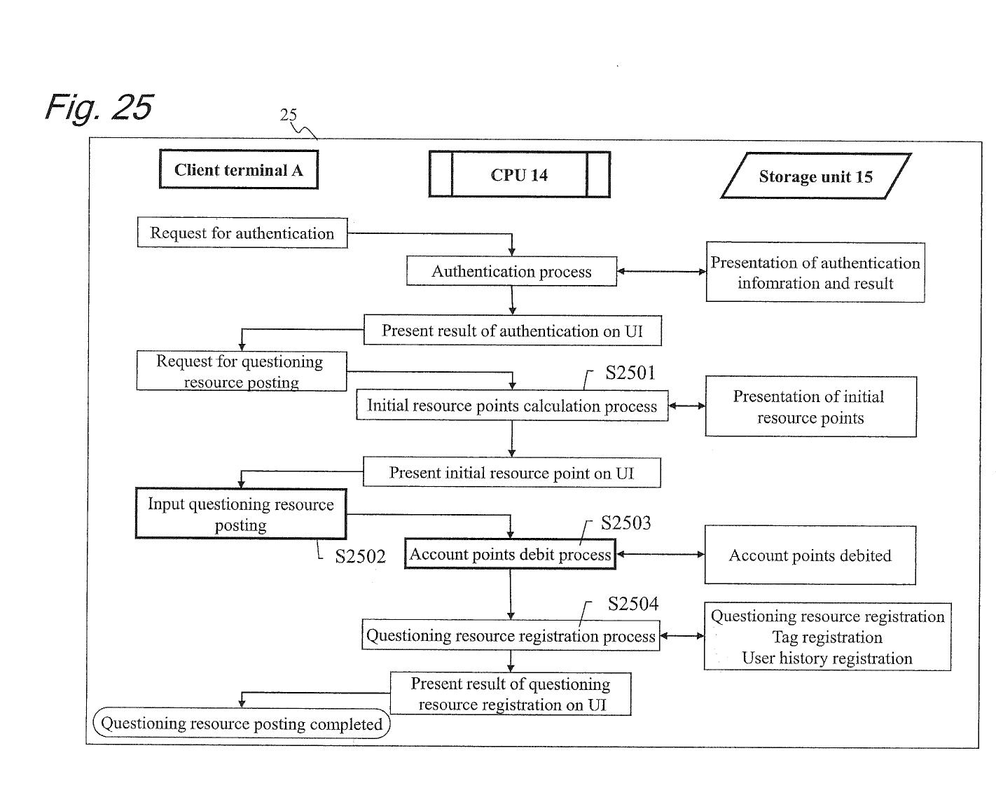

A flow (25) involving a flow of an answering resource registration onto a point(s) valuation and allotment server by a client terminal A is shown in FIG. 25. In comparison with an answering resource registration flow of FIG. 12 that has been used in the description of the second mode of embodiment, an account debit process (S2503) by the processing unit 14 is added, and with this timing, the account point for the user A stored in the user table 44 can be deducted for storage. Further, since upon inputting a questioning resource for posting (S2502), a calculated initial resource point is presented on the client terminal, therefore, only if the user with his/her eye on the resource point decides to make an investment, “an authorized registration” of the questioning resource can be carried out, and if the user decides not to make an investment, then “an authorized registration” will not be carried out and “a temporary registration” can be cancelled.

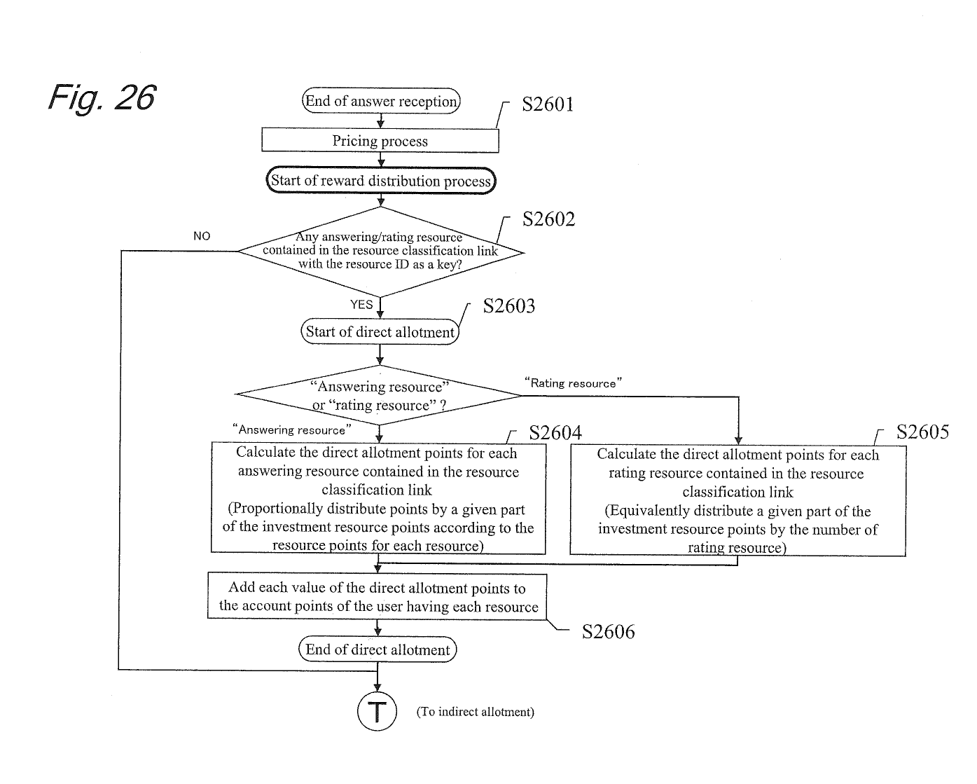

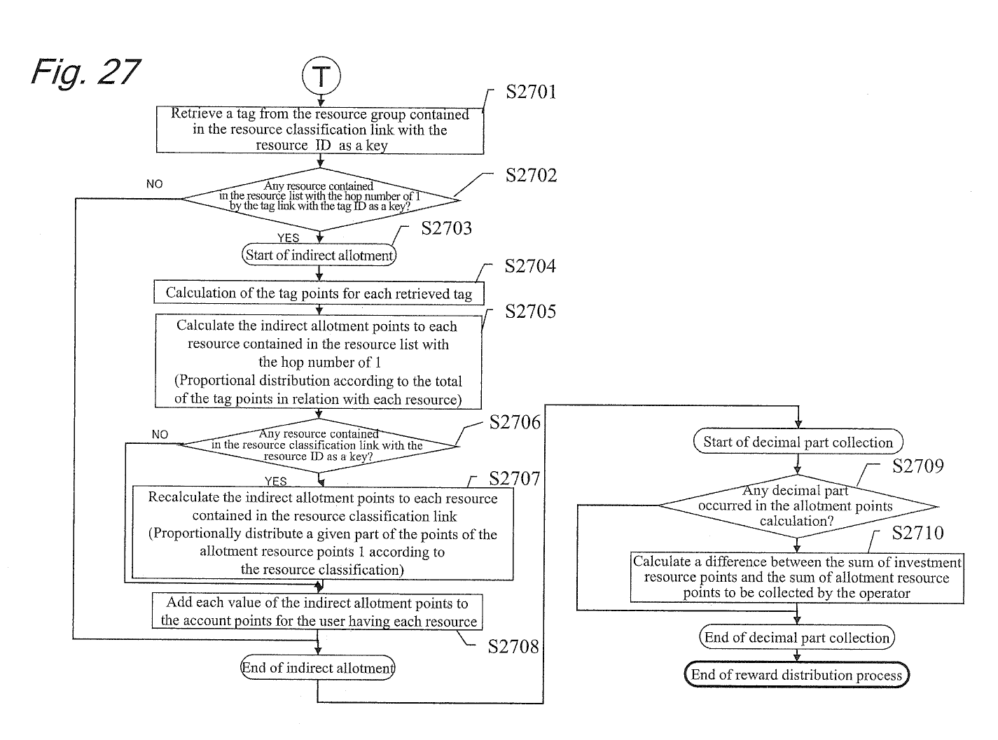

A flow chart of a preferred reward distribution process in the present embodiment will be described below with reference to FIGS. 26 and 27. The reward distribution process in the present embodiment may include a direct allotment process, an indirect allotment process, and a fractional part collection process.

The present embodiment comprises a point investment step (S2503) comprising the steps (S2503 and 2504) characterized by subtracting the initial resource point in the new resource information stored in the resource table (42) from the value of the account point in the user account information, which has the value of the posting user ID in said new resource information as the value of the user ID in the user account information stored in the user table (41) and then further storing a result obtained from this subtraction as the value of the account point of said user account information into the user table (41) so as to increase or decrease the value of said account point.

In addition, every piece of tag information stored in the tag table (43) as described above further comprises tag point, wherein the tag point of one piece of tag information can take for storage a value from the summation of the values of the resource points in said resource information that has further as the value of the resource ID in said resource information stored in the resource table (42), the value of one or more resource ID(s) in the resource-tag correspondence information having the value of the tag ID in said one piece of tag information as the value of the tag ID in said resource-tag correspondence information stored in said resource-tag association table (45).

The processing is characterized in that it further comprises a step occurring at the above-described (first) timing to calculate the points for all pieces of tag information and store each of the values of the points as the value of the tag point in the tag information in the tag table and also comprises a reward distribution step as will be described below.

The reward distribution step in the present embodiment is characterized by: (i) at the (second) timing as specified when the (first) text of the resource in the new resource information has been input via the interface (21), selecting a value of the resource ID in the new resource information to be subject to valuation by the above-described selection step; (ii) generating a resource list having the hop number of 1 with respect to said resource ID in said new resource information by the first resource list generation and storage step (1603); (iii) summing up the values of the tag points of those pieces of tag information, each of which further has, as the value of the tag ID in the tag information stored in the tag table (43), the value of the one or more tag ID(s) in the resource-tag correspondence information, each having the value of each resource ID possessed by said resource list as the value of the resource ID in the resource-tag correspondence information stored in the resource-tag association table (45) to calculate thereby each total value of the tag points with respect to each resource ID possessed by the resource list having the hop number of 1 and storing the calculated value into the temporary memory (153); (iv) calculating each value of the point to be allotted with respect to each resource ID possessed by said resource list from the value of the initial resource point in the new resource information stored in the resource table (42) based on the ratio of the sum of the values of the tag points and storing the thus calculated each value of the points into the temporary memory (153); and (v) adding each value of the stored point that is to be allotted to each value of the account point of such user account information that further has, as the value of the user ID in the user account information in the user table (41), the value of the posting user ID in the resource information that has the value of each said resource ID possessed by the resource list as the value of resource ID in the resource information stored in the resource table (42) and storing the result from the addition taken as the value of the account point in the user account information into the user table (41).

In FIG. 26, once the reception of answering and rating resources with respect to one questioning resource has been terminated, firstly the pricing process is executed with respect to all resources within the community by means of the pricing in the foregoing second mode of embodiment (S2601) and then the reward distribution process will begin. If any answering or rating resources have been registered with respect to said questioning resource, or specifically if any answering or rating resources related to the questioning resource are contained in the resource association table 46 as in the resource classification link (S2602), then each of the resources will be subject to the distribution of the direct allotment point(s). The processing unit 14 may start the direct allotment process with the aid of the reward distribution function 40 (S2603). Then, with respect to the resource representative of “an answering resource,” a proportional distribution according to the resource point value for each answering resource is carried out by using the point comprising a part given for “answering resource allotment” of a part of said investment resource point given for “direct allotment” (for example, relative to the investment resource Points of 10000, 500 Points equivalent to 50% thereof is given for the direct allotment and 300 Points equivalent to 60% of the part given for the direct allotment is given for the answering resource allotment) (S2604). In this example, if the resource classification link contains answering resources V and W having the resource Points of 1000 and 2000, respectively, then the points to be allotted to the resource V will be 100 Points and that to the resource W will be 200 Points.

Alternatively, with respect to the resource representative of “a rating resource,” an equalized distribution, the distribution equalized by the number of rating resources contained in said resource classification link is carried out by using the point comprising a part given for “rating resource allotment” of a part of said investment resource point given for “direct allotment (for example, relative to the investment resource Points of 10000, 500 Points equivalent to 50% thereof is given for the direct allotment and 200 Points equivalent to 40% of the part given for the direct allotment is given for the rating resource allotment) (S2605). In this example, if the resource classification link contains the rating resources X and Y, then the point to be allotted to the resources will be 100 Points each. Although the present embodiment has employed herein the equalized distribution for the distribution with respect to the rating resources, it may also take the form of proportional distribution according to the resource points values for respective resources, as is the case for the distribution with respect to the answering resources as described above. Each value of the direct allotment point will then be added individually to each value of the account point for the user having each resource to thus complete the direct allotment process.

Thus, the direct allotment process is accomplished and the flow will transfer to an indirect allotment process.

Then, in FIG. 27, prior to starting the indirect allotment process, a tag is retrieved from a resource group contained in the resource classification link (S2701). It is to be noted that this process of tag retrieval is not limited to the time after the end of the answer reception but may be carried out simultaneously with occurrence of the event of storing a resource into the resource table 42 and/or it may be such a process that can be carried out with a fixed interval or time, such as one time/day. Further, although in the present embodiment, the resource group is taken as a subject from which the tag is retrieved, the subject is not limited to this but for example, the tag may be retrieved only from the questioning resources. By means of the resource-tag association table, a determination is made for each tag whether or not there is a resource associated with the same tag as that has been retrieved, or whether or not there is a resource linked in accordance with one hop via the retrieval tag in the above-described tag link (S2702). If there is such a resource existing therein, then the indirect allotment process will start (S2703). In said process, at first, a total value of resource points possessed by the resources associated with said tag is calculated respectively as the tag point and stored in the tag point in the tag table 43 in connection with each tag which has been retrieved (S2704). Then, using said point equivalent to a part of investment resource point given for “indirect allotment” (for example, relative to the investment resource point of 1000, 500 Points equivalent to 50% thereof is given for the indirect allotment), a proportional distribution is carried out on these resources according to the total value of the tag points for the tags associated with each resource so as to obtain an indirect allotment point(s) (S2705). In this example, if the tag link contains a rating resource XX having tags A and B and a rating resource YY having a tag C, with the tag point of 300 Points for tag A, 500 Points for tag B and 200 Points for tag C, respectively, then the point to be allotted of 500 Points can be distributed to respective resources proportionally with a ratio of (300+500):200. Specifically, the point to be allotted to the resource XX will be 400 Points and that to the resource YY will be 100 Points. In this connection, if there are two or more resources associated with the tag, the equalized distribution by the number of resources or the proportional distribution according to the resource point(s) can be applied. The indirect allotment is further characterized in that said point(s) calculated in accordance with the proportional distribution can be further calculated for redistribution by using the resource classification link. Specifically, with respect to the resource associated with the same tag as said retrieved tag, the indirect allotment can be extended even to cover the resource that is contained in the resource classification link in conjunction with said resource (S2706). In this case, according to a given percentage predetermined for each resource classification (for example, 40% for “any questioning resource”, 40% for “any answering resource,” and 20% for “any rating resource” making a total of 100%), said indirect allotment point(s) may be distributed to said resource so as to provide a final indirect allotment point(s) (S2707). In this example, the 100 Points once proportionally distributed to the resource YY (questioning resource) are again redistributed at an answering resource ZZ and a rating resource ZZZ contained in the resource classification link, so that 40 Points, 40 Points and 20 Points are to be distributed to the questioning resource YY, the answering resource ZZ and the rating resource ZZZ, respectively. In doing so, it is to be noted that if there is a plurality of registrations of answering or rating resources, then the equalized distribution by the number of resources or the proportional distribution according to the resource points can be applied again to each resource. Each value of the indirect allotment point(s) as recalculated at S2707 is individually added to the account point for the user having each resource to complete the indirect allotment process (S2708).

It is to be envisaged that in the calculation by the direct allotment process and/or the indirect allotment process as described above, the direct allotment point(s) and/or the indirect allotment point(s) could potentially take a numerical value having values at decimal places as a consequence from the proportional distribution and equalized distribution calculation to be carried out. In such a case, these values are supposed to be rounded up to integer values by truncating any values at decimal places (fractional part). As such, the reward distribution function 40 is able to execute a fractional part collection process of collecting thus produced fractional part of the points in order to avoid any inconsistency from occurring in the total sum of the resource points being distributed in the community. If it is determined that fractional parts have occurred in the direct allotment point(s) and/or indirect allotment point(s) calculation (S2709), the sum of these fractional parts, or a difference between the investment resource points and the sum of the points to be allotted, which have been rounded up to the integer values, may be collected by the operator (S2710). It is to be noted in connection with the points to be collected that such points can be handled by using an operation management table 48, which will be described later in connection with a fifth mode of embodiment, and may be provided for later reuse of the points.

Thus, by the operator collecting the fractional part, occurrence of any inconsistency in the total sum of the resource points being distributed in the community can be avoided and the stability of the community can be ensured. In addition, the operator can also use said points and make them available for redistribution in a form, such as transferring the points to a certain user account.

As shown in the present embodiment, by means of the indirect allotment process that can be herein realized in addition to the direct allotment process, the points distribution can be carried out not only between resources via a resource classification link but also between resources sharing a tag via a tag link. Further, not only a direct association between resources via a resource classification link but also an indirect association and a degree thereof between resources through a tag can be explicitly presented to a posting user of the resource.

### Example 5

In a fifth mode of embodiment of a point(s) valuation and allotment system of the present invention, the point(s) valuation and allotment system that can be realized by means of all of the first to fourth embodiments is able to further provide such a new pricing process to be carried out in the calculation of the resource point with respect to a resource within a community that can make available a current ratio of the points that may be calculated from the occurrence of the points movement in the community within a fixed period of time to be applied as a parameter during the calculation. As used herein, “the points movement” may include a points movement between the accounts, including the point(s) investment at the time of the posting of a questioning resource, the direct and indirect allotment of the points after the answer reception having been terminated and the collection by the operator at the time of the allotment in the fourth embodiment as described above, as well as the points collection by the operator at a given time with a negative interest as set beforehand by the operator. The collection of the points resultant from the negative interest are to be done by each subtraction of the point equivalent to “the account point of a user×an interest” (as noted herein, any fractional parts are to be truncated to roundup to an integer) from the account points for all the users within the community at a given time to yield the points to be collected for the operator account, which will be then collected by the operator. It is to be noted that the value of this negative interest and the timing of the collection by the operator can be set by the community operation management function 37 as described in said second embodiment. As used herein, the negative interest refers to a given points interest rate intended for the operator to collect the points from the user account at a given timing. This can bring a decrement of the account point unfavorably for the user, thus named “a negative interest.”

In this regard, the values of the resource points in all pieces of resource information to be stored in the resource table (42), the values of the tag points in all pieces of tag information stored in the tag table (43), the values of the account points in all pieces of user information stored in the user table (41) and the values of the points to be allotted for storage into the temporary memory (153) are all integer values determined by truncating any values at decimal places.

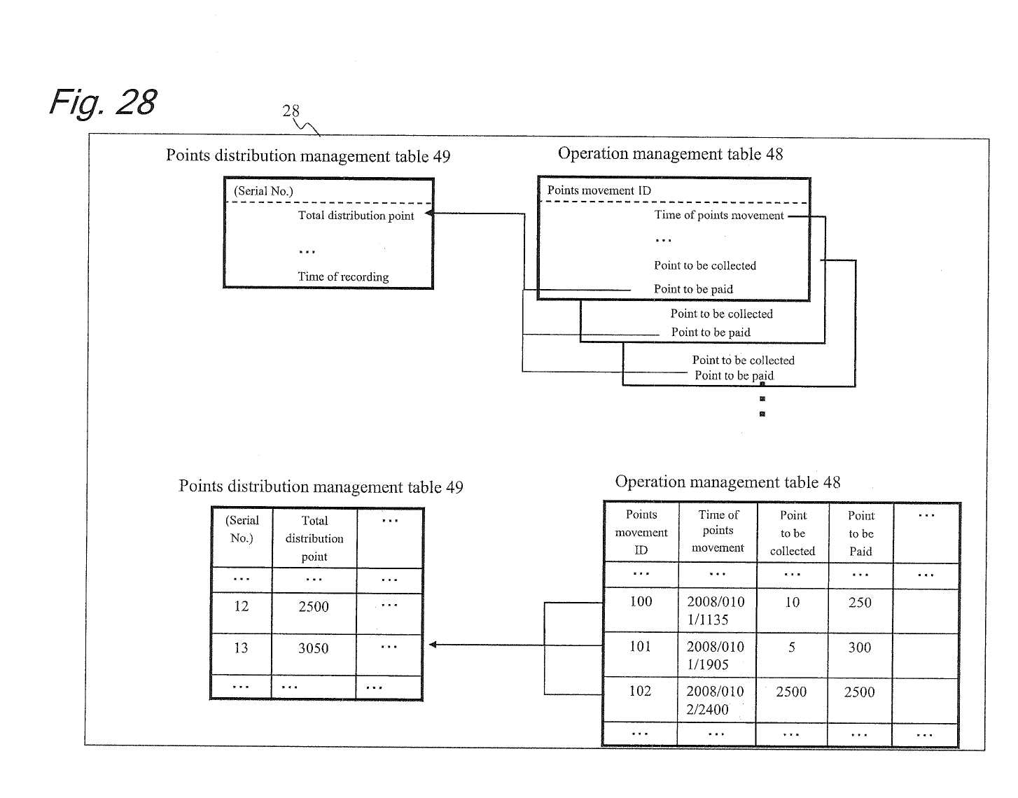

In the present embodiment, as shown in FIG. 28, the database 152 of the point(s) valuation and allotment server further comprises an operation management table (48) which may store a points movement record, including the time of occurrence of the points movement and a quantity of points moved, such as the points to be collected and the points to be paid. Further provided is a points distribution management table (49) which may store distribution information including a quantity of total points distributed for a fixed period of time and which may be used for managing the points distribution within the community (28).

The present embodiment comprises a step of storing in the operation management table (48), the management information including the value of the initial resource point for the new resource information stored in the resource table (42), which is taken as the value of the point to be paid, the difference between the value of the resource point in the new resource information and a total value of the point to be allotted for storage into the temporary memory (153), which is taken as the value of the point to be collected and the time of the (second) timing, which is taken as the value of the time of points movement.

The present embodiment further comprises the steps of: at a (third) timing, multiplying each value of the account point possessed by every piece of account information stored in the user table (41) by a given rate; truncating values at decimal places from the result from this multiplication to yield an integer; subtracting a thus yielded integer from each value of the account point; and storing the result from this subtraction taken as the value of account point in the user account information into the user table (41), and the step of storing into the operation management table (48), such management information including said integer value taken both as the value of the point to be paid and as the value of the point to be collected in the management information so as to be stored in the operation management table (48) and the time of said timing taken as the value of the time of points movement.

The present embodiment is characterized in that said database (152) further comprises a points distribution management table (49) for storing two or more pieces of points distribution information including total distribution points, wherein based on this, the embodiment comprises the steps of: (i) at the first timing as described above, calculating a total sum of the values of the points to be paid possessed by such management information with the value of the time of points movement falling within a given range, among those pieces of management information stored in the operation management table (48) by the above-described two steps of storing of the management information and storing the thus calculated total sum, taken as the value of the total distribution points, in the points distribution management table (49) (S301); (ii) calculating the total distribution points increase rate by taking a ratio of the value of the total distribution points which has been thus stored to the total distribution points in the last stored points distribution information among those pieces of points distribution information that have been already stored and storing the thus calculated total distribution point into said temporary memory (153) (S302); and (iii) calculating and storing point with respect to the new resource information, which includes newly calculating point based on the point that have been calculated with respect to said new resource information and the total distribution points increase rate that has been stored in the temporary memory (153) and storing the thus newly calculated point taken as the value of the resource point in the newly input one piece of resource information into said resource table (42).

As illustrated in FIG. 28, the values will be stored in the operation management table (48) and the points distribution management table (49). As used herein, the points to be paid refer to such as the points to be invested by a user at the time of the posting of a questioning resource and the points to be collected as a result from the negative interest, which are specifically the points to be paid out of the user account. Further, the points to be collected, which is opposite to the points to be paid, refers to the points to be collected into the operator account. As such, these payments and/or collections are recorded in said operation management table (48) each time that they occur. It is to be noted that upon collection into the operator account as a result of said negative interest, the points to be collected and said points to be paid may have the same value as set at the same time. These can be realized by adding a function enabling said process to the pricing (resource point(s) calculation) function 38 of FIG. 11 in the second embodiment.

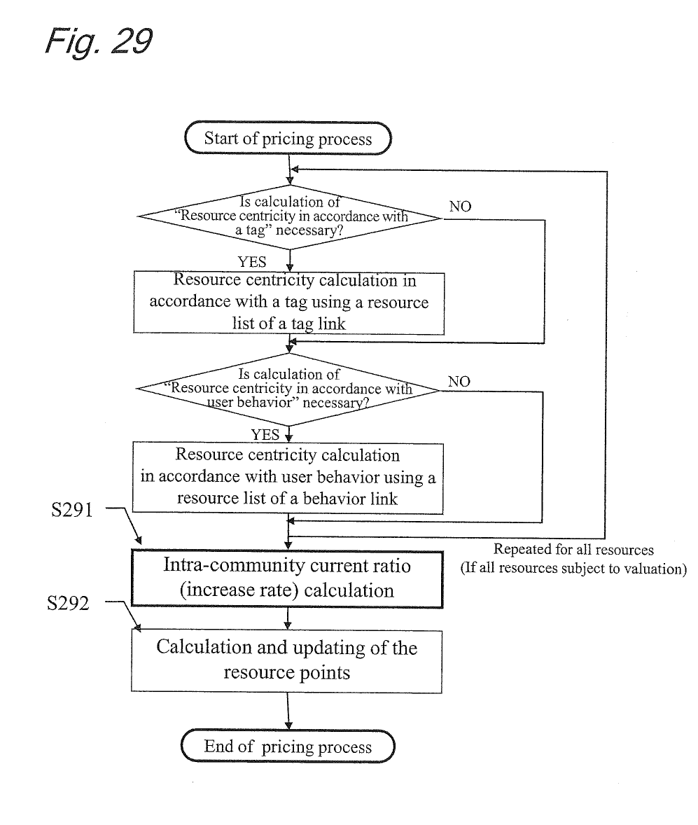

FIG. 29 shows an exemplary pricing flow in the present embodiment. Further, the flow of the pricing of the resource in the second embodiment as explained with reference to FIG. 15, another process referred to as S291 is added, in which the processing unit 14 of the point(s) valuation and allotment server 13 calculates a points current ratio (increase rate) within the community. The current ratio calculated in said process can be used as one of the input parameters in a resource point(s) calculation process at S292. Then, this may provide a function to calculate a quantity of total distribution of these points for a fixed period of time during the pricing (resource point(s) calculation function) 38.

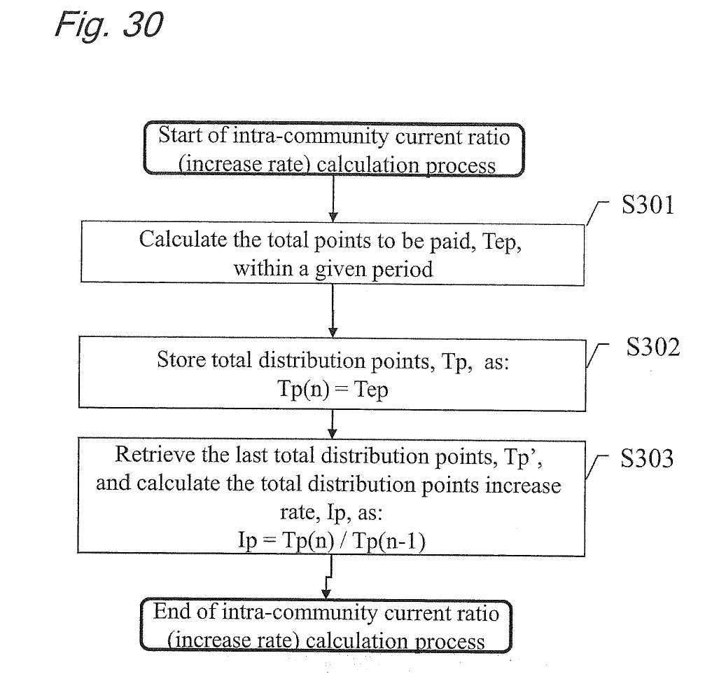

FIG. 30 shows an exemplary specific process flow involving “an intra-community point(s) current ratio (increase rate) calculation process” (S291) as described in S291 of FIG. 29 in the present invention. At first, using the above-described information stored in the operation management table (48), total point that have been paid out of the account points of users for a fixed period of time is calculated and set to Tep (S301). This “Tep” is calculated as the total distribution point Tp(n) (S302). Then, in accordance with the ratio relative to the last calculated total distribution point, Tp(n−1), an intra-community total distribution points increase rate, lp, can be calculated (S303). Thus, the intra-community points current ratio (increase rate) calculation process will be completed. Considering the example of storing in a table, as illustrated in FIG. 28 and assuming that the point movement from 100 to 102 has occurred with the points movement ID in the operation management table (48) within the given period, then 250+300+2500=3030 Points calculated as the Tp(n) will be stored in the total distribution point in the points distribution management table (49), and in accordance with the ratio relative to the Tp(n−1)=2500, lp=3050/2500 will be determined.

The resource points calculation process of the present embodiment corresponding to the resource points calculation process (S292) of FIG. 29 allows the resource points to be updated by multiplying the above-described intra-community total distribution points increase rate, lp, by the resource point calculated by means of the above-described “a resource median value calculation in accordance with a tag(s) using a resource list(s) of a tag link(s)” and/or “a resource median value calculation in accordance with user behavior(s) using a resource list(s) of a behavior link(s).”

The value that can be calculated in such a manner may reflect the condition of points distribution across the entire community during the pricing process. Accordingly, providing the value determination in dependence on the volume of currency distributed across the entire community can advantageously enhance the stability of the resources present in the community and ensure the stable points flow within the community as compared to the pricing process in the second embodiment as described above.

It is to be noted that said stability may be controlled through a forced setting of the intra-community total distribution points increase rate to a given value, if it falls out of a certain range.

### Example 6

A sixth mode of embodiment presents a new “resource pricing” process with an improvement in the configuration as shown in connection with the first and the second mode of embodiment. A user table may primarily have a user ID and a user median value associated with said user ID stored therein, while a user association table (311) may have one or more piece(s) of user association information stored therein, including one of such user IDs, other user ID(s) associated with said one of the user IDs and a user association type for identifying a relation between said one of the user IDs and other user IDs stored therein, based on which information, the process can be carried out.

The second embodiment has envisaged “a resource median value in accordance with a tag(s)” (a first resource median value) and “a resource median value in accordance with user behavior(s)” (a second resource median value) as a resource median value indicative of centricity of a resource and calculated the resource point based on them. In contrast to that, the present embodiment takes into account a concept of “user link,” in which a link between users can be indicated upon “a resource median value calculation in accordance with user behavior(s)” as in the above-mentioned. Further, the present embodiment is characterized in that it takes such a value that can be determined from the division between “a resource median value in accordance with a tag(s)” and said “a resource median value in accordance with user behavior(s) with a user link(s) taken into account” to be defined as “a resource demand-supply value,” based on which, “pricing of a resource” is carried out so as to determine the final resource point.

An overview of the process will be herein described. The resource point(s) calculation function 38 comprises a module for calculating a value of user median value to be stored in the user table (41) for one user ID (S3306), wherein the value of the user median value to be stored in the user table (41) is calculated based on the value of each user median value, which is further associated by the user table (41) with each of the other user IDs associated with said one user ID stored in the user association table (311) and each user association type for identifying the relation between said one user ID and each of the other user IDs. The resource point(s) calculation function 38 is characterized in that it further comprises a module for further calculating a second resource median value of the one resource ID as described above, further based on each value of the user median values that is further associated by the user table (41) with each of the user IDs in the user behavior correspondence information associated with one resource ID stored in the user history table (44) as described above.

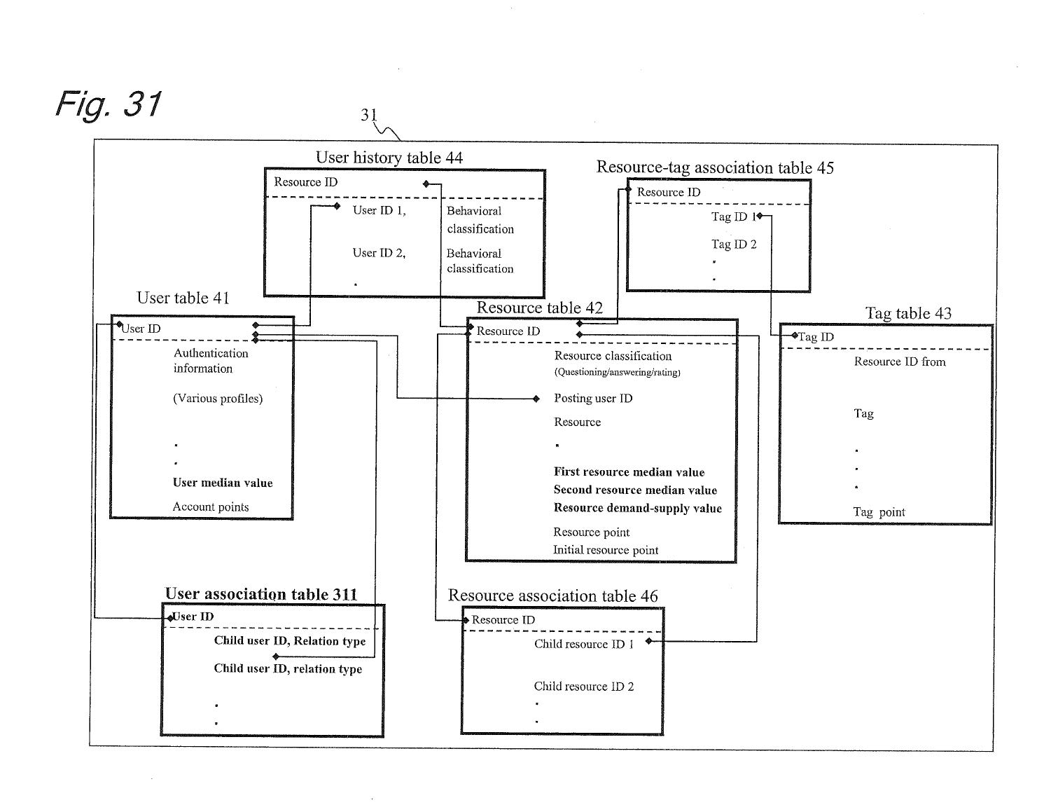

FIG. 31 shows a list of preferred tables and their associations (31), which represents an improvement from the one as shown in FIG. 4. Specifically, a user association table 311 is added, and also “a resource demand-supply value,” “a first resource median value,” and “a second resource median value” are added in the resource table 42, while “a user median value” is added in the user table 41. As used herein, the user association table 311 is a table for storing user association information, specifically such information that associates one user ID with other user IDs (user IDs) in conjunction with “a relation type.” Such “a relation type” may include, for example, “(F): registered on a favored user” and “(D): registered on a denied user.”

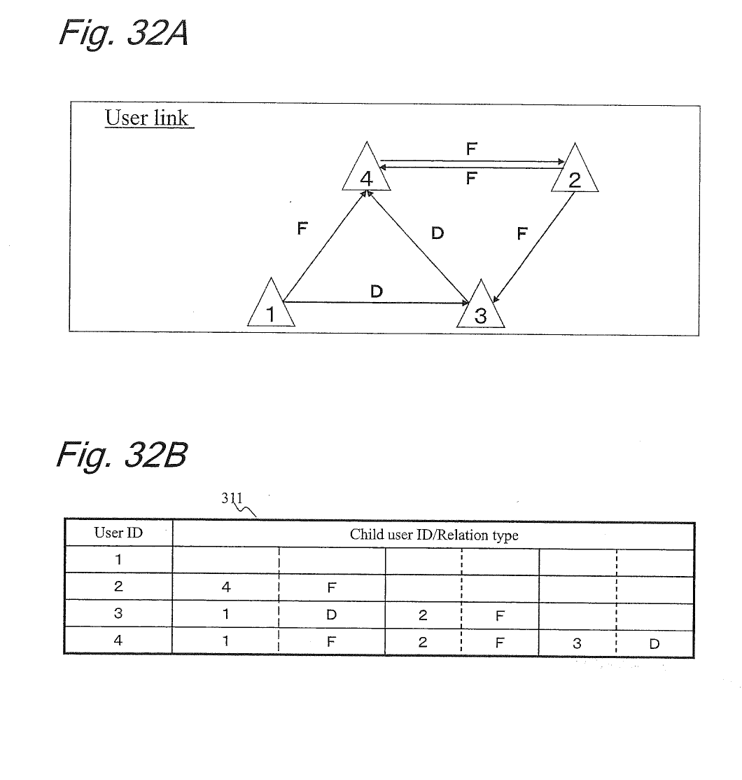

Turning now to FIGS. 32A and 32B, depicted therein is a link between a plurality of users (hereinafter referred to as “a user link”) that can be configured by the information contained in the user association table 311 as described above. A user link among users 1, 2, 3, and 4, as illustrated in FIG. 32A, can be configured by storing the information in the user association table 311 in such a form as illustrated in FIG. 32B.

Specifically, the user having the user ID “2” has been “registered on a favored user” with the user having the user ID “4”, while the user having the user ID “3” has been “(D): registered on a denied user” with the user having the user ID “1” and, at the same time, “(F): registered on a favored user” with the user having the user ID “2”. Likewise, the user having the user ID “4” has been “registered on a favored user” with the users having the user IDs “1” and “2”, respectively, and at the same time, “registered on a denied user” with the user having the user ID “3”. It is to be noted that these “(F): registered on a favored user” and “(D): registered on a denied user” can be accomplished by a user of 1 who assigns a user to be registered through the user interface on a client terminal. Although the description will be given below by using “(F): registered on a favored user” and “(D): registered on a denied user” as applied to “a relation type,” the present invention is not limited to these.

In the present embodiment, generation of the user link with respect to the users who have been registered allows the centricity of each user in that user link to be determined objectively. This is based on a prospect that with respect to the users present in a community, a user who is “registered on a favored user” with more users will have higher centricity, while a user who is registered on a denied user” with more users will have lower centricity.

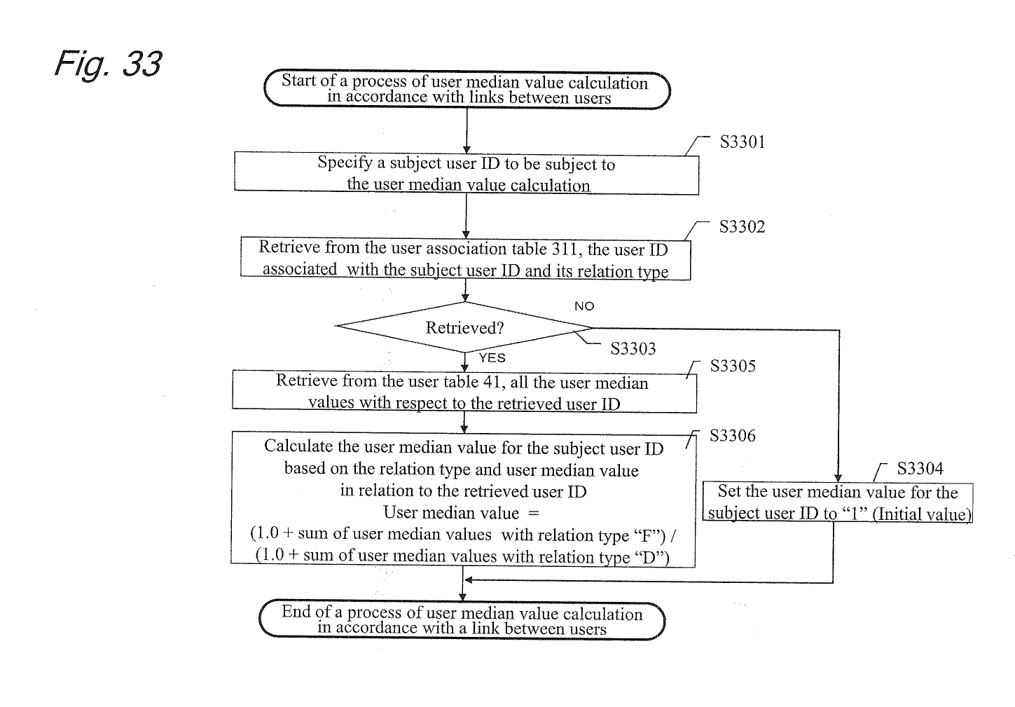

FIG. 33 represents a process flow showing a step to be executed by a processing unit of a server in order to calculate such a user median value for a user ID. Specifically, at first, a user ID to be subject to a user median value calculation is identified (S3301). Then, in the user association table 311, all user IDs associated with said subject user ID as well as their relation types are retrieved (S3302). If no user ID associated with said subject user ID is retrieved (S3303), then “1” taken as the user median value for the subject user is stored in “a user median value” in the user table 41 (S3304). If any user IDs associated with said subject user ID are retrieved (S3303), then using the user table 41, the user median value for every one of said retrieved subject user IDs is retrieved (S3305). Then, using the user median values that have been retrieved at S3304 for each relation type (i.e., “F” or “D”) that has been retrieved at S3302, the user median value of the subject user ID can be calculated in the following equation defined as:

User median value of subject user ID=(1+sum of user median values of user IDs associated in accordance with relation type “F”/(1+sum of user median values of user IDs associated in accordance with relation type “D”),

and stored in “a user median value” in the user table 41 (step S3306).

Assuming that the median value for the user ID “4” is to be calculated (S3301) for the case as previously illustrated in FIGS. 32A and 32B At first, the user IDs “1” and “2” with the relation type “F” and the user ID “3” with the relation type “D” are retrieved, respectively, from the user association table (S3302, S3303). As supposed herein by way of example that the user median value for the user ID “1”=2.0, the user median value for the user ID “2”=0.5 and the user median value for the user ID “3”=1.0, respectively, in the user table 41, these values should be retrieved from the user table (S3305) and the calculation will be made as follows:

the median value of the user ID “4”=(1+2.0+0.5)/(1+1.0)=1.75,

and the result is stored in the user table 41 (S3306).

It is to be noted in connection with the calculation of said user median value and the storage of said value in the user table 41 as well as the timing for this that: (i) at the time of the user registration, specifically when user information is to be newly stored in the user table 41, the user median value taking its initial value of “1” is stored in the user table 41; (ii) when the user of 1 has acted over other users to place them as “(F): registered on a favored user” or “(D): registered on a denied user,” specifically when any user association information has been stored or updated in the user association table 311, the user median values of said other user IDs are calculated and stored in the user table 41 by using the above equation; and (iii) at the time of the calculation of “a resource demand-supply value” for calculating the resource point within the community, which will be described later, similarly by using the above equation, the user median values of said other user IDs are calculated and stored in the user table 41.

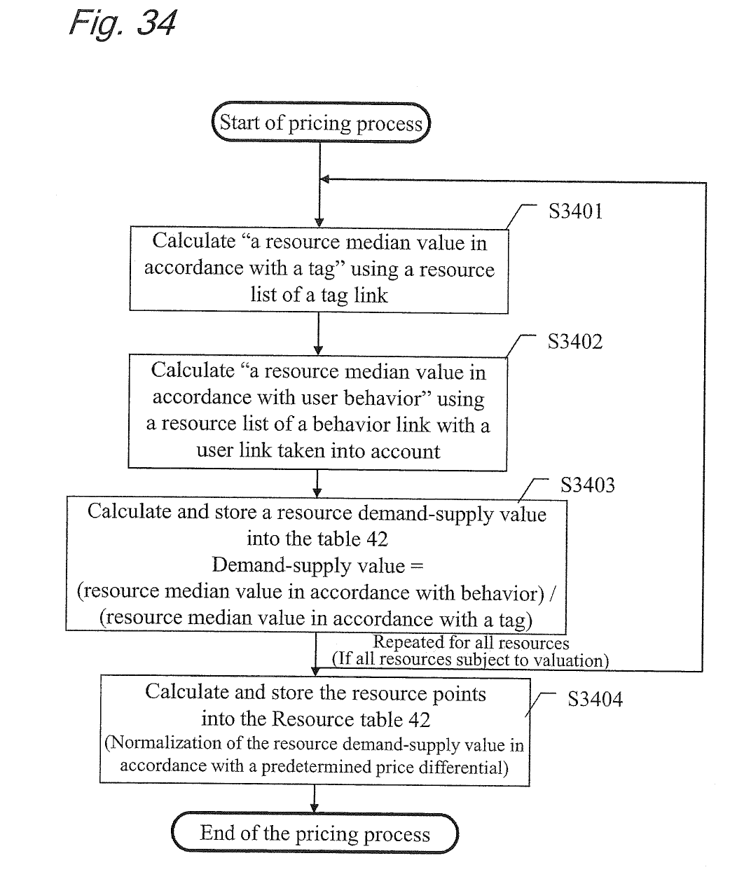

The foregoing is the description of “a user link” and the calculation of “a user median value” based on the user link, which have been newly introduced in the present embodiment. Turning now to FIGS. 34, 35, 36, and 37, the pricing process and the calculation process and others involving “a resource median value in accordance with user behavior(s) with a user link(s) taken into account” employed in the pricing process will be described in detail.

An overview of the pricing of a resource in the present embodiment representing an improvement from the second embodiment will be described specifically with reference to FIG. 34. Each of a plurality of resources to be stored in the resource table 42 has a first resource median value, a second resource median value, a resource demand-supply value and resource point. As such, with respect to any specific resource and/or every resource within a community, the present system may calculate said first resource median value, said second resource median value, said resource demand-supply value and said resource point through the pricing process and update respective items in the resource table 42 with values that have been calculated respectively.

In the pricing process in the present embodiment, the processing unit 14 of the point(s) valuation and allotment server 13 can, at first, with the aid of the resource point(s) calculation function, calculate the median value of each resource within the community by means of a tag link and a behavior link. To calculate said median value, herein, “a resource median value calculation in accordance with a tag(s) using a resource list(s) of a tag link(s)” (S3401) and/or “a resource median value calculation in accordance with user behavior(s) using a resource list(s) of a behavior link(s) with a user link taken into account” (S3402) can be used. Then, a value determined by the division between “a resource median value in accordance with behavior” (a second resource median value) and “a resource median value in accordance with a tag(s)” (a first resource median value) is taken as a demand-supply value and stored in the resource table 42 (S3403), which resource demand-supply value is further normalized with a predetermined point differential so as to determine the resource point for each resource (S3404).

As used herein, “a median value” refers to a value that indicates relatively objective centricity of a specific resource as viewed relative to an entire resource group having one or more resources and it can be calculated by employing the above-described tag link and/or behavior link along with their resource lists. Specifically, said specific resource having been directly/indirectly linked and thus having more relations with many of the other resources will have a higher median value, while in contrast, the one having lesser direct/indirect relations may have said median value that will be smaller. As such, based on the “resource median value in accordance with behavior” (a second resource median value) and “a resource median value in accordance with a tag(s)” (a first resource median value), “a demand-supply value” can be calculated and the value of the resource demand-supply value can be stored in the above-described resource table 42 as in association with one resource ID.

The resource point(s) calculation function 38 comprises a module for calculating the demand-supply value based on such a first and a second resource median value. In particular, a value from the division between “a resource median value in accordance with behavior” and “a resource median value in accordance with a tag(s)” can be taken as a preferred “demand-supply value.” “A resource median value in accordance with behavior” (a second resource median value) is indicative of how much a resource in question is demanded by users within a community and may be considered as “a quantity of demand for a resource in a community” so to speak. Besides, “a resource median value in accordance with a tag(s)” (a first resource median value) is indicative of how rare a resource in question is within a community and may be considered as “a quantity of supply of a resource in a community” so to speak. Accordingly, such an idea that a balance between the quantity of demand and the quantity of supply, specifically “a demand-supply value” as determined by applying the division therebetween can imply real value of the resource within the community is based.

It is to be noted that since said “demand-supply value is merely a value indicative of the balance between the quantity of demand and the quantity of supply, therefore, in practice for presenting the value on the user interface, such a value that has been normalized with a predetermined point differential (for example, the differential by a factor of one-tenth to ten within a given range of the resource point relative to the entire community, specifically relative to an average of the demand value over all resources stored in the resource table) applied to said resource demand value can be employed as the resource point (S3404), and preferably such a graph (D142) as shown in FIG. 14, for example, may be plotted and presented.

Said graph (D142) represents a table (not shown) in which resource points identifiable by a resource ID and a time and date when said value of the resource point was calculated will be stored, wherein said time and date are based on a table that contains the time and date when a resource has been input as well as the time and date, including fixed interval, fixed time and/or any desired set timing, and created in a presentation means provided on the point(s) valuation and allotment server 13 further based on the time and date as well as the point stored in said table, which are related to the resource identified by one resource ID, and then presented on the interface.

Specifically, the point for the resource identified by said one resource ID is characterized in that it is calculated based on the normalization of the value of the resource demand-supply value associated with said one resource ID in the resource table 42 within a given range in relation to all the values of the resource demand-supply values associated with all the resource IDs stored in said resource table 42.

It is to be noted that although the present embodiment has employed “a resource value calculation in accordance with a tag(s)” in common with the pricing process (S3401) of FIG. 15 as shown in connection with the second embodiment, the present embodiment differs from the pricing process of FIG. 15 in that it takes a user link into account in “a resource median value calculation in accordance with user behavior(s)” (S3402) and that a resource demand-supply value is further calculated (S3403) so as to determine the resource point (S3404).

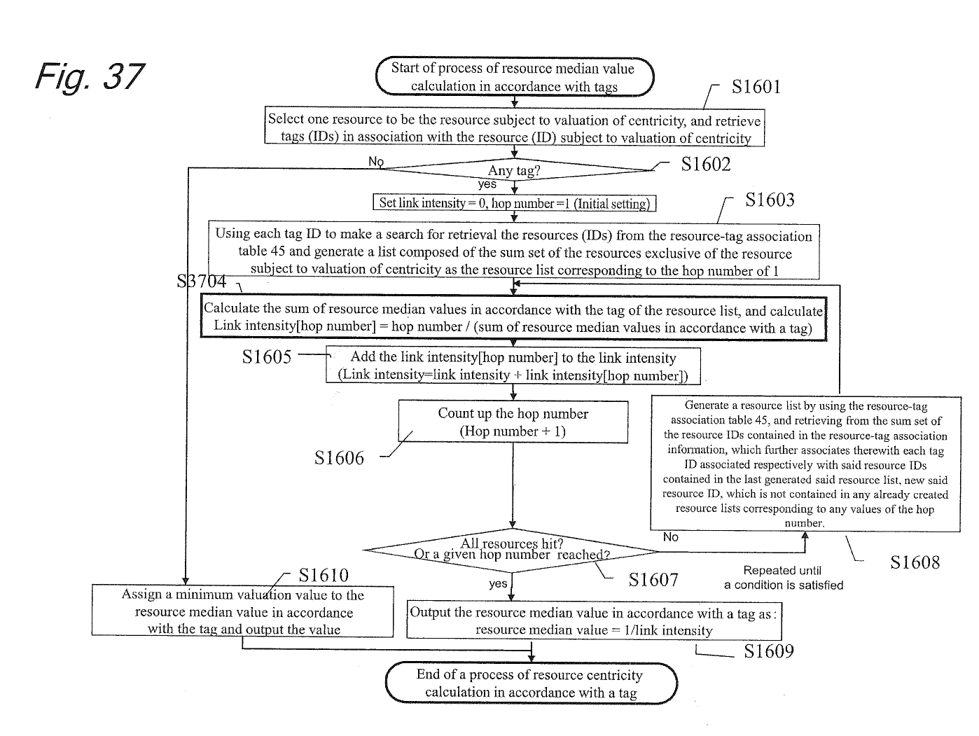

FIG. 37 represents an exemplary process flow involving “a resource median value calculation in accordance with a tag(s) using a resource list(s) of a tag link(s)” (S3401) of FIG. 34. Said flow differs from the process flow involving “a resource median value calculation in accordance with a tag(s)” as shown in FIG. 16 in that the present process, at step S3704, uses the first resource median value stored in the resource table 42 with respect to the resource ID contained in the generated resource list to calculate the sum of the resource median values in accordance with the tag in the resource list, and then calculates: “link intensity [hop number]=hop number/sum of resource median values (a first resource median value) in accordance with a tag(s).” Processes other than that are carried out as described in the second embodiment and FIG. 16.

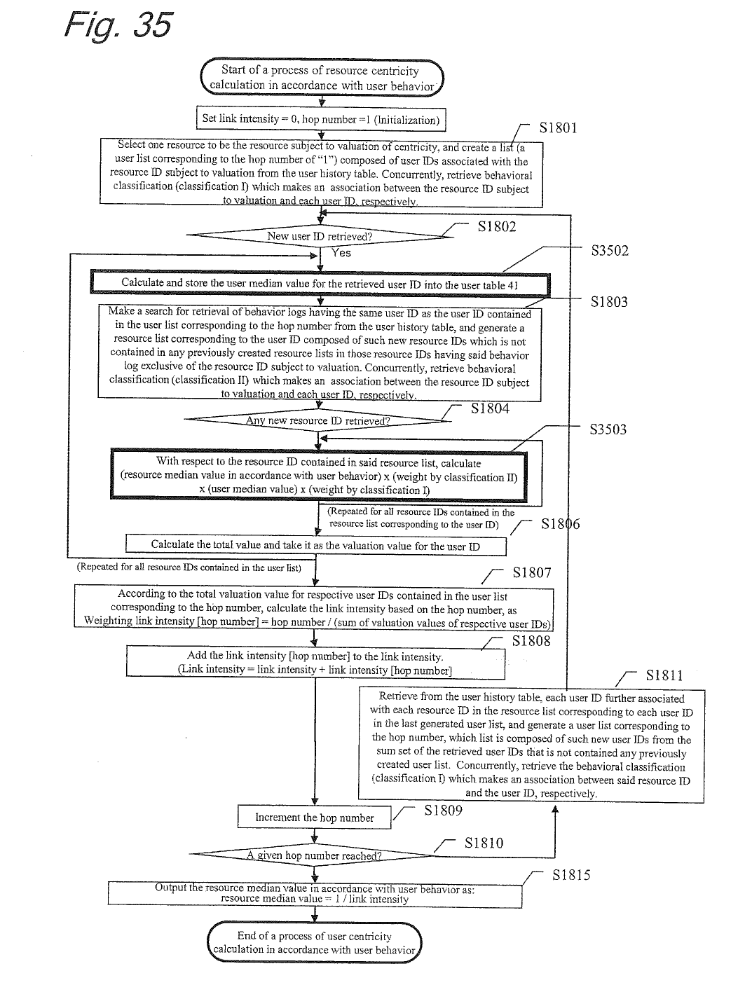

FIG. 35 represents an exemplary process flow involving “a resource median value calculation in accordance with user behavior(s) using a resource list(s) of a behavior link(s) with a user link taken into account” (S3402) of FIG. 34. Said flow differs from the process flow involving “a resource median value calculation in accordance with user behavior(s)” as shown in FIG. 18A in two aspects: (i) the present process calculates, with respect to each user ID contained in a user list to be generated (S1801, S1811 and S1802), the user median value of said retrieved user ID and stores the value in the user table 41 (S3501); and (ii) the present process, at step S3502, uses, with respect to a resource ID contained in the generated resource list, the second resource median value stored in the resource table 42 and the user median value calculated at S3501 so as to provide the valuation (S3502) as: “(resource median value in accordance with user behavior(s) (a second resource median value))*(weight by a classification II) (user median value as calculated)×(weight by a classification I).” Processes other than that described above are carried out as described in the second embodiment.

By calculating the valuation value for the user ID by means of “a user median value” of the user ID as explained in connection with FIG. 33, the resource point for the resource within the community that can be calculated in the present embodiment can even reflect the value of the user in relation to the resource.

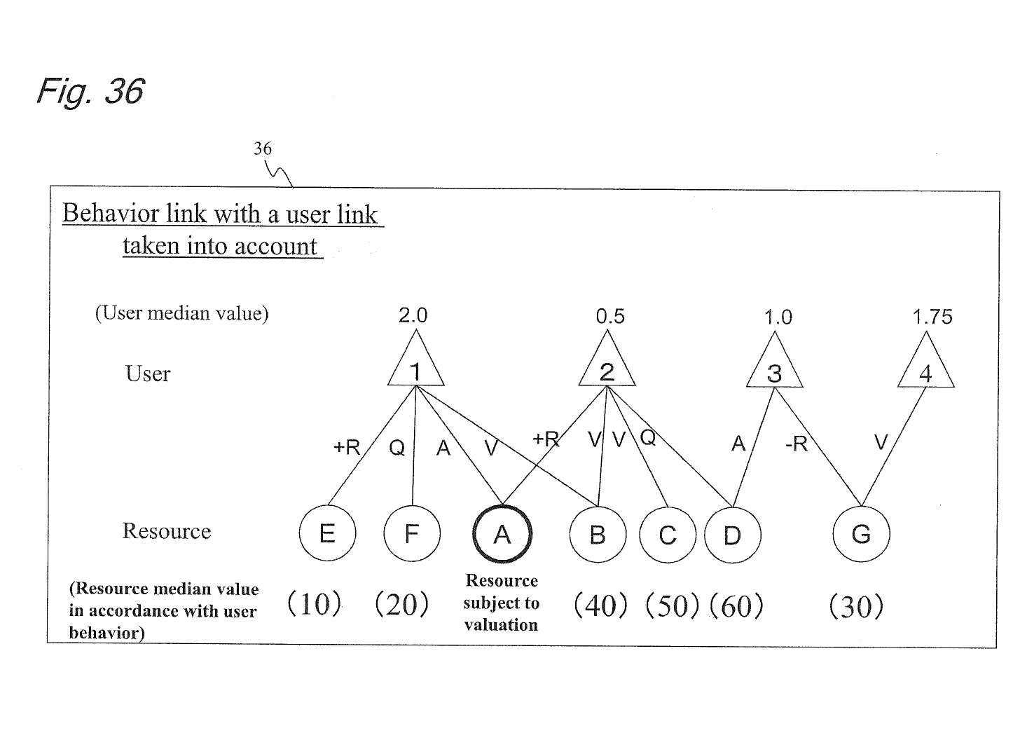

Now, the process of “a resource median value calculation in accordance with user behavior(s) using a behavior link(s) with a user link(s) taken into account” as stated above will be described based on an exemplary behavior link (36) as shown in FIG. 36. Assuming that “a resource median value in accordance with user behavior(s)” (a second resource median value) for the resources A to G at the time of the processing are as follows, respectively: the second resource median value for (A)=30, (B)=40, (C)=50, (D)=60, (E)=10, (F)=20 and (G)=30, and also that the weight in accordance with the behavioral classification is as follows: viewing (V)=1, answering (A)=3, questioning (Q)=4, positive rating (+R)=2, and negative rating (−R)=0.5. It is further assumed that users 1 to 4 constitute the user link as shown in FIGS. 32A and 32B, and the user median values to be calculated and stored in the user table 41 at the time of the calculation are as follows, respectively: the user median value for the user 1=2.0; the user 2=0.5; the user 3=1.0; and the user 4=1.75. In addition, for simplicity, “a given hop number=1” is taken and the repetitive processing at S1811 onward is not supposed to be applied. Under these assumed conditions, “a resource median value in accordance with user behavior(s) with a user link(s) taken into account” is to be calculated by the resource median value calculation process. Assuming that a resource subject to valuation is “the resource A.” As can be seen, the user list having the hop number of 1 from the resource A is denoted as “the users (1, 2).” Further, the resource list corresponding to “the user 1” is denoted as “the resources (E, F)” and the resource list corresponding to “the user 2” is denoted as “the resources (B, C, D).

(S1801) The user list having the hop number of 1, “the users (1, 2),” and the classification I (A, +R) are retrieved.

(S3501) The user median value of the user 1=(1+0.0)/(1+0.0)=1.0 and the user median value of the user 2=(1+1.75)/(1+0.0)=2.75 are calculated and stored in the user table 41, respectively.

(S1803) Using the user list having the hop number of 1, “the users (1, 2),” a search is made over the resources so as to generate the resource list corresponding to “the user 1,” “the resources (E, F),” and the resource list corresponding to “the user 2,” and “the resources (B, C, D).” Further, retrievals for the classification II (+R, Q, V, V, Q) are made, respectively.

(S3502 and S1806) A calculation is made to determine the valuation value, as follows:

Valuation value for the user 1=(valuation value for E+valuation value for F)={(10*(+2)*1.0*3)+(20*4*1.0*3)}=300, and
Valuation value for the user 2=(valuation value for B+valuation value for C+valuation value for D)={(40*1*2.75*(+2))+(50*1*2.75*(+2))+(60*4*2.75*(+2))}=1815.

(S1807) The link intensity [1]=1/(300+1815) is calculated.

(S1808) Therefore, the link intensity= 1/2115 results.

(S1815) A resource median value in accordance with user behavior(s) with a user link(s) taken into account=1/( 1/2115)=2115 results and the value is output to end the process.

In the foregoing description, an exemplary specific process involving the pricing of a resource provided in the present embodiment has been explained, which is characterized in that it is an improvement from the second embodiment, wherein “a user median value” in accordance with “a user link” and “a resource demand-supply value” representative of a value determined by the division between “a resource median value in accordance with a tag(s)” and “a resource median value in accordance with user behavior(s) with a user link(s) taken into account” are newly defined and “pricing of a resource” is carried out based on said “resource demand-supply value.”

In the foregoing description, the embodiments of a point(s) valuation and allotment system according to the present invention have been explained.

Realizing a point(s) valuation and allotment system of the present invention may provide an advantage that resource point for any one resource present in a community can be determined as an objective value relative to an entire community. Specifically, the above-described approach in which the median value for the resource is calculated by using the tag link as described above so as to determine the resource point implies that “a resource that is linked in accordance with a tag(s) possessed by other resources of high quality can be also evaluated as the one of high quality,” and likewise, the approach in which the median value of the resource is calculated by means of the link in accordance with user behavior(s) so as to determine the resource point can provide a mechanism wherein “a resource on which a user who has once invoked positive behaviors on other resources of high quality intends here again to invoke positive behavior can be also evaluated as the one of high quality.”

Further, realizing the management of points distribution across the community so that it can be reflected in the calculations of the resource points may create a condition where the resource points to be currently calculated during a quantity of total distribution points for a fixed period of time being greater, specifically in an environment where the entire community is active, can also rise high, while the resource points to be currently calculated during the entire community being inactive can drop. Specifically, provided is a mechanism that the resource points can be automatically adjusted with respect to “a market” represented by a community according to the current “condition of business activities.”

In addition, realizing such a mechanism that enables a user to invest point with respect to a questioning resource and the point(s) invested to be allotted, in particular not only directly but also indirectly, to another user who posts another related resource allows the point(s) to be distributed even to a user who has previously posted a resource that can be indirectly associated in accordance with a tag(s). It means that this makes the user who is posting the questioning resource have a thought that any outgiving action required when he or she posts the resource is an investment action and successfully encourages the postings of high quality resources by the users who are going to post the questioning resources. Additionally, relations among those questioning resources, which conventionally have been alienated, can be enhanced, so that the collection of the high quality resources around the tag can be achieved and a concept of a group having a common theme represented by the tag also can be established. Further, this may promise users who post resources to receive dividends and also foment the sense of their belonging to the group, leading to postings of high quality resources.

It should be understood that any modifications or variations may be made without departing from the various embodiments of the present invention or without departing from the true spirit thereof. Any descriptions contained in the present specification are merely illustrative and should not be translated in the sense of limiting.

1. A system operable with respect to a resource to be input by a user via an interface to calculate and output point for said resource, said system comprising:
a first storage means operable to store said resource, a resource ID for identifying said resource and a first resource median value associated with said resource ID;
a second storage means operable to store one or more piece(s) of resource-tag association information including one of said resource IDs and a tag ID associated with said one of said resource IDs, said tag ID for identifying a tag to be retrieved from said resource identified by said resource ID;
a first generation means operable to generate a resource list corresponding to a value of the hop number with respect to one resource ID based on said one or more piece(s) of resource-tag association information stored in said second storage means repeatedly by sequentially incrementing the value of said hop number from 1, wherein each one of said resource lists to be generated contains one or more said resource ID(s) and based on said resource ID contained in said resource-tag association information, which further associates therewith each said tag ID associated with each said resource ID contained in the last generated said resource list;
a first calculation means operable to calculate the first resource median value for said one resource ID based on the value of said hop number and the values of said first resource median values, each respectively associated by said first storage means with each of said resource IDs contained in said resource list corresponding to the value of said hop number;
a second calculation means operable to further calculate said point for said resource identified by said one resource ID based on said first resource median value calculated by said first calculation means; and
a presentation means operable to present said point calculated by said second calculation means on said interface.

2. A system in accordance with claim 1, wherein
said resource list having the value of said hop number of 1 to be generated in said first generation means is generated by subtracting said one resource ID from a sum set of said resource IDs contained in said resource-tag association information, which further associates therewith each said tag ID associated by said second storage means with said one resource ID; and
each of said resource lists having 2 or greater value taken as the value of said hop number to be generated in said first generation means is generated by retrieving new said resource IDs, each of which is not contained in any already generated said resource lists corresponding to any of the values of said hop number from a sum set of said resource IDs contained in said resource-tag association information that further associates therewith each of said tag IDs associated respectively with said resource IDs contained in said last generated resource list.

3. A system in accordance with claim 2, wherein further,
said first generation means is operable to generate said resource list repeatedly until there are no more said new resource IDs to be retrieved or the incremented value of said hop number has reached a given value.

4. A system in accordance with claim 1, wherein further,
said first storage means operable to store a second resource median value associated with said resource ID, said system comprising:
a third storage means operable to store one or more piece(s) of user behavior correspondence information including: one of said resource IDs; a user ID associated with said one of said resource IDs, said user ID for identifying said user; and a behavioral classification for identifying a relation between said one of said resource IDs and said user ID;
a third calculation means operable to calculate a user valuation value with respect to each one of said user IDs associated with said one resource ID based on said one or more piece(s) of user behavior correspondence information stored in said third storage means, wherein with respect to each one of said user IDs, said third calculation means calculates said user valuation value for said user ID based on: the value of said second resource median value, which is further associated by said first storage means with said resource ID in said user behavior correspondence information that associates therewith said user ID; the value indicative of said behavioral classification for identifying a relation between said resource ID in said user behavior correspondence information, which associates therewith said user ID and said user ID; and the value indicative of said behavioral classification for identifying the relation between said one resource ID and said user ID in said third storage means; and
a fourth calculation means operable to calculate said second resource median value for said one resource ID based on said user valuation value for each one of said user IDs calculated in said third calculation means.

5. A system in accordance with claim 4, further comprising:
a fourth storage means operable to store said user ID and a user median value associated with said user ID;
a fifth storage means for storing one or more piece(s) of user association information including one of said user IDs, other said user IDs associated with said one of said user IDs and a user association type for identifying a relation between said one of said user IDs and said other user IDs; and
a fifth calculation means operable to calculate the value of said user median value to be stored in said fourth storage means with respect to one user ID, wherein the value of said user median value to be stored is calculated based on: the value of each said user median value, which is further associated by said fourth storage means with each one of said other user IDs associated with said one user ID stored in said fifth storage means; and each said user association type for identifying the relation between said one user ID and each of said other user IDs, wherein
said second resource median value of said one resource ID to be calculated by said fourth calculation means is calculated further based on the value of each of said user median values, which is further associated by said fourth storage means with each of said user IDs in said user behavior correspondence information associated with said one resource ID stored in said third storage means.

6. A system in accordance with claim 4, wherein said behavioral classification includes questioning, answering, negative rating, positive rating, and/or viewing, and the value indicative of said behavioral classification is set as weighted corresponding to each said behavioral classification.

7. A system in accordance with claim 5, wherein said user association type includes favored user registration and/or denied user registration.

8. A system in accordance with claim 4, wherein further,
said first storage means is operable to store a resource demand-supply value associated with said resource ID, and said system comprises:
a sixth calculation means with respect to said one resource ID operable to calculate the value of said resource demand-supply value associated with said one resource ID to be stored in said first storage means, based on: said first resource median value, which has been calculated by said first calculation means; and said second resource median value that has been calculated by said fourth calculation means.

9. A system in accordance with claim 8, wherein the value of said resource demand-supply value to be calculated and stored by said sixth calculation means is based on a value from division between said second median value and said first median value.

10. A system in accordance with claim 9, wherein said point for said resource identified by said one resource ID to be calculated by said second calculation means is calculated in accordance with normalization of the value of said resource demand-supply value associated with said one resource ID in said first storage means within a given range in relation to the values of all said resource demand-supply values associated with all said resource IDs stored in said first storage means.

11. A system in accordance with claim 1, comprising:
a sixth storage means operable to store said point for said resource identified by said resource ID and the time and date when the calculation of said point for said resource has been made by said second calculation means, wherein said time and date when the calculation of said point has been made is such time and date, including the time and date when said resource has been input as well as a timing by a fixed interval, a fixed time and/or any timing as set, said system characterized in that
said presentation means is further operable to create and present on said interface a resource points transition graph with respect to said resource identified by said one resource ID, which is based on said time and date and said point associated with said one resource ID stored in said sixth storage means.

12. A method to be carried out on a server, said server comprising a database within a storage unit, said database containing: a resource table for storing two or more pieces of resource information including a resource, a resource ID for uniquely identifying said resource and a resource point; a tag table for storing two or more pieces of tag information including a tag and a tag ID for uniquely identifying said tag; and a resource-tag association table for storing one or more piece(s) of resource-tag correspondence information including one of said resource IDs included in said resource information and one or more tag ID(s) associated with said resource ID, wherein said method is carried out by a processing unit further provided on said server equipped with a temporary memory to calculate and store a value of resource point in one piece of said resource information based on the values of said resource points in other pieces of said resource information so as to increase or decrease an account point, said method comprising:
a selection step of selecting a value of said resource ID in one piece of said resource information stored in said resource table;
a first resource list generation and storage step including: retrieving the values of said tag IDs in said resource-tag correspondence information having the value of said selected resource ID as the value of said resource ID in said resource-tag correspondence information; further, retrieving the resource IDs in said resource-tag correspondence information having the values of said retrieved tag IDs as the value of said tag IDs in said resource-tag correspondence information; generating a list composed of the values of said resource IDs, which are determined by deleting the value of said selected resource ID from a sum set of the values of said retrieved resource IDs, as a resource list corresponding to the hop number of 1 taken as said hop number with respect to said selected resource ID; and storing the thus generated list into said temporary memory;
a second resource list generation and storage step of generating said hop number correspondent resource list with the value of said hop number, which is an integer of 2 or greater, repeatedly by incrementing the value of said hop number from 2 until a given condition is satisfied and storing the thus generated list into said temporary memory, said second resource list generation and storage step including: retrieving the values of said tag IDs in said resource-tag correspondence information having the values of said resource IDs included in the last generated said hop number correspondent resource list as the values of said resource IDs in said resource-tag correspondence information; further, retrieving the values of said resource IDs in said resource-tag correspondence information having the values of said retrieved tag IDs as the values of said tag IDs in said resource-tag correspondence information; and generating a list composed of the values of said resource IDs, which are determined by deleting the values of said resource IDs included respectively in all first resource lists stored in said temporary memory from a sum set of the values of said retrieved resource IDs, as said hop number correspondent resource list, which list will be repeatedly generated;
a first calculation step of calculating a first resource median value with respect to said one piece of resource information based on the values of said hop numbers as well as the values of said resource points in said resource information having the values of said resource IDs included in each said hop number correspondent resource list corresponding to the value of said hop number as the values of said resource IDs in said resource information stored in said resource table; and
a second calculation step of calculating first point with respect to said one piece of resource information based on said calculated first resource median value and storing said first point as the value of said resource point in said one piece of resource information into said resource table, wherein said method is executed by said processing unit at a first timing.

13. A method in accordance with claim 12 executed by said processing unit, characterized in that:
said resource information to be stored in said resource table includes initial resource point associated with said resource ID, said method further comprising:
a resource storage step of newly storing one or more piece(s) of first text newly input via an interface, each as a new resource in said resource information, along with each the value of said resource ID in said new resource information and the value of said initial resource point, in said resource table;
a tag retrieval and storage step for newly storing each new second text that is to be retrieved respectively from said one or more piece(s) of said first text, which has been newly stored by said resource storage step and that has not yet been stored as the tag in said tag information stored in said tag table, as the tags in new said tag information, along with the values of said tag IDs in said new tag information, in said tab table; and
a step of storing new said resource-tag correspondence information including the value of said resource ID in said new resource information that has been stored by said resource storage step and the values of said tag IDs in said new tag information that has been stored by said tag retrieval and storage step in said resource-tag association table,
wherein the value of said initial resource point for said new resource information that has been stored by said resource storage step is calculated, at the time of an input via said interface taken as said first timing, by selecting the value of said resource ID in said new resource information in said selection step followed by a series of said first resource list generation and storage step, said second resource list generation and storage step, said first calculation step and said second calculation step.

14. A method in accordance with claim 13, characterized in that said second texts to be retrieved from said first text by said tag retrieval and storage step is retrieved by:
retrieving a group of first keywords including one or more first keyword(s) from said first text;
using each first keyword in said retrieved group of first keywords to make a search over a text set comprising a plurality of pairs of words and the descriptions to be stored in a second database that is to be stored in a storage unit of a second server configured on the network in coordination with said database of said server with the aid of an application interface, for said word corresponding to each said first keyword so as to obtain said description for said word matched with said first keyword;
further, retrieving a group of second keywords including one or more second keyword(s) from the thus obtained said description; and
using each said second keyword included in the group of said retrieved second keywords to make a search over said resources in said resource information in said resource table and deleting those said second keywords that have been stored in excess of a given number from the group of said second keywords so as to retrieve said second texts.

15. A method in accordance with claim 13, wherein further, said database contains a user history table for storing two or more pieces of user behavior correspondence information including: one of said resource IDs included in said resource information in said resource table; and one or more user ID(s) and the corresponding behavioral classification associated with said one of said resource IDs, said method comprising:
a behavioral classification retrieval step of retrieving: the value(s) of said one or more user ID(s) in said user behavior correspondence information having the value of said resource ID in said one piece of resource information selected by said selection step as the value of said resource ID in said user behavior correspondence information stored in said user history table: and the value of its first said corresponding behavioral classification, and storing the thus retrieved values in a temporary memory;
a third calculation step of calculating a valuation value for one user ID repeatedly for every one of the values of said retrieved one or more user ID(s) and storing the thus calculated valuation value in said temporary memory, said third calculation step including:
a series of steps comprising: retrieving the value(s) of one or more resource ID(s) and the value(s) of its second said corresponding behavioral classification included in said user behavior correspondence information having the value of said one user ID as the value of said user ID in said user behavior correspondence information stored in said user history table; generating a list, which is created by deleting the value of said selected resource ID from a sum set of the values of said retrieved one or more resource ID(s), as a second resource list with respect to said selected resource ID; and storing the thus generated second resource list in said temporary memory; and
a series of steps comprising: calculating the valuation value for said one user ID based on: the value of said first behavioral classification retrieved at said behavioral classification retrieval step; the value of said resource point in said resource information having the value of each said resource ID included in said generated second resource list as the value of said resource ID in said resource information stored in said resource table; and the value of said retrieved second behavioral classification with respect to the value of said resource ID in said resource information; and storing the thus calculated valuation value for said one user ID in said temporary memory;
a step of calculating a second resource median value with respect to said one piece of resource information based on each said valuation value for said retrieved one or more user ID(s); and
a step of further calculating second point with respect to said one piece of resource information based on said calculated first resource median value and said calculated second resource median value, both with respect to said one piece of resource information and storing the thus calculated second point as the value of said resource point for said one piece of resource information in said resource table, wherein said method is executed by said processing unit at said first timing.

16. A method in accordance with claim 15, further comprising third point storage step, said step including:
with respect to each of the values of said resource IDs in all pieces of said resource information stored in said resource table, making a selection for retrieval as said resource ID in said one piece of resource information at said selection step;
subsequently calculating the values of said first resource median values for said all pieces of resource information and the values of said second resource median values for said all pieces of resource information, respectively, through the series of steps including said first resource list generation and storage step, said second resource list generation and storage step, said first calculation step and said second calculation step;
based on a ratio of the sum of calculated said first resource median values to the sum of calculated said second resource median values, calculating third points for said all pieces of resource information, respectively, and storing the thus calculated said third points into said temporary memory, wherein the thus respectively calculated third points are stored respectively as the values of said resource points in said all pieces of resource information into said resource table, wherein said method is executed by said processing unit at said first timing.

17. A method in accordance with claim 16, further comprising a user table for storing two or more pieces of user account information including said user ID for uniquely identifying a user and account point associated with said user ID, wherein
said two or more pieces of resource information to be stored in said resource table further contain, respectively, one posting user ID associated with said resource ID in said resource information, the value of said posting user ID representing the value of said user ID of said user who has posted said first text; and
said behavioral classification in said two or more pieces of user behavior correspondence information stored in said user history table includes those representing questioning, answering, negative rating, positive rating, and viewing whose corresponding values are taken as the values of said behavioral classification; said method comprising:
said resource storage step, which works to store the value of said user ID of the user who has input said first text via said interface as the value of said posting user ID in said new resource information,
while concurrently storing said user behavior correspondence information including the value of said resource ID in said new resource information, the value of said posting user ID in said new resource information and the value of any one of said behavioral classifications other than the viewing, which corresponds to the one that has been selected by said user, in said user history table; and
a step occurring at the time when any one of the values of said resource IDs of said resources included in said all pieces of resource information stored in said resource table is specified by any said user via said interface so as to store said user behavior correspondence information including the value of said specified resource ID, the value of said user ID identifying said user who has invoked said specification and the value corresponding to said classification representing the viewing in said user history table, wherein said method is executed by said processing unit.

18. A method in accordance with claim 17, further comprising:
a point investment step characterized by subtracting the initial resource point in said new resource information stored in said resource table from the value of said account point in said user account information, which has the value of said posting user ID in said new resource information as the value of said user ID in said user account information stored in said user table and then further storing a result from said subtraction as the value of said account point in said user account information into said user table so as to increase or decrease the value of said account point,
wherein every piece of tag information stored in said tag table further comprises tag point, wherein the tag point in one piece of said tag information can take for storage a value from summation of the resource point in said resource information that further has, as the value of said resource ID in said resource information stored in said resource table, the value(s) of one or more resource ID(s) in said resource-tag correspondence information having the value of said tag ID in one piece of said tag information as the value of said tag ID in said resource-tag correspondence information stored in said resource-tag association table, said method further comprising:
a fourth point calculation and storage step occurring at said first timing to calculate the fourth points for all pieces of said tag information and store each of the values of said fourth point as the value of said tag point in said tag information in said tag table;
a reward distribution step including:
at the second timing as specified when said first text of said resource in said new resource information has been input via said interface, selecting the value of said resource ID in said new resource information by said selection step;
generating said hop number correspondent resource list having said hop number of 1 with respect to said resource ID in said new resource information by said first resource list generation and storage step;
summing up the values of said tag points in pieces of said tag information, each of which further has, as the value of said tag ID in said tag information stored in said tag table, the value(s) of said one or more tag ID(s) in said resource-tag correspondence information, each having the value of each resource ID included in said hop number correspondent resource list as the value of said resource ID in said resource-tag correspondence information stored in said resource-tag association table to calculate thereby each total value of said tag points with respect to each resource ID included in said hop number correspondent resource list having said hop number of 1 and storing the thus calculated value in said temporary memory;
calculating each value of point to be allotted with respect to each said resource ID included in said hop number correspondent resource list from the value of said initial resource point in said new resource information stored in said resource table based on the ratio of the sum of the values of said stored tag points and storing the thus calculated each value of said point in the temporary memory; and
adding each value of said stored point to be allotted to each value of the account point in said user account information that further has, as the value of said user ID in said user account information in said user table, the value of said posting user ID in said resource information that has the value of each said resource ID included in said hop number correspondent resource list as the value of said resource ID in said resource information stored in said resource table, and storing each result from the addition taken as the value of said account point in said user account information in said user table, wherein said method is executed by said processing unit.

19. A method in accordance with claim 18, wherein said database further comprises an operation management table for storing two or more pieces of management information including point to be paid, point to be collected, and a time of points movement in the reward distribution, said method further comprising:
a first management information storage step of storing in said operation management table, said management information including the value of said initial resource point in said new resource information stored in said resource table taken as the value of said point to be paid, a difference between the value of said resource point in said new resource information and the total value of allotted points stored in said temporary memory taken as the value of said point to be collected and the time of said second timing taken as the value of said time of points movement, wherein said method is executed by said processing unit.

20. A method in accordance with claim 19, characterized in further comprising a process occurring at a third timing and including:
a step of multiplying each value of said account point included in every piece of said account information stored in said user table by a given rate; truncating values at decimal places from the result from said multiplication to yield an integer; subtracting the thus yielded integer from each value of said account point; and storing the result from said subtraction taken as the value of said account point in said user account information in said user table (41); and
a second management information storage step of storing in said operation management table, said management information including said integer value taken as the value of said point to be paid as well as the value of said point to be collected in said management information to be stored in said operation management table and the time of said third timing taken as the value of said time of points movement, wherein said method is executed by said processing unit.

21. A method in accordance with claim 20, wherein said database further comprises a points distribution management table for storing two or more pieces of points distribution information including total distribution point, said method comprising a process occurring at said first timing and including:
a step of calculating a total sum of the values of said points to be paid included in said management information with the value of said time of point movement falling within a given range, among those pieces of said management information stored in said operation management table by said first management information storage step and/or said second management information storage step and storing the thus calculated value of said total sum taken as the value of said total distribution point into said points distribution management table;
a step of calculating a total distribution points increase rate by taking a ratio of the value of said total distribution point that have been thus stored to the total distribution point in the last stored said points distribution information among those pieces of points distribution information that have been already stored and storing the thus calculated total distribution points increase rate in said temporary memory; and
a step of calculating and storing fifth point with respect to said new resource information, said step including: calculating the fifth point based on the fourth point that have been calculated with respect to said new resource information by said fourth point calculation and storage step and the total distribution points increase rate that has been stored in said temporary memory and storing the thus calculated point taken as the value of resource point in said newly input one piece of resource information into said resource table, wherein said method is executed by said processing unit.
